(19) United States
(12) Patent Application Publication
(10) Pub. No.: US 2015/0301935 A1
(43) Pub. Date: Oct. 22, 2015

(54) MICROCOMPUTER AND NONVOLATILE SEMICONDUCTOR DEVICE

(71) Applicants: Tamiyu KATO, Kawasaki-shi, Kanagawa (JP); Yukiko MARUYAMA, Kawasaki-shi, Kanagawa (JP); Shinya IZUMI, Kawasaki-shi, Kanagawa (JP); Kiyoshi NAKAKIMURA, Kawasaki-shi, Kanagawa (JP); Yoshihiro SEGUCHI, Kawasaki-shi, Kanagawa (JP)

(72) Inventors: Tamiyu KATO, Kawasaki-shi, Kanagawa (JP); Yukiko MARUYAMA, Kawasaki-shi, Kanagawa (JP); Shinya IZUMI, Kawasaki-shi, Kanagawa (JP); Kiyoshi NAKAKIMURA, Kawasaki-shi, Kanagawa (JP); Yoshihiro SEGUCHI, Kawasaki-shi, Kanagawa (JP)

(73) Assignee: RENESAS ELECTRONICS CORPORATION, Kawasaki-shi, Kanagawa (JP)

(21) Appl. No.: 14/382,159

(22) PCT Filed: Mar. 2, 2012
(86) PCT No.: PCT/JP2012/055341

§ 371 Date: Aug. 29, 2014

(51) Int. Cl. G06F 12/02

(52) U.S. Cl. CPC G06F 12/0246; G06F 2212/7208

(57) ABSTRACT

A program counter (12) updates an address by adding a first value or a second value. A code select circuit (14) selects, in accordance with the address of the program counter (12), one of an insert code retained in an insert code register set block (17) and corresponding to the address specified by the program counter (12), and an original code stored in a flash control code ROM (13) and having the address specified by the program counter (12). An instruction execution unit (15) executes the selected code. At least one of a plurality of original codes and the insert code is a multicycle instruction. The program counter (14) stops update of the address when the multicycle instruction is executed.

### TECHNICAL FIELD

The present invention relates to a microcomputer and a nonvolatile semiconductor device, and particularly relates to a microcomputer and a nonvolatile semiconductor device having a capability of inserting an additional code into original codes.

### BACKGROUND ART

A method for modifying a program recorded in a ROM (Read Only Memory) of a microcomputer has been known

PTD 1 (Japanese Patent Laying-Open No. 10-27704) discloses a device including a modification address register and a comparison circuit. The comparison circuit compares a ROM fetch address and a value of the modification address register with each other and sends the result of comparison to an instruction decoder. Detecting a match in the comparison circuit, the instruction decoder executes a microinstruction to thereby acquire a start address of a modified program from a predetermined address on a RAM and cause execution of a program to branch to the start address of the modified program in the RAM.

PTD 2 (Japanese Patent Laying-Open No. 8-95946) discloses a device including an instruction queue, a fetch pointer, a register storing an address of a bug portion of an internal ROM, and a select circuit which outputs a program on a memory or a specific branch instruction in accordance with the output result of a comparison circuit comparing respective contents of the register and the fetch pointer with each other. When the content of the fetch pointer matches the content of the register, the branch instruction is transferred from the select circuit to the instruction queue. A CPU executes the branch instruction to thereby go on to a modified program, so that execution of the bug portion is avoided.

PTD 3 (Japanese Patent Laying-Open No. 2004-46318) discloses a device including: a memory in which an instruction data array is stored; and a CPU having an instruction register and a program counter which indicates a specific instruction address at which stored specific instruction data to be output to the instruction register among the instruction data stored in the memory. The device further includes additional instruction storage means configured in such a manner that the storage means can externally be written and can store a data-address pair made up of additional instruction data to be added to the instruction data array and an additional address indicating a location where the additional instruction data is to be added. The device compares the specific instruction address indicated by the program counter with the additional address stored in the additional instruction storage means to select one of the specific instruction data and the additional instruction data. When the specific instruction address and the additional address match each other, the program counter stops update of the specific instruction address.

### CITATION LIST

### Patent Document

PTD 1: Japanese Patent Laying-Open No. 10-27704
PTD 2: Japanese Patent Laying-Open No. 8-95946
PTD 3: Japanese Patent Laying-Open No. 2004-46318

### SUMMARY OF INVENTION

### Technical Problem

While respective devices of PTD 1 and PTD 2 can insert and modify a code, they have a problem that the amount of required hardware is large. In addition, the overhead time taken for a branch jump deteriorates the device performance.

While the device of PTD 3 can insert a code, the device has a difficulty in being applied to a multicycle instruction, since the program counter stops for one cycle when a code is inserted. Other problems and new features will become apparent from the description herein and the attached drawings.

### Solution to Problem

A microcomputer in one embodiment of the present invention includes: a program counter updating an address by adding a first value or a second value, and stopping update of the address when a multicycle instruction is executed; a select circuit selecting, in accordance with the address of the program counter, one of an insert code retained in a register and corresponding to the address specified by the program counter, and an original code stored in a ROM and having the address specified by the program counter; and an instruction execution unit executing the code selected by the select circuit.

### Advantageous Effects of Invention

A microcomputer and a nonvolatile semiconductor device in one embodiment of the present invention enable a code to be inserted and a multicycle instruction to be executed.

### BRIEF DESCRIPTION OF DRAWINGS

FIG. 1 (a) is a diagram showing an example of codes (original codes) recorded in a ROM and a code to be inserted, FIG. 1 (b) is a diagram showing modified codes of a microcomputer A having a code modification capability, and FIG. 1 (c) is a diagram showing modified codes of a ROM of a microcomputer B having a code insert capability.

FIG. 2 (a) is a diagram showing an example of codes (original codes) recorded in a ROM and a code to be modified, FIG. 2 (b) is a diagram showing modified codes of a microcomputer A having the code modification capability, and FIG. 2 (c) is a diagram showing modified codes of a microcomputer B having the code insert capability.

FIG. 3 (a) is a diagram showing timings of fetch and execution of instructions in a single-cycle scheme, and FIG. 3 (b) is a diagram showing timings of fetch and execution of instructions in a multicycle scheme.

FIG. 4 is a timing diagram illustrating, regarding PTD 3, a case where a single-cycle instruction is inserted into codes (original codes) recorded in a ROM that are partially multicycle instructions.

FIG. 5 (a) is a timing diagram of a case where a part of codes (original codes) recorded in a ROM is a multicycle instruction and operation is normally performed even when a single-cycle instruction is inserted, and FIG. 5 (b) is a timing diagram of a case where codes (original codes) recorded in a ROM are single-cycle instructions and operation is normally performed even when a multicycle instruction is inserted.

FIG. 6 is a diagram showing a configuration of a microcomputer in the present embodiment.

FIG. 7 is a diagram showing a configuration of a flash memory control unit 2 in a first embodiment.

FIG. 8 is a diagram for illustrating respective functions of an instruction execution unit 15 and a program counter 12.

FIG. 9 is a diagram showing a configuration of program counter 12 FIG. 10 is a diagram showing a configuration of an insert code register set block 17.

FIG. 11 is a diagram showing a configuration of a code insert register set 29-0.

FIG. 12 is a diagram showing a configuration of a code select circuit 14.

FIG. 13 (a) is a diagram showing an example of values retained in an address register 31 of a code insert register set 29-i, and FIG. 13 (b) is a timing diagram under the conditions in FIG. 13 (a).

FIG. 14 (a) is a diagram showing an example of values retained in address register 31 of code insert register set 29-i, FIG. 14 (b) is a diagram showing an original code and an insert code, and FIG. 14 (c) is a timing diagram under the conditions indicated in FIGS. 14 (a) and (b).

FIG. 15 (a) is a diagram showing an example of values retained in address register 31 of code insert register set 29-i, FIG. 15 (b) is a diagram showing an original code and an insert code, and FIG. 15 (c) is a timing diagram under the conditions indicated in FIGS. 15 (a) and (b).

FIG. 16 is a diagram showing a configuration of a flash memory control unit 102 in a second embodiment.

FIG. 17 is a diagram showing a configuration of a program counter 51.

FIG. 18 is a diagram showing a configuration of an insert code register set block 52.

FIG. 19 is a diagram showing a configuration of a code insert register set 54-0.

FIG. 20 (a) is a diagram showing an example of values retained in an address register 31 of a code insert register set 29-i, and FIG. 20 (b) is a timing diagram under the conditions in FIG. 20 (a).

FIG. 21 is a diagram showing a configuration of a flash memory control unit 312 in a third embodiment.

FIG. 22 is a diagram showing a configuration of a code insert register set 64-0 included in an insert code register set block 164.

FIG. 23 (a) is a diagram showing an example of values retained in an address register 31 of a code insert register set 64-i, and FIG. 23 (b) is a timing diagram under the conditions in FIG. 23 (a).

FIG. 24 is a diagram showing a configuration of a flash memory control unit 103 in a fourth embodiment.

FIG. 25 is a diagram showing a configuration of a program counter 65 in the fourth embodiment.

FIG. 26 (a) is a diagram showing an example of values retained in an address register 31 of a code insert register set 54-i, and FIG. 26 (b) is a timing diagram under the conditions in FIG. 26 (a).

FIG. 27 is a diagram showing a configuration of a flash memory control unit 395 in a fifth embodiment.

FIG. 28 is a diagram showing a configuration of a code insert register set 40-0 included in an insert code register set block 396.

FIG. 29 is a diagram showing a configuration of a flash memory control unit 423 in a sixth embodiment.

FIG. 30 is a diagram showing a configuration of a program counter 72.

FIG. 31 is a diagram showing a configuration of a code insert register set 71-0 included in an insert code register set block 424.

FIG. 32 (a) is a diagram showing an example of values retained in an address register 31 of a code insert register set 71-i, and FIG. 32 (b) is a timing diagram under the conditions in FIG. 32 (a).

FIG. 33 is a diagram showing a configuration of a flash memory control unit 623 in a seventh embodiment.

FIG. 34 is a diagram showing a configuration of a program counter 74.

FIG. 35 is a diagram showing a configuration of a code insert register set 78-0 included in an insert code register set block 624.

FIG. 36 (a) is a diagram showing an example of values retained in an address register 31 of a code insert register set 78-i, and FIG. 36 (b) is a timing diagram under the conditions in FIG. 36 (a).

FIG. 37 is a diagram showing a configuration of a flash memory control unit 742 in an eighth embodiment.

FIG. 38 is a diagram showing a configuration of a program counter 94.

FIG. 39 is a diagram showing a configuration of an insert code register set block 743.

FIG. 40 is a diagram showing a configuration of a code insert register set 88-0 included in insert code register set block 743.

FIG. 41 (a) is a diagram showing an example of values retained in an address register 31 of a code insert register set 88-i, and FIG. 41 (b) is a timing diagram under the conditions in FIG. 41 (a).

FIG. 42 is a diagram showing a configuration of a flash memory control unit 388 in a ninth embodiment.

FIG. 43 is a diagram showing a configuration of a program counter 94.

FIG. 44 is a diagram showing a configuration of an insert code register set block 389.

FIG. 45 is a diagram showing a configuration of a code insert register set 86-0 included in insert code register set block 389.

FIG. 46 (a) is a diagram showing an example of values retained in an address register 31 of a code insert register set 86-i, and FIG. 46 (b) is a timing diagram under the conditions in FIG. 46 (a).

### DESCRIPTION OF EMBODIMENTS

In the following, embodiments of the present invention will be described with reference to the drawings.

### First Embodiment

As to code insert and code modification:

A description will be given first of the quantity of codes required to be modified for inserting a code, in a microcomputer A having a code modification capability and a microcomputer B having a code addition capability.

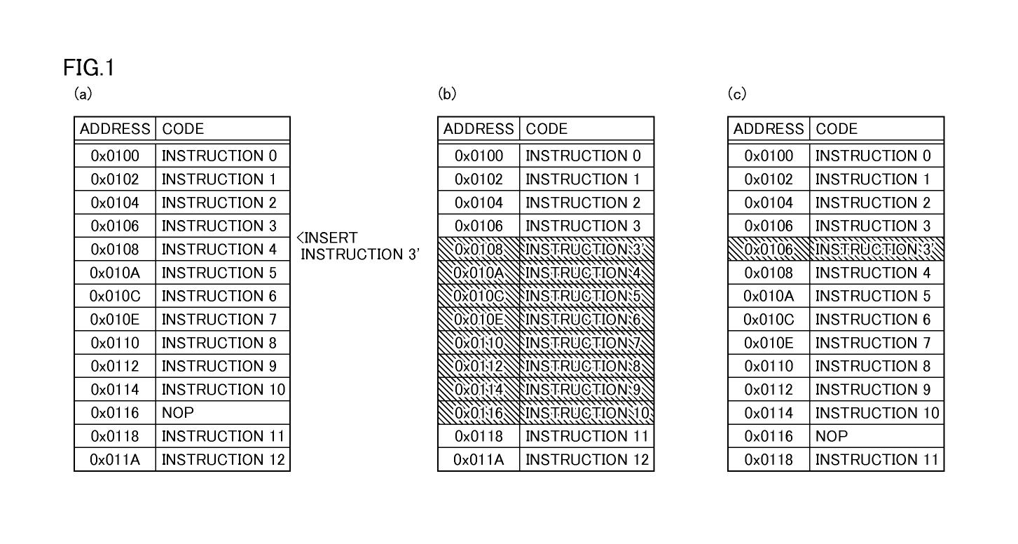

FIG. 1 (a) is a diagram showing an example of codes (original codes) recorded in a ROM and a code to be inserted. In the example in FIG. 1 (a), the original codes are instructions 0 to 10, 11, and 12, and the code to be inserted after instruction 3 is instruction 3′.

FIG. 1 (b) is a diagram showing modified codes of microcomputer A having the code modification capability.

As shown in FIG. 1 (b), instruction 3′ is stored at address “0x0108”. Since an NOP region before the modification is located at address “0x0116”, respective locations where instruction 4 to instruction 10 are stored are changed to addresses “0x010A” to “0x0116”. The quantity of codes required to be modified is therefore “8”. Namely, the regions from the region where the code is inserted to the NOP region have to be modified. Thus, depending on where the NOP region is located, an enormous quantity of codes may have to be modified. Register sets of the number corresponding to the quantity of codes which are to be modified are necessary, resulting in an increase in scale of the hardware. In order to address this, more NOP regions may be provided which, however, increases the redundant processing time and leads to deterioration of the processing performance of the CPU.

FIG. 1 (c) is a diagram showing the modified codes of a ROM of microcomputer B having the code insert capability.

As shown in FIG. 1 (c), instruction 3′ is stored at address “0x0106”. The quantity of codes required to be modified is therefore “1”.

A description will be given next of the quantity of codes required to be modified for modifying codes, in microcomputer A having the code modification capability and microcomputer B having the code addition capability.

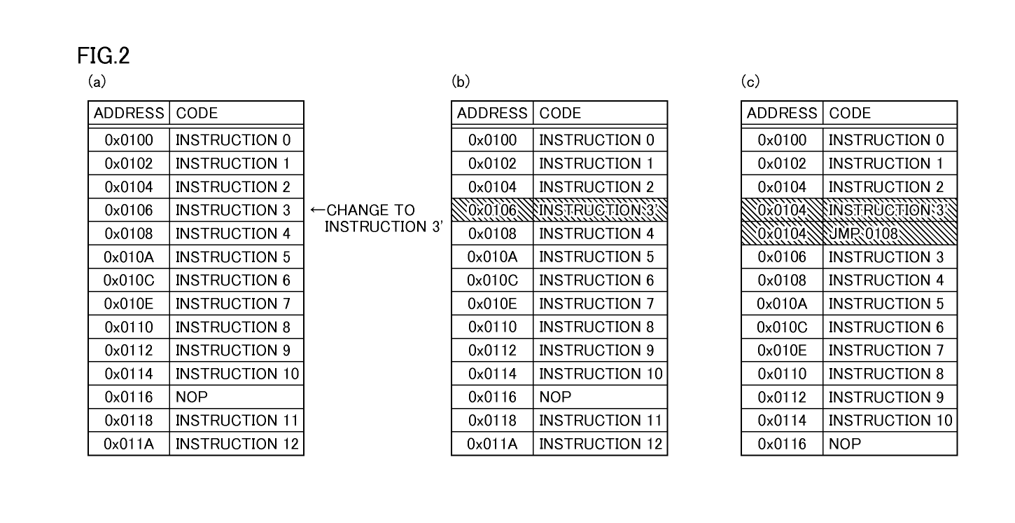

FIG. 2 (a) is a diagram showing an example of codes (original codes) recorded in a ROM and a code to be modified. In the example in FIG. 2 (a), the original codes are instructions 0 to 10, 11, and 12, and instruction 3 is to be modified to instruction 3′.

FIG. 2 (b) is a diagram showing the modified codes of microcomputer A having the code modification capability.

As shown in FIG. 2 (b), instruction 3 stored at address “0x0106” is modified to instruction 3′. The quantity of codes required to be modified is therefore “1”.

FIG. 2 (c) is a diagram showing the modified codes of microcomputer B having the code insert capability.

As shown in FIG. 2 (c), instruction 3′ and a jump instruction “JUMP0108” are stored at address “0x0104”. The quantity of codes required to be modified is therefore “2”.

As set forth above, when a microcomputer having the code modification capability inserts a code, an enormous quantity of codes may have to be modified and accordingly register sets of the number corresponding to the quantity of codes to be modified may be necessary. It is therefore considered inefficient to insert a code by means of the code modification capability.

Single-Cycle Scheme and Multicycle Scheme:

A single-cycle scheme and a multicycle scheme will now be described. In the following, “cycle” refers to a cycle of a so-called constant-frequency reference clock signal with respect to which the operation timing is determined. A program counter is updated per this cycle.

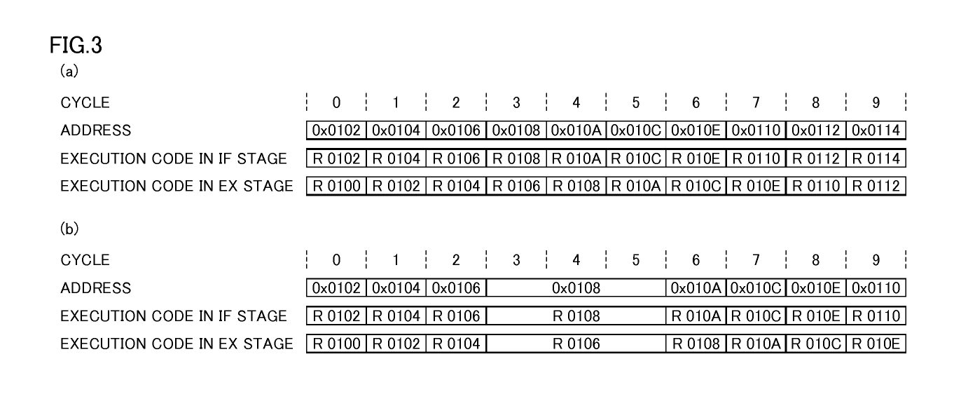

FIG. 3 (a) is a diagram showing timings of fetch and execution of instructions in the single-cycle scheme.

In each cycle, an instruction is fetched from an address of a ROM that is indicated by a program counter (IF stage), and simultaneously an instruction fetched in the immediately preceding cycle is executed (EX stage). In the single-cycle scheme, respective periods of all cycles are equal to each other.

FIG. 3 (b) is a diagram showing timings of fetch and execution of instructions in the multicycle scheme.

The multicycle scheme is similar to the single-cycle scheme in that an instruction is fetched in each cycle from an address of a ROM that is indicated by a program counter (IF stage), and simultaneously an instruction fetched in the immediately preceding cycle is executed (EX stage). In the multicycle scheme, at least one instruction is executed over multiple cycles.

Regarding the single-cycle scheme, the period of one cycle is regulated by the longest pass (the longest time taken to execute an instruction), which is disadvantageous in that the period of one cycle may be longer and that the amount of required hardware may be greater, for example. In view of this, it should be desired to employ the multicycle scheme. In the case where the multicycle scheme is employed, it is necessary to adapt the code insert capability to the multicycle scheme. As for the device of PTD 3, however, a PC update stop signal stops update for one cycle as described in paragraph [0049] and therefore the device is not adapted to the multicycle scheme.

(Problems with the Case where the Multicycle Scheme is Equipped with the Code Insert Capability)

Next, a description will be given of problems with the case where a single-cycle instruction is inserted into codes (original codes) recorded in a ROM that are partially multicycle instructions.

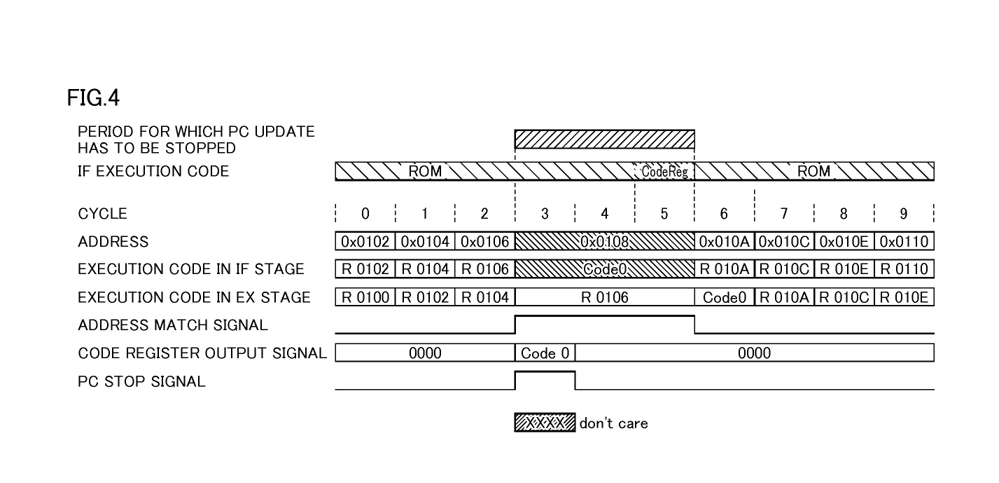

FIG. 4 is a timing diagram illustrating, regarding PTD 3, a case where a single-cycle instruction is inserted into codes (original codes) recorded in a ROM that are partially multicycle instructions.

In the example in FIG. 4, “R0106” which is a part of the original codes is a multicycle instruction (three-cycle instruction), the address of the code is “0x0106”, and a single-cycle insert code “Code 0” is inserted after the multicycle code. Here, “0x . . . ” means that the address is represented using the hexadecimal notation.

In the third cycle, the value of a program counter matches address “0x0108”. Accordingly, insert code Code 0 is fetched and a program counter update stop signal is made valid. In the third cycle, however, the program counter is being stopped for the sake of allowing the multicycle instruction to be executed. The program counter update stop signal thus cannot perform its function of stopping the program counter for the sake of insert Consequently, a ROM's code of address “0x0108” fails to be fetched and executed. In order to execute the ROM's code of address “0x0108”, it is necessary to stop update of PC (program counter) for three cycles as shown in FIG. 4, which, however, requires complicated control for the following reasons.

When a multicycle instruction is executed, a PC stall signal, which is a signal for stopping update of the program counter for a period (the number of multiple cycles−1), is output from an instruction execution unit. The PC stall signal is a signal which is output in a common processor when a multicycle instruction is executed. The following is a study of a case where a simple logic is generated from the PC stall signal and an address match signal to thereby implement the code insert capability when a multicycle instruction is executed.

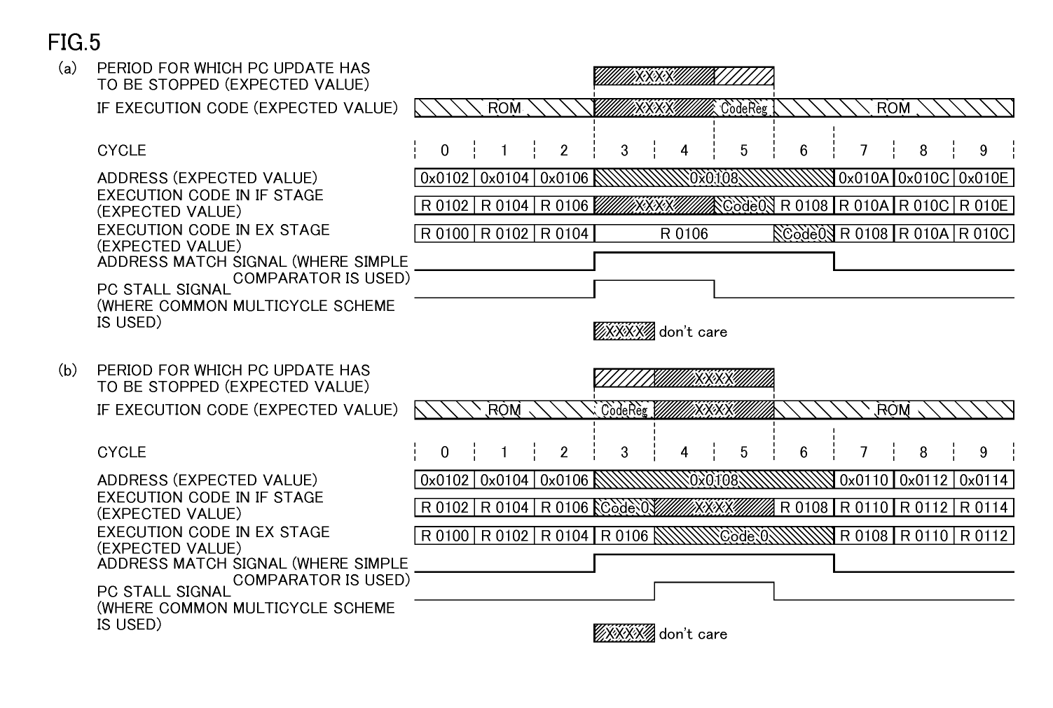

FIG. 5 (a) is a timing diagram of a case where a part of codes (original codes) recorded in a ROM is a multicycle instruction and operation is normally performed even when a single-cycle instruction is inserted. Respective timings of the IF execution code, the address, the execution code in the IF stage, and the execution code in the EX stage are each represented by an expected value necessary for implementing insertion of the code. The timing of the PC stall signal represents an operation in a microcomputer of a common multicycle scheme, and the timing of the address match signal represents an operation where a simple comparator is used.

In the example in FIG. 5 (a), “R0106” which is a part of the original codes is a multicycle instruction (three-cycle instruction), the address of the code is “0x0106”, and a single-cycle insert code “Code 0” is inserted after the multicycle code.

In the third cycle, the value of a program counter matches address “0x0108”. Accordingly, the address match signal is “H” level for four cycles and the PC stall signal is “H” level for two cycles. As shown in FIG. 5 (a), in order to fetch and execute the ROM's code of address “0x0108”, it is necessary, in the fifth cycle where the PC stall signal is “L” level, a PC update stop signal is separately generated for stopping update of the program counter. In the case of FIG. 5 (a), it is necessary to provide a logic circuit so that the newly provided PC update stop signal is “H” level in such a case where both the address match signal and the PC stall signal are “H” level in the immediately preceding cycle and the address match signal is “H” level and the PC stall signal is “L” level in the current cycle.

FIG. 5 (b) is a timing diagram of a case where codes (original codes) recorded in a ROM are single-cycle instructions and operation is normally performed even when a multicycle instruction is inserted.

In the example in FIG. 5 (b), “R0106” which is a part of the original codes is followed by insertion of an insert code “Code 0” which is a three-cycle instruction.

In the third cycle, the value of a program counter matches address “0x0108”. Accordingly, the address match signal is “H” level for four cycles and the PC stall signal is “H” level for two cycles from the fourth cycle. As shown in FIG. 5 (b), in order to fetch and execute the ROM's code of address “0x0108”, it is necessary, in the third cycle where the PC stall signal is “L” level, a PC update stop signal is generated for stopping update of the program counter. In the case of FIG. 5 (b), it is necessary to provide a logic circuit so that the PC update stop signal is “H” level in such a case where both the address match signal and the PC stall signal are “L” level in the immediately preceding cycle and the address match signal is “H” level and the PC stall signal is “L” level in the current cycle.

As seen from the above, in the case of FIG. 5 (a) and that of FIG. 5 (b), a separate logic circuit is necessary for generating the PC update stop signal.

The fifth cycle and the immediately preceding fourth cycle in FIG. 5 (a) are identical to the sixth cycle and the immediately preceding fifth cycle in FIG. 5 (b) in terms of respective levels of the address match signal and the PC stall signal. However, in FIG. 5 (a), the code is fetched from the CodeReg retaining the insert code and, in FIG. 5 (b), the code is fetched from the ROM retaining the original codes. They are thus different from each other.

Thus, the mere addition of the logic circuit is encountered by difficulties in generating the PC update stop signal for the sake of implementing the code insert capability and a switch signal for the sake of switching a selector for selecting one of an original code and an insert code and sending the selected one to an instruction execution unit. The present embodiment solves the above problems to thereby implement a microcomputer of the multicycle scheme that enables a code to be inserted.

(Configuration of First Embodiment)

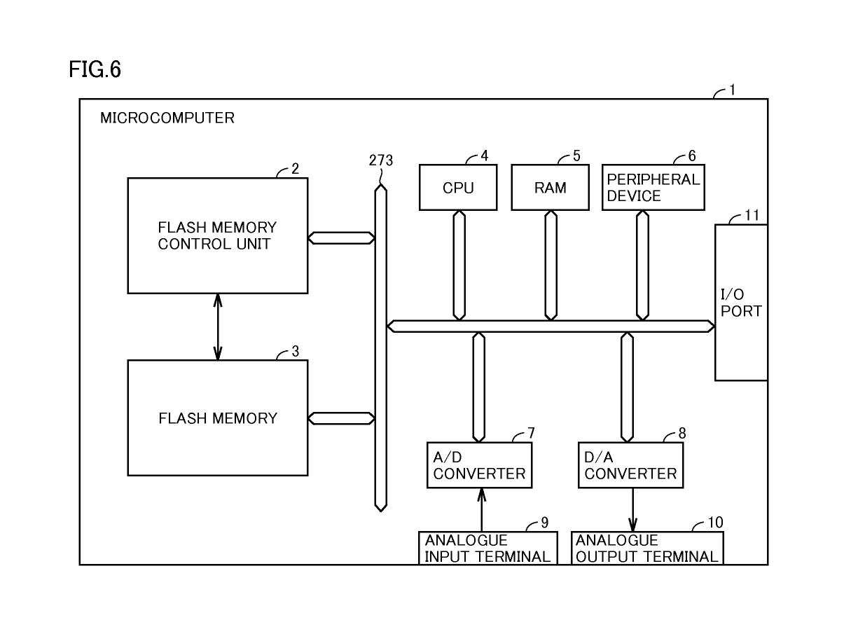

FIG. 6 is a diagram showing a configuration of a microcomputer in the present embodiment. The microcomputer shown therein is formed on a semiconductor substrate (chip) with a known technique of manufacturing a semiconductor integrated circuit. The microcomputer, however, is not particularly limited to this.

As shown in FIG. 6, this microcomputer 1 includes a CPU (Central Processing Unit) 4, a RAM (Random Access Memory) 5, a peripheral device 6, an analogue input terminal 9, an A/D converter 7, an analogue output terminal 10, a D/A converter 8, an I/O port 1, a flash memory 3, a flash memory control unit 2 which chiefly controls flash memory 3, and a main data bus 273 for transmission of signals between these variety of circuits.

CPU 4 controls the overall processing of microcomputer 1. CPU 4 is capable of accessing flash memory 3.

RAM 5 stores a variety of data and is used for example as a work area of CPU 4.

Peripheral device 6 transmits and receives data to and from the external circuitry through I/O port 11.

A/D converter 7 converts an analogue signal which is input from analogue input terminal 9 into a digital signal.

D/A converter 8 converts a digital signal into an analog signal and outputs the analog signal to analogue output terminal 10.

Flashy memory 3 is a nonvolatile memory and capable of electrical erasure and writing from and into the semiconductor substrate. Flash memory 3 stores an operating program of CPU 4 or a variety of data. Flash memory 3, however, is not particularly limited to this.

Flash memory control unit 2 controls flash memory 3 in a predetermined sequence, in response to access from CPU 3. Flash memory control unit 2 stores a program controlling operations such as erasure, writing, and reading of flash memory 3, and also executes the program. The program includes for example an instruction to monitor an error in rewriting of the flash memory. Upon reading the instruction to monitor an error, flash memory control unit 2 checks a register for an error, and outputs an error, if any, to CPU 4.

Such an instruction to monitor an error is located at every certain number of addresses in the program so that the instruction is read at certain time intervals. Execution of this instruction causes deterioration of other processing performances. It is therefore necessary to locate this program at appropriate intervals. There may, however, a request to shorten the time intervals at which the error monitoring is performed for the sake of safety even if the processing performance is deteriorated to some extent.

Flash memory control unit 2 of the present embodiment can meet the above request by being equipped with a capability of inserting a new code into a program made up of original codes which are instructions incorporated in advance, without modifying the hardware of the microcomputer.

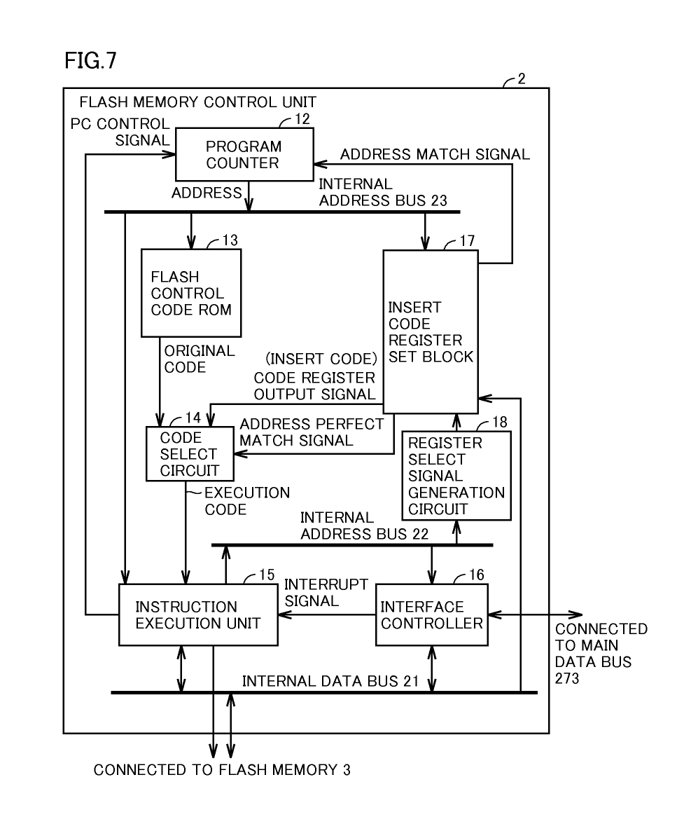

FIG. 7 is a diagram showing a configuration of flash memory control unit 2 in the first embodiment.

As shown in FIG. 7, flash memory control unit 2 includes a program counter 12, a flash control code ROM 13, an insert code register set block 17, a register select signal generation circuit 18, a code select circuit 14, an instruction execution unit 15, and an interface controller 16.

Flash control code ROM 13 stores a plurality of original codes which are instructions incorporated in advance. Flash control code ROM 13 outputs an original code stored at an address which is output from program counter 12. Regarding the addresses of a plurality of original codes in flash control code ROM 13, the second least significant bit and more significant bits than the second least significant bit in an output from the program counter are valid. While flash control code ROM 13 in the present embodiment functionally corresponds to a masked ROM, flash control code ROM 13 is herein the one fixedly incorporated in advance in the form of logic circuits or the like, rather than the so-called write-protected mass-storage memory.

Insert code register set block 17 has a register set retaining at least one insert code and an address of the insert code. When the bits of the address of the retained insert code except for the least significant bit and the bits of an address given from program counter 12 except for the least significant bit match each other, insert code register set block 17 outputs a first signal to program counter 12 (namely sets an address match signal to “H” level). When insert code register set block 17 outputs the first signal and the least significant bit of the address given from program counter 12 is “1”, block 17 outputs a second signal to code select circuit 14 (namely sets an address perfect match signal to “H” level) and outputs the retained insert code as a code register output signal.

Program counter 12 updates the address which is the value of the counter, by adding a first value or a second value. Namely, based on the address match signal and a PC control signal, program counter 12 updates the counter value and outputs the address which is the counter value to an internal address bus 23. When a multicycle instruction is executed, program counter 12 stops update of the address. More specifically, receiving the first signal, program counter 12 adds “1” to the least significant bit and, failing to receive the first signal, program counter 12 adds “1” to the second least significant bit.

Register select signal generation circuit 18 provides to insert code register set block 17 code register select signals 0 to n and address register select signals 0 to n as will be described later herein. The code register select signals 0 to n and address register select signals 0 to n are activated to serve as a select signal, when a code to be inserted and an address at which the code is to be inserted are set in insert code register set block 17.

Code select circuit 14 outputs to instruction execution unit 15 one of the original code which is output from flash control code ROM 13 and the insert code which is output from insert code register set block 17, as an execution code, based on the address perfect match signal which varies depending on the address which is output from program counter 12. More specifically, receiving the second signal, code select circuit 14 selects the insert code and, failing to receive the second signal, code select circuit 14 selects the original code.

Instruction execution unit 15 fetches the execution code which is output from code select circuit 14 and executes the fetched execution code.

In the present embodiment, at least one of a plurality of original codes and the insert code is a multicycle instruction. Namely, control of flash memory 3 requires processing adapted to the multicycle instruction.

Interface controller 16 is connected to main data bus 273. When interrupted externally to the flash memory control unit, interface controller 16 outputs an interrupt signal to instruction execution unit 15.

Instruction execution unit 15 and interface controller 16 are connected through an internal data bus 21 to flash memory 3.

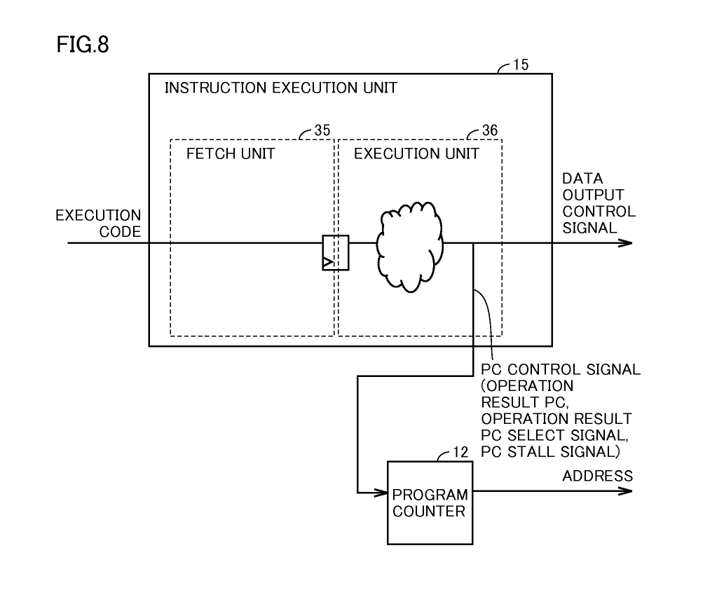

FIG. 8 is a diagram for illustrating respective functions of instruction execution unit 15 and program counter 12.

As shown in FIG. 8, instruction execution unit 15 includes a fetch unit 35 and an execution unit 36. Fetch unit 35 fetches the execution code which is output from code select circuit 14 and outputs the fetched execution code to execution unit 35. Execution unit 36 executes the fetched execution code. Execution unit 36 outputs to program counter 12 PC control signals such as an operation result PC indicating an immediate value, an operation result PC select signal giving an instruction to select the immediate value, and a PC stall signal. The PC stall signal is set to “H” level when a multicycle instruction is executed.

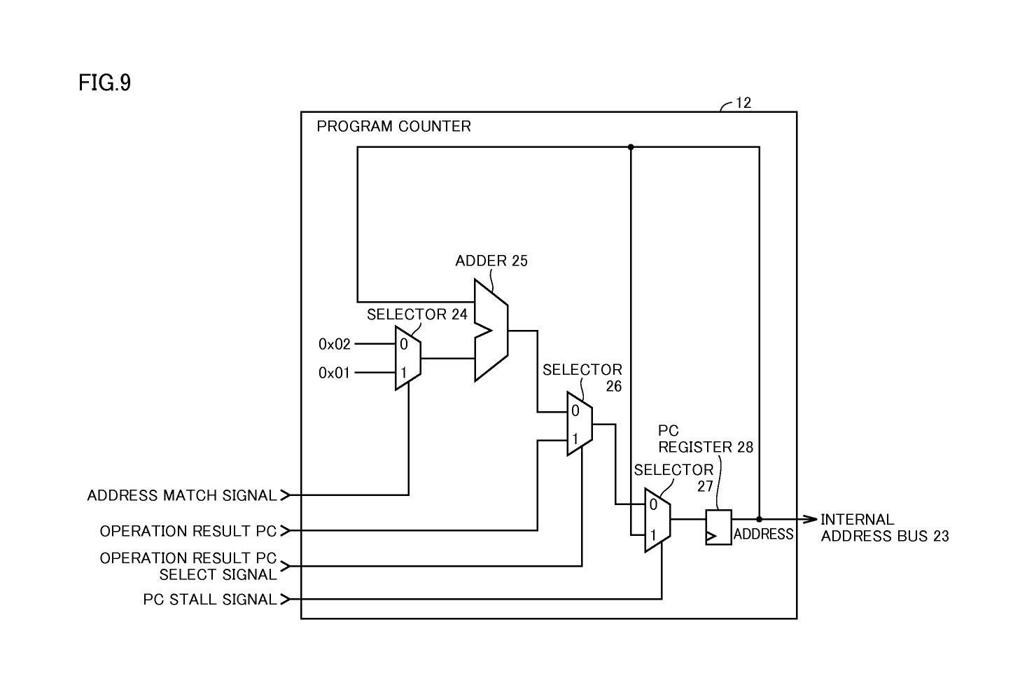

FIG. 9 is a diagram showing a configuration of program counter 12.

As shown in FIG. 9, program counter 12 includes a selector 24, an adder 25, a selector 26, a selector 27, and a PC register 28.

Selector 24 outputs “0x01” when the address match signal which is output from insert code register set block 17 is “H” level, and outputs “0x02” when the address match signal is “L” level.

Adder 25 adds together a 16-bit address which is output from PC register 28 and a value which is output from selector 24.

Selector 26 receives the output of adder 25 and the operation result PC (namely the immediate value) which is output from instruction execution unit 15. When the operation result PC select signal which is output from instruction execution unit 15 is “H” level, selector 26 outputs the operation result PC. When the operation result PC select signal is “L” level, selector 26 outputs the output of adder 25.

Selector 27 receives the output of selector 26 and the address which is output from PC register 28. When the PC stall signal which is output from instruction execution unit 15 is “H” level, selector 27 outputs the address which is output from PC register 28. When the PC stall signal is “L” level, selector 27 outputs the output of selector 26.

PC register 28 latches the output of selector 27 and outputs to internal address bus 23 the latched output as an address of flash control code ROM 13.

FIG. 10 is a diagram showing a configuration of insert code register set block 17.

As shown in FIG. 10, insert code register set block 17 includes a code insert register set 29-i (i=0 to n) retaining a code to be inserted and the location (address) where the code is to be inserted, as well as logic circuits OR1, OR2, OR3.

Code insert register set 29-i receives an address which is output from program counter 12 and data which is transmitted through the data bus, further receives from register select signal generation circuit 18 code register select signal i and address register select signal i, and outputs to code select circuit 14 address match signal i, address perfect match signal i, and code register output signal i. Specifically, based on code register select signal i and address register select signal i, code insert register set 29-i in insert code register set block 17 is selected, and the insert code and the address which are transmitted from internal data bus 21 are written in a code register and an address register of selected code insert register set 29-i.

Logic circuit OR1 outputs an address match signal, namely the logical sum of (n+1) address match signals 0 to n. Namely, when at least one of address match signals 0 to n is “H” level, the address match signal is “H” level.

Logic circuit OR2 outputs a code register output signal, namely the logical sum of (n+1) code register output signals 0 to n Namely, when at least one of (n+1) code register output signals 0 to n has an “H” level bit (namely when the insert code is output), the code register output signal is the insert code. Namely, when all bits of (n+1) code register output signals 0 to n are “L” level (namely when the insert code is not output), all bits of the code register output signal are “L”.

Logic circuit OR3 outputs an address perfect match signal, namely the logical sum of (n+1) address perfect match signals 0 to n. Namely, when at least one of (n+1) address perfect match signals 0 to n is “H” level, the address perfect match signal is “H” level.

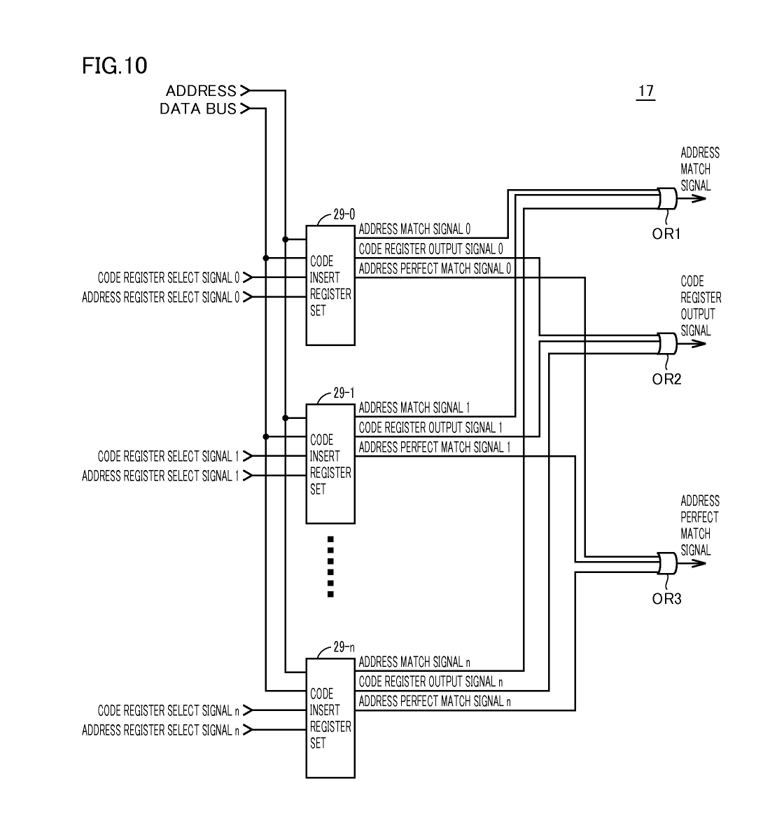

FIG. 11 is a diagram showing a configuration of code insert register set 29-0. Code insert register sets 29-1 to 29-n are configured similarly to code insert register set 29-0 in FIG. 11.

As shown in FIG. 11, code insert register set 29-0 includes a logic circuit AND1, an address register 31, an address comparator 30, a logic circuit AND4, a code register 32, a logic circuit AND2, and a logic circuit AND3.

Logic circuit AND1 outputs to a control terminal of address register 31 an “H” level signal when both clock clk and address register select signal 0 are “H” level.

When the input to the control terminal is “H” level, address register 31 latches and retains the 15-bit address (namely the address where the insert code is to be inserted) which is sent through the data bus. Namely, in synchronization with clock clk, address register select signal 0 is accepted, and the signal from the data bus is stored as the insert destination address of the insert code, in selected address selector 31.

Address comparator 30 sets address match signal 0 to “H” level when the high-order 15 bits (address [15:1]) of the 16-bit address which is output from program counter 12 and the 15-bit address which is retained in address register 31 match each other.

Logic circuit AND2 sets address perfect match signal 0 to “H” level when address match signal 0 is “H” level and the least significant bit (address[0]) of the 16-bit address which is output from program counter 12 is “1”. The fact that the least significant bit which is not valid as an address of a plurality of original codes in flash control code ROM 13 is “1” means that an address which is not present in flash control code ROM 13 is specified.

Logic circuit AND4 outputs an “H” level signal to a control terminal of code register 32 when both clock clk and code register select signal 0 are “H” level.

Code register 32 latches and retains, when the input to the control terminal is “H” level, the 16-bit data (namely the insert code) which is sent through the data bus. Namely, in synchronization with clock clk, code register select signal 0 is accepted, and the signal from the data bus, namely the insert code, is stored in the selected code register.

Logic circuit AND3 receives address perfect match signal 0 and the output of code register 32. When address perfect match signal 0 is “H” level, logic circuit AND3 outputs, as code register output signal 0, the 16-bit data (insert code) retained in code register 32. When address perfect match signal 0 is “L” level, logic circuit AND3 outputs, as code register output signal 0, 16-bit “0x0000”.

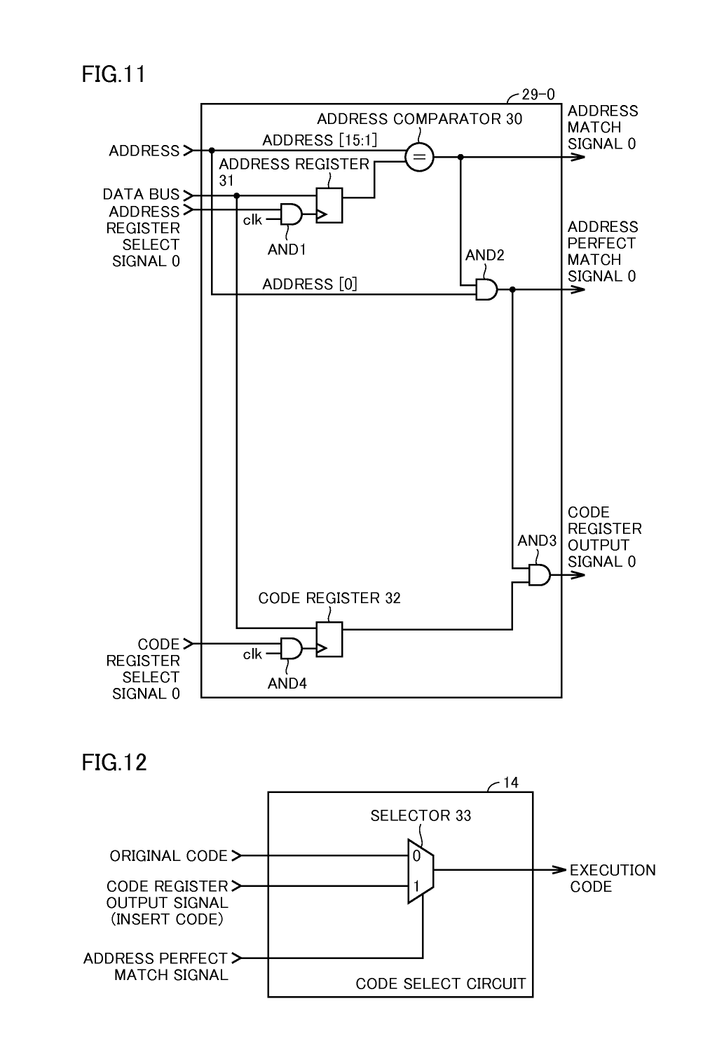

FIG. 12 is a diagram showing a configuration of code select circuit 14.

As shown in FIG. 12, code select circuit 14 includes a selector 33.

Selector 33 receives the original code which is output from flash control code ROM 13 and receives the code register output signal (insert code) which is output from insert code register set block 17. Selector 33 outputs one of the two input signals based on the address perfect match signal. When the address perfect match signal is “H” level, selector 33 outputs the code register output signal (insert code). When the address perfect match signal is “L” level, selector 33 outputs the original code as an execution code.

(Example Operation 1 of First Embodiment)

Next, an example operation in the case where the original codes and the insert code are single-cycle instructions will be described.

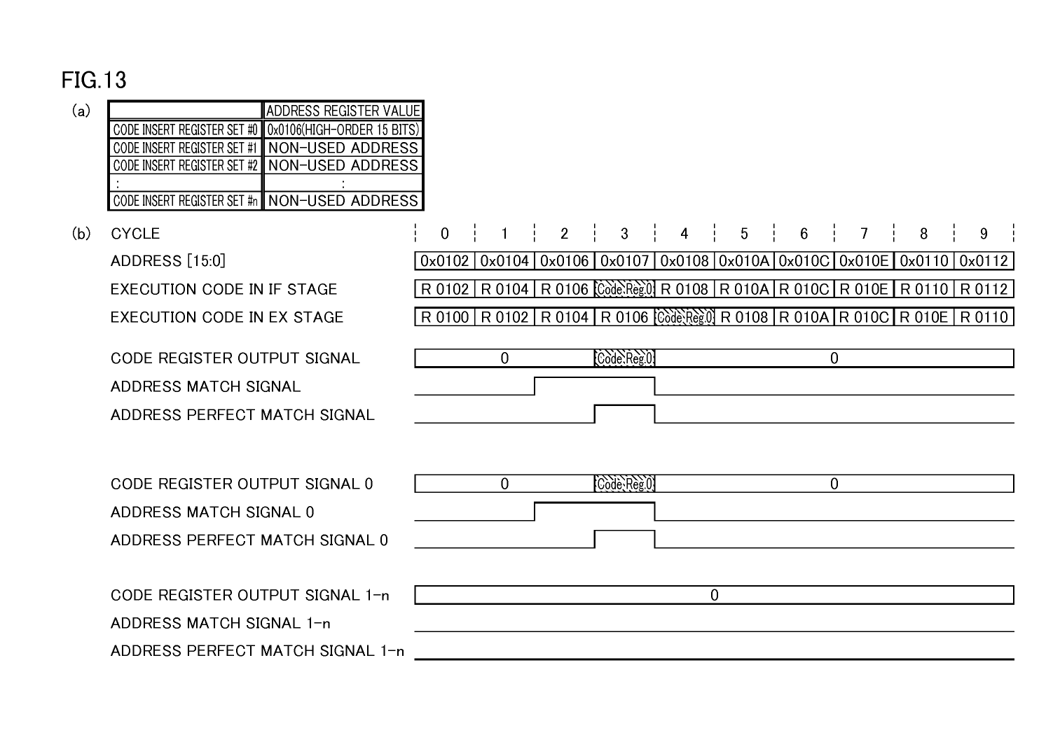

FIG. 13 (a) is a diagram showing an example of values retained in address register 31 of code insert register set 29-i (hereinafter code insert register set #i). In this example, address register 31 of code insert register set #0 retains the high-order 15 bits (2nd bit to 16th bit) of “0x0106”. The first bit is herein the LSB (Least Significant Bit) and an X-th bit is higher by (X−1) bits than the LSB.

In code register 32 of code insert register set #0, an insert code “Code Reg.0” is retained. An original code “R . . . ” is retained at an address “0x . . . ” in flash control code ROM 13.

FIG. 13 (b) is a timing diagram under the conditions in FIG. 13 (a).

In the 0th cycle, the 16-bit address (PC (Program Counter) value [15:0]) which is output from program counter 12 is “0x0102”. The high-order 15 bits of address “0x0102” are different from the high-order 15 bits of address “0x0106” retained in address register 31 of code insert register set #0. Accordingly, the address match signal and the address perfect match signal are “L” level and the code register output signal is “0x000”. From flash control code ROM 13, “R0102” which is an original code at address “0x0102” is output. Since the address perfect match signal is “L” level, code select circuit 14 outputs original code “R0102” to fetch unit 35 of instruction execution unit 15. Execution unit 36 of instruction execution unit 15 executes original code “R0100” which is output to fetch unit 35 in the immediately preceding cycle.

In the first cycle, selector 24 of program counter 12 outputs “0x02” since the address match signal in the preceding cycle is “L” level. Accordingly, the output address of program counter 12 is “0x0104” determined by adding “0x02”. The high-order 15 bits of address “0x0104” are different from the high-order 15 bits of address “0x0106” retained in address register 31 of code insert register set #0. Accordingly, the address match signal and the address perfect match signal are “L” level and the code register output signal is “0x0000”. From flash control code ROM 13, original code “R0104” at address “0x0104” is output. Since the address perfect match signal is “L” level, code select circuit 14 outputs original code “R0104” to fetch unit 35 of instruction execution unit 15. Execution unit 36 of instruction execution unit 15 executes original code “R0102” which is output to fetch unit 35 in the immediately preceding cycle.

In the second cycle, selector 24 of program counter 12 outputs “0x02” since the address match signal in the preceding cycle is “L” level. Accordingly, the output address of program counter 12 is “0x0106” determined by adding “0x02”. The high-order 15 bits of address “0x0106” match the high-order 15 bits of address “0x0106” retained in address register 31 of code insert register set #0. Accordingly, the address match signal is “H” level (since address match signal 0 is “H” level). Meanwhile, the least significant bit of the output address of program counter 12 is “0”. Accordingly, the address perfect match signal is still “L” level and the code register output signal is still “0x0000”. From flash control code ROM 13, original code “R0106” at address “0x0106” is output. Since the address perfect match signal is “L” level, code select circuit 14 outputs original code “R0106” to fetch unit 35 of instruction execution unit 15. Execution unit 36 of instruction execution unit 15 executes original code “R0104” which is output to fetch unit 35 in the immediately preceding cycle.

In the third cycle, selector 24 of program counter 12 outputs “0x01” since the address match signal in the preceding cycle is “H” level. Accordingly, the output address of program counter 12 is “0x0107” determined by adding “0x01”. The high-order 15 bits of address “0x0107” match the high-order 15 bits of address “0x0106” retained in address register 31 of code insert register set #0. Accordingly, the address match signal is “H” level (since address match signal 0 is “H” level). Meanwhile, the least significant bit of the output address of program counter 12 is “1”. Accordingly, the address perfect match signal is “H” level (since address perfect match signal 0 is “H” level). Further, the code register output signal is insert code “Code Reg.0” retained in code register 32 (since code register output signal 0 is “Code Reg.0”). Since the address perfect match signal is “H” level, code select circuit 14 outputs insert code “Code Reg.0” to fetch unit 35 of instruction execution unit 15. Execution unit 36 of instruction execution unit 15 executes original code “R0106” which is output to fetch unit 35 in the immediately preceding cycle.

In the fourth cycle, selector 24 of program counter 12 outputs “0x01” since the address match signal in the preceding cycle is “H” level. Accordingly, the output address of program counter 12 is “0x0108” determined by adding “0x01” The high-order 15 bits of address “0x0108” are different from the high-order 15 bits of address “0x0108” retained in address register 31 of code insert register set #0. Accordingly, the address match signal and the address perfect match signal are “L” level and the code register output signal is “0x0000”. From flash control code ROM 13, original code “R0108” at address “0x0108” is output. Since the address perfect match signal is “L” level, code select circuit 14 outputs original code “R0108” to fetch unit 35 of instruction execution unit 15. Execution unit 36 of instruction execution unit 15 executes insert code “Code Reg.0” which is output to fetch unit 35 in the immediately preceding cycle.

In the fifth and its subsequent cycles, the operation is performed similarly to that in the fourth cycle.

(Example Operation 2 of First Embodiment)

Next, an operation in the case where a part of the original codes is a multicycle instruction and the insert code is a single-cycle instruction will be described.

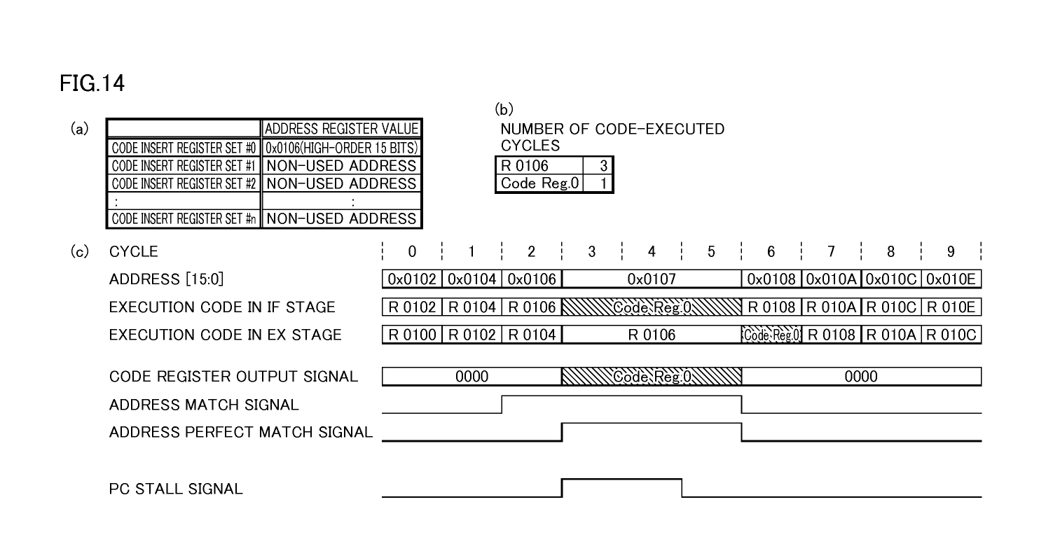

FIG. 14 (a) is a diagram showing an example of values retained in address register 31 of code insert register set 29-i (hereinafter code insert register set #i). In this example, address register 31 of code insert register set #0 retains the high-order 15 bits (2nd bit to 16th bit) of “0x0106”, address register 31 of code insert register set #1 retains the high-order 15 bits of “0x8000”, and address register 31 of code insert register set #2 retains the high-order 15 bits of “0x8002”. Code register 32 of code insert register set #0 retains insert code “Code Reg.0”. An original code “R . . . ” is retained at an address “0x . . . ” in flash control code ROM 13.

As shown in FIG. 14 (b), original code “R0106” is a three-cycle instruction, the other original codes are each a single-cycle instruction, and insert code “Code Reg.0” is a single-cycle instruction.

FIG. 14 (c) is a timing diagram under the conditions indicated in FIGS. 14 (a) and (b).

In the 0-th cycle, the 16-bit address (PC value [15:0]) which is output from program counter 12 is “0x0102”. The high-order 15 bits of address “0x0102” are different from the high-order 15 bits of address “0x0106” retained in address register 31 of code insert register set #0. Accordingly, the address match signal and the address perfect match signal are “L” level and the code register output signal is “0x0000”. From flash control code ROM 13, “R0102” which is an original code at address “0x0102” is output. Since the address perfect match signal is “L” level, code select circuit 14 outputs original code “R0102” to fetch unit 35 of instruction execution unit 15. Execution unit 36 of instruction execution unit 15 executes original code “R0100” which is output to fetch unit 35 in the immediately preceding cycle.

In the first cycle, selector 24 of program counter 12 outputs “0x02” since the address match signal in the preceding cycle is “L” level. Accordingly, the output address of program counter 12 is “0x0104” determined by adding “0x02”. The high-order 15 bits of address “0x0104” are different from the high-order 15 bits of address “0x0106” retained in address register 31 of code insert register set #0. Accordingly, the address match signal and the address perfect match signal are “L” level and the code register output signal is “0x0000”. From flash control code ROM 13, original code “R0104” at address “0x0104” is output. Since the address perfect match signal is “L” level, code select circuit 14 outputs original code “R0104” to fetch unit 35 of instruction execution unit 15. Execution unit 36 of instruction execution unit 15 executes original code “R0102” which is output to fetch unit 35 in the immediately preceding cycle.

In the second cycle, selector 24 of program counter 12 outputs “0x02” since the address match signal in the preceding cycle is “L” level. Accordingly, the output address of program counter 12 is “0x0106” determined by adding “0x02”. The high-order 15 bits of address “0x0106” match the high-order 15 bits of address “0x0106” retained in address register 31 of code insert register set #0. Accordingly, the address match signal is “H” level (since address match signal 0 is “H” level). Meanwhile, the least significant bit of the output address of program counter 12 is “0”. Accordingly, the address perfect match signal is still “L” level and the code register output signal is still “0x0000”. From flash control code ROM 13, original code “R0106” at address “0x0106” is output. Since the address perfect match signal is “L” level, code select circuit 14 outputs original code “R0106” to fetch unit 35 of instruction execution unit 15. Execution unit 36 of instruction execution unit 15 executes original code “R0104” which is output to fetch unit 35 in the immediately preceding cycle.

In the third cycle, selector 24 of program counter 12 outputs “0x01” since the address match signal in the preceding cycle is “H” level. Accordingly, the output address of program counter 12 is “0x0107” determined by adding “0x01”. The high-order 15 bits of address “0x0107” match the high-order 15 bits of address “0x0106” retained in address register 31 of code insert register set #0. Accordingly, the address match signal is “H” level (since address match signal 0 is “H” level). The least significant bit of the output address of program counter 12 is “1” since the addition of “0x01” is performed. Accordingly, the address perfect match signal is “H” level (since address perfect match signal 0 is “H” level). Further, the code register output signal is insert code “Code Reg.0” retained in code register 32 (since code register output signal 0 is “Code Reg.0”). Since the address perfect match signal is “H” level, code select circuit 14 outputs insert code “Code Reg.0” to fetch unit 35 of instruction execution unit 15. Execution unit 36 of instruction execution unit 15 executes original code “R0106” which is output to fetch unit 35 in the immediately preceding cycle. Since original code “R0106” is a three-cycle instruction, execution unit 36 sets the PC stall signal to “H” level.

In the fourth cycle, program counter 12 outputs the same address “0x0107” as the address of the preceding cycle, since the PC stall signal is set to “H” level in the preceding cycle. The high-order 15 bits of address “0x0107” match the high-order 15 bits of address “0x0106” retained in address register 31 of code insert register set #0. Accordingly, the address match signal is “H” level (since address match signal 0 is “H” level). Meanwhile, the least significant bit of the output address of program counter 12 is “1”. Accordingly, the address perfect match signal is “H” level (since address perfect match signal 0 is “H” level). Further, the code register output signal is insert code “Code Reg.0” retained in code register 32 (since code register output signal 0 is “Code Reg.0”). Since the address perfect match signal is “H” level, code select circuit 14 outputs insert code “Code Reg.0” to fetch unit 35 of instruction execution unit 15. Execution unit 36 of instruction execution unit 15 continues executing original code “R0106” which is a three-cycle instruction (execution in two cycles is completed).

In the fifth cycle, program counter 12 outputs the same address “0x0107” as the address of the preceding cycle, since the PC stall signal is set to “H” level in the preceding cycle. The high-order 15 bits of address “0x0107” match the high-order 15 bits of address “0x0106” retained in address register 31 of code insert register set #0. Accordingly, the address match signal is “H” level (since address match signal 0 is “H” level). Since the least significant bit of the output address of program counter 12 is “1”, address perfect match signal is “H” level (since address perfect match signal 0 is “H” level). Further, the code register output signal is insert code “Code Reg.0” retained in code register 32 (since code register output signal 0 is “Code Reg.0”). Since the address perfect match signal is “H” level, code select circuit 14 outputs insert code “Code Reg.0” to fetch unit 35 of instruction execution unit 15. Execution unit 36 of instruction execution unit 15 continues executing original code “R0106” which is a three-cycle instruction (execution in three cycles is completed). Completing execution of original code “R0106” which is a three-cycle instruction, execution unit 36 sets the PC stall signal to “L” level.

In the sixth cycle, selector 24 of program counter 12 outputs “0x01” since the address match signal in the preceding cycle is “H” level. Accordingly, the output address of program counter 12 is “0x0108” determined by adding “0x01”. The high-order 15 bits of address “0x0108” are different from the high-order 15 bits of address “0x0106” retained in address register 31 of code insert register set #0. Accordingly, the address match signal and the address perfect match signal are “L” level and the code register output signal is “0x0000”. From flash control code ROM 13, original code “R0108” at address “0x0108” is output. Since the address perfect match signal is “L” level, code select circuit 14 outputs original code “R0108” to fetch unit 35 of instruction execution unit 15. Execution unit 36 of instruction execution unit 15 executes insert code “Code Reg.0” which is output to fetch unit 35 in the immediately preceding cycle.

In the seventh cycle, selector 24 of program counter 12 outputs “0x02” since the address match signal in the preceding cycle is “L” level. Accordingly, the output address of program counter 12 is “0x010A” determined by adding “0x02”. The high-order 15 bits of address “0x010A” are different from the high-order 15 bits of address “0x0106” retained in address register 31 of code insert register set #0. Accordingly, the address match signal and the address perfect match signal are “L” level and the code register output signal is “0x0000”. From flash control code ROM 13, original code “R010A” at address “0x010A” is output. Since the address perfect match signal is “L” level, code select circuit 14 outputs original code “R010A” to fetch unit 35 of instruction execution unit 15. Execution unit 36 of instruction execution unit 15 executes original code “R0108” which is output to fetch unit 35 in the immediately preceding cycle.

In the eighth and its subsequent cycles, the operation is performed similarly to that in the seventh cycle.

(Example Operation 3 of First Embodiment)

Next, an operation in the case where the original codes are single-cycle instructions and the insert code is a multicycle instruction will be described.

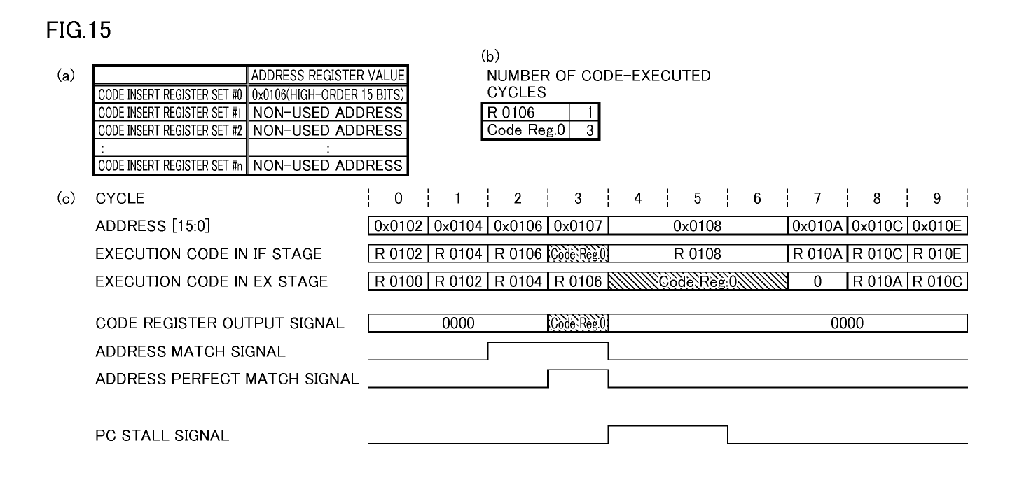

FIG. 15 (a) is a diagram showing an example of values retained in address register 31 of code insert register set 29-i (hereinafter code insert register set #i). In this example, address register 31 of code insert register set #0 retains the high-order 15 bits of “0x0106”, address register 31 of code insert register set #1 retains the high-order 15 bits of “0x8000”, and address register 31 of code insert register set #2 retains the high-order 15 bits of “0x8002”. Code register 32 of code insert register set #0 retains insert code “Code Reg.0”. An original code “R . . . ” is retained at an address “0x . . . ” in flash control code ROM 13.

As shown in FIG. 15 (b), original code “R0106” is a single-cycle instruction, the other original codes are also single-cycle instructions, and insert code “Code Reg.0” is a three-cycle instruction.

FIG. 15 (c) is a timing diagram under the conditions indicated in FIGS. 15 (a) and (b).

In the 0-th cycle, the 16-bit address (PC value [15:0]) which is output from program counter 12 is “0x0102”. The high-order 15 bits of address “0x0102” are different from the high-order 15 bits of address “0x0106” retained in address register 31 of code insert register set #0. Accordingly, the address match signal and the address perfect match signal are “L” level and the code register output signal is “0x0000”. From flash control code ROM 13, “R0102” which is an original code at address “0x0102” is output. Since the address perfect match signal is “L” level, code select circuit 14 outputs original code “R0102” to fetch unit 35 of instruction execution unit 15. Execution unit 36 of instruction execution unit 15 executes original code “R0100” which is output to fetch unit 35 in the immediately preceding cycle.

In the first cycle, selector 24 of program counter 12 outputs “0x02” since the address match signal in the preceding cycle is “L” level. Accordingly, the output address of program counter 12 is “0x0104” determined by adding “0x02”. The high-order 15 bits of address “0x0104” are different from the high-order 15 bits of address “0x0106” retained in address register 31 of code insert register set #0. Accordingly, the address match signal and the address perfect match signal are “L” level and the code register output signal is “0x0000”. From flash control code ROM 13, original code “R0104” at address “0x0104” is output. Since the address perfect match signal is “L” level, code select circuit 14 outputs original code “R0104” to fetch unit 35 of instruction execution unit 15. Execution unit 36 of instruction execution unit 15 executes original code “R0102” which is output to fetch unit 35 in the immediately preceding cycle.

In the second cycle, selector 24 of program counter 12 outputs “0x02” since the address match signal in the preceding cycle is “L” level. Accordingly, the output address of program counter 12 is “0x0106” determined by adding “0x02”. The high-order 15 bits of address “0x0106” match the high-order 15 bits of address “0x0106” retained in address register 31 of code insert register set #0. Accordingly, the address match signal is “H” level (since address match signal 0 is “H” level). Meanwhile, the least significant bit of the output address of program counter 12 is “0”. Accordingly, the address perfect match signal is still “L” level and the code register output signal is still “0x000”. From flash control code ROM 13, original code “R0106” at address “0x0106” is output. Since the address perfect match signal is “L” level, code select circuit 14 outputs original code “R0106” to fetch unit 35 of instruction execution unit 15. Execution unit 36 of instruction execution unit 15 executes original code “R0104” which is output to fetch unit 35 in the immediately preceding cycle.

In the third cycle, selector 24 of program counter 12 outputs “0x01” since the address match signal in the preceding cycle is “H” level. Accordingly, the output address of program counter 12 is “0x0107” determined by adding “0x01”. The high-order 15 bits of address “0x0107” match the high-order 15 bits of address “0x0106” retained in address register 31 of code insert register set #0. Accordingly, the address match signal is “H” level (since address match signal 0 is “H” level). The least significant bit of the output address of program counter 12 is “1” since the addition of “0x01” is performed. Accordingly, the address perfect match signal is “H” level (since address perfect match signal 0 is “H” level). Further, the code register output signal is insert code “Code Reg.0” retained in code register 32 (since code register output signal 0 is “Code Reg.0”). Since the address perfect match signal is “H” level, code select circuit 14 outputs insert code “Code Reg.0” to fetch unit 35 of instruction execution unit 15. Execution unit 36 of instruction execution unit 15 executes original code “R00106” which is output to fetch unit 35 in the immediately preceding cycle.

In the fourth cycle, selector 24 of program counter 12 outputs “0x01” since the address match signal in the preceding cycle is “H” level. Accordingly, the output address of program counter 12 is “0x0108” determined by adding “0x01”. The high-order 15 bits of address “0x0108” are different from the high-order 15 bits of address “0x0106” retained in address register 31 of code insert register set #0. Accordingly, the address match signal and the address perfect match signal are “L” level and the code register output signal is “0x0000”. From flash control code ROM 13, original code “R0108” at address “0x0108” is output. Since the address perfect match signal is “L” level, code select circuit 14 outputs original code “R0108” to fetch unit 35 of instruction execution unit 15. Execution unit 36 of instruction execution unit 15 executes insert code “Code Reg.0” which is output to fetch unit 35 in the immediately preceding cycle. Since insert code “Code Reg.0” is a three-cycle instruction, execution unit 36 sets the PC stall signal to “H” level.

In the fifth cycle, program counter 12 outputs the same address “0x0108” as the address of the preceding cycle, since the PC stall signal is set to “H” level in the preceding cycle. The high-order 15 bits of address “0x0108” are different from the high-order 15 bits of address “0x0106” retained in address register 31 of code insert register set #0. Accordingly, the address match signal and the address perfect match signal are “L” level and the code register output signal is “0x0000”. Execution unit 36 of instruction execution unit 15 continues executing insert code “Code Reg.0” which is a three-cycle instruction (execution in two cycles is completed).

In the sixth cycle, program counter 12 outputs the same address “0x0108” as the address of the preceding cycle, since the PC stall signal is set to “H” level in the preceding cycle. The high-order 15 bits of address “0x0108” are different from the high-order 15 bits of address “0x0106” retained in address register 31 of code insert register set #0. Accordingly, the address match signal and the address perfect match signal are “L” level and the code register output signal is “0x0000”. Execution unit 36 of instruction execution unit 15 continues executing insert code “Code Reg.0” which is a three-cycle instruction (execution in three cycles is completed). Completing execution of insert code “Code Reg.0” which is a three-cycle instruction, execution unit 36 sets the PC stall signal to “L” level.

In the seventh cycle, selector 24 of program counter 12 outputs “0x02” since the address match signal in the preceding cycle is “L” level. Accordingly, the output address of program counter 12 is “0x010A” determined by adding “0x02”. The high-order 15 bits of address “0x010A” are different from the high-order 15 bits of address “0x0106” retained in address register 31 of code insert register set #0. Accordingly, the address match signal and the address perfect match signal are “L” level and the code register output signal is “0x0000”. From flash control code ROM 13, original code “R010A” at address “0x010A” is output. Since the address perfect match signal is “L” level, code select circuit 14 outputs original code “R010A” to fetch unit 35 of instruction execution unit 15. Execution unit 36 of instruction execution unit 15 executes original code “R0108” which is output to fetch unit 35 in the immediately preceding cycle.

In the eighth and its subsequent cycles, the operation is performed similarly to that in the seventh cycle.

### Second Embodiment

In the present embodiment, regarding the addresses of a plurality of original codes, the (k+1)-th least significant bit and more significant bits than the (k+1)-th least significant bit in an address are valid, where k is a natural number of 1 or more.

(Configuration)

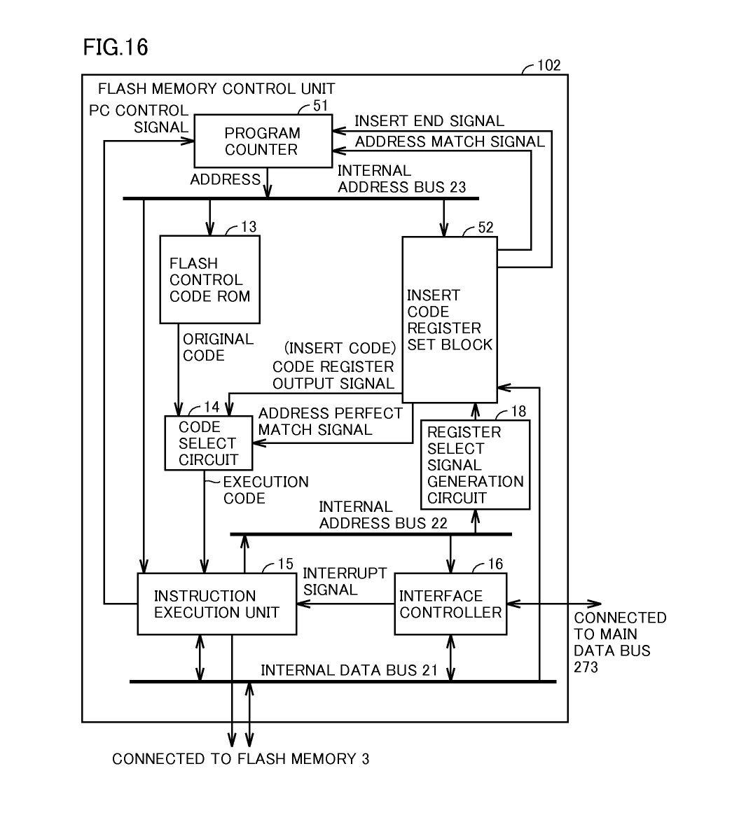

FIG. 16 is a diagram showing a configuration of a flash memory control unit 102 in a second embodiment.

Flash memory control unit 102 in FIG. 16 differs from flash memory control unit 2 in FIG. 7 in terms of program counter 51 and insert code register set block 52.

Insert code register set block 52 retains up to a maximum of 2k−1 insert codes and the addresses of the insert codes. When the bits of the address of a retained insert code except for k bits from the least significant bit match the bits of an address given from program counter 51 except for k bits from the least significant bit, insert code register set block 52 outputs a first signal (namely sets the address match signal to “H” level).

When insert code register set block 52 outputs the first signal and the k bits from the least significant bit of the address of the retained insert code match the k bits from the least significant bit of the address given from program counter 51, insert code register set block 52 outputs a second signal (namely sets the address perfect match signal to “H” level) and outputs the retained insert code corresponding to the address given from program counter 51.

In a case where a plurality of insert codes are successively inserted, insert code register set block 52 outputs the second signal and simultaneously outputs an insert end signal indicating an end of insert, when insert code register block 52 outputs the last insert code. Generation of the insert end signal will be described later herein.

Receiving the first signal, program counter 51 adds “1” to the least significant bit and, failing to receive the first signal, program counter 51 adds “1” to the (k+1)-th least significant bit. Receiving the insert end signal, program counter 51 adds “1” to the (k+1)-th least significant bit and sets the k bits from the least significant bit to “0” even when the program counter receives the first signal.

The following description will be made with k=5.

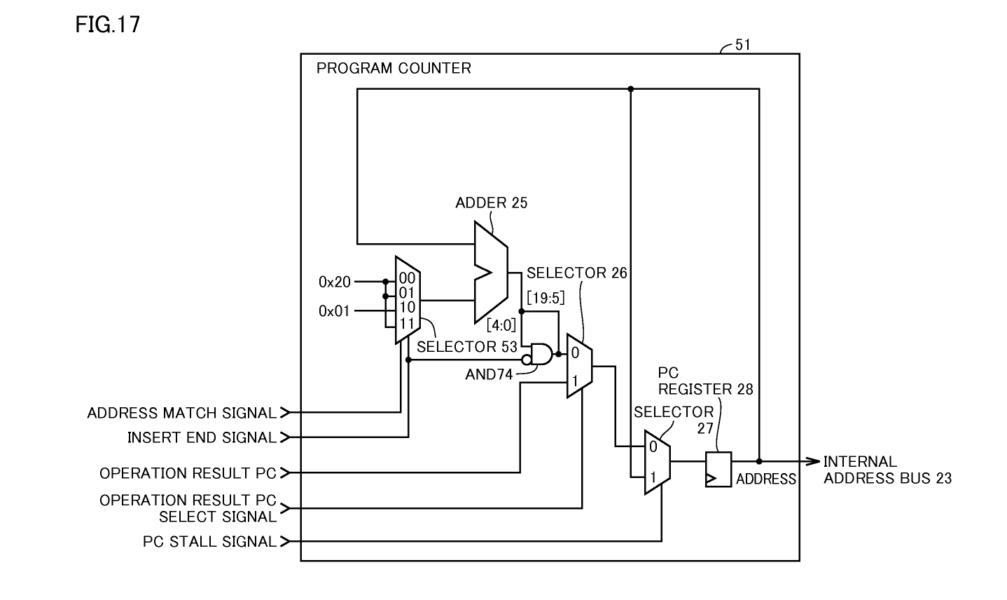

FIG. 17 is a diagram showing a configuration of program counter 51.

As shown in FIG. 17, program counter 51 includes a selector 53, an adder 25, a logic circuit AND74, a selector 26, a selector 27, and a PC register 28.

Selector 53 receives from insert code register set block 52 the address match signal and the insert end signal. Selector 53 outputs “0x01” when the address match signal is “H” level and the insert end signal is “L” level. Selector 53 outputs “0x20” when the address match signal is “H” level and the insert end signal is “H” level, or when the address match signal is “L” level and the insert end signal is “H” level, or when the address match signal is “L” level and the insert end signal is “L” level.

Adder 25 adds together a 20-bit address which is output from PC register 28 and the value which is output from selector 53.

Logic circuit AND74 outputs the logical product of the low-order 5 bits of the 20 bits which are output from adder 25 and negation of the insert end signal Namely, when the insert end signal is “L” level, logic circuit AND74 outputs the low-order 5 bits of the 20 bits output from adder 25. When the insert end signal is “H” level, logic circuit AND74 outputs 5-bit “0b00000”. “0b . . . ” herein means that the output is represented by the binary notation.

Selector 26 receives a signal in which the high-order 15 bits are the high-order 15 bits of the 20 bits which are output from adder 25 and the low-order 5 bits are the 5-bit signal which is output from logic circuit AND74, and also receives the operation result PC which is output from instruction execution unit 15. When the operation result PC select signal which is output from instruction execution unit 15 is “H” level, selector 26 outputs the operation result PC. When the operation result PC select signal is “L” level, selector 26 outputs the signal from adder 25 and logic circuit AND74.

Selector 27 receives the output from selector 26 and an address which is output from PC register 28. When the PC stall signal which is output from instruction execution unit 15 is “H” level, selector 27 outputs the address which is output from PC register 28. When the PC stall signal is “L” level, selector 27 outputs the signal received from selector 26.

PC register 28 latches the output of selector 27 and outputs, to internal address bus 23, the latched output as an address of the flash control code ROM.

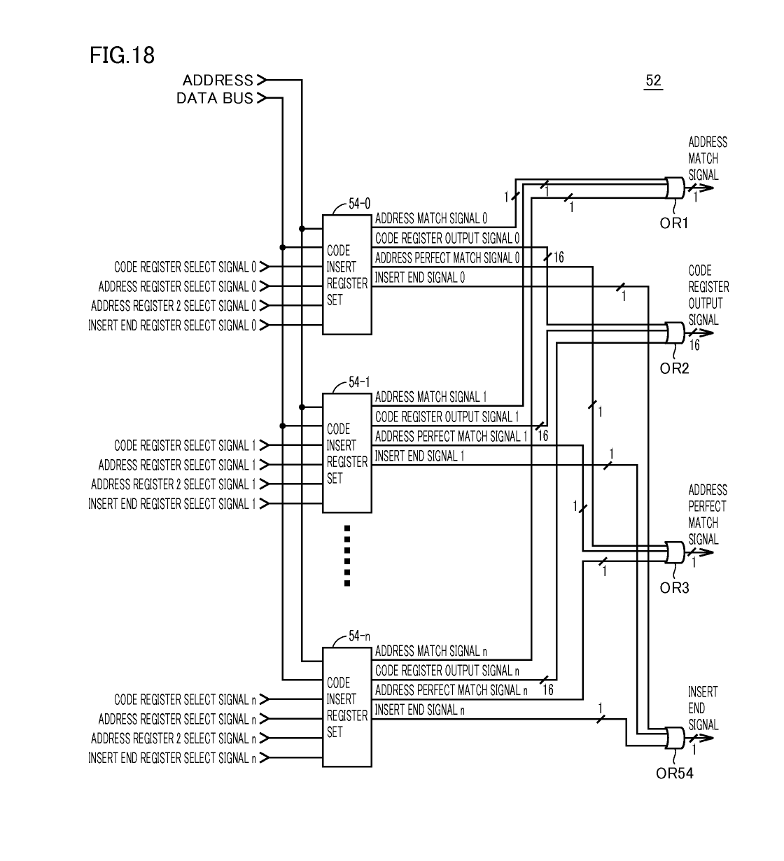

FIG. 18 is a diagram showing a configuration of insert code register set block 52.

As shown in FIG. 18, insert code register set block 52 includes a code insert register set 54-i (i=0 to n) and logic circuits OR1, OR2, OR3, OR54.

Code insert register set 54-i receives an address which is output from program counter 51 and data which is transmitted through the data bus, further receives from code select circuit 14 code register select signal i, address register select signal i, address register 2 select signal i, and insert end register select signal i, and outputs address match signal i, address perfect match signal i, insert end signal i, and code register output signal i.

Logic circuit OR1 outputs an address match signal, namely the logical sum of (n+1) address match signals 0 to n. Namely, when at least one of (n+1) address match signals 0 to n is “H” level, the address match signal is “H” level.

Logic circuit OR2 outputs a code register output signal, namely the logical sum of (n+1) code register output signals 0 to n. Namely, when at least one of (n+1) code register output signals 0 to n has an “H” level bit (namely when the insert code is output), the code register output signal is the insert code. Namely, when all bits of (n+1) code register output signals 0 to n are “L” level (namely when the insert code is not output), all bits of the code register output signal are “L”.

Logic circuit OR3 outputs an address perfect match signal, namely the logical sum of (n+1) address perfect match signals 0 to n. Namely, when at least one of (n+1) address perfect match signals 0 to n is “H” level, the address perfect match signal is “H” level.

Logic circuit OR54 outputs an insert end signal, namely the logical sum of (n+1) insert end signals 0 to n. Namely, when at least one of (n+1) insert end signals 0 to n is “H” level, the insert end signal is “H” level.

In FIG. 18, address match signals 0 to n and the address match signal are 1-bit signals. Address perfect match signals 0 to n and the address perfect match signal are 1-bit signals. Insert end signals 0 to n and the insert end signal are 1-bit signals. Code register output signals 0 to n and the code register output signal are 16-bit signals.

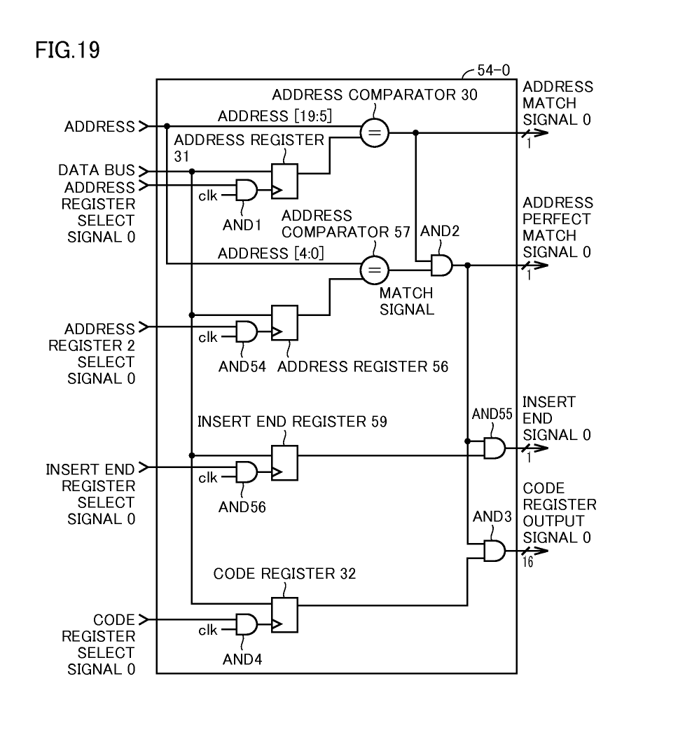

FIG. 19 is a diagram showing a configuration of code insert register set 54-0. Code insert register sets 54-1 to 54-n are configured similarly to code insert register set 54-0 in FIG. 19.

As shown in FIG. 19, code insert register set 54-0 includes a logic circuit AND1, an address register 31, an address comparator 30, a logic circuit AND4, a code register 32, a logic circuit 54, an address register 56, an address comparator 57, a logic circuit 56, an insert end register 59, a logic circuit AND2, a logic circuit 55, and a logic circuit AND3.

Logic circuit AND1 outputs to a control terminal of address register 31 an “H” level signal when both clock clk and address register select signal 0 are “H” level.

When the input to the control terminal is “H” level, address register 31 latches and retains the 15-bit address (namely the address where the insert code is to be inserted) which is sent through the data bus.

Address comparator 30 sets address match signal 0 to “H” level when the high-order 15 bits (address [19:5]) of the 20-bit address which is output from program counter 12 and the 15-bit address which is retained in address register 31 match each other.

Logic circuit AND54 outputs to a control terminal of code register 32 an “H” level signal when both clock clk and address register 2 select signal 0 are “H” level.

When the input to the control terminal is “H” level, address register 56 latches and retains the 5-bit address which is sent through the data bus. In this address register 56, addresses indicating the order in which a plurality of insert codes, which are to be successively inserted, are inserted.

Address comparator 57 outputs a match signal of “H” level when the low-order 5 bits (address [4:0]) of the 20-bit address which is output from program counter 12 match a 5-bit address retained in address register 56.

Logic circuit AND2 sets address perfect match signal 0 to “H” level when address match signal 0 is “H” level and the match signal which is output from address comparator 57 is “H” level.

Logic circuit AND56 outputs an “H” level signal to a control terminal of insert end register 59 when both clock clk and insert end register select signal 0 are “H” level.

Insert end register 59 latches and retains 1-bit data (insert end) which is sent through the data bus, when the input to the control terminal is “H” level. The fact that the “H” (“1”) data is retained in corresponding insert end register 59 in code insert register set 54-0 means that insertion of codes is temporarily ended in response to insertion of the insert code of the corresponding code insert register set.

Logic circuit AND55 receives address perfect match signal 0 and the output of insert end register 59. When address perfect match signal 0 is “H” level, logic circuit AND55 outputs, as insert end signal 0, the 1-bit data (insert end) retained in insert end register 59.

Logic circuit AND4 outputs an “H” level signal to a control terminal of code register 32 when both clock clk and code register select signal 0 are “H” level.

Code register 32 latches and retains, when the input to the control terminal is “H” level, the 16-bit data (namely the insert code) which is sent through the data bus.

Logic circuit AND3 receives address perfect match signal 0 and the output of code register 32. When address perfect match signal 0 is “H” level, logic circuit AND3 outputs, as code register output signal 0, the 16-bit data (namely the insert code) retained in code register 32. When address perfect match signal 0 is “L” level, logic circuit AND3 outputs, as code register output signal 0, 16-bit “0x0000”.

In FIG. 19, address match signal 0 is a 1-bit signal. Address perfect match signal 0 is 1-bit signal. Insert end signal 0 is a 1-bit signal. Code register output signal 0 is a 16-bit signal. These features of the signals are applied as well to other drawings.

Example Operation of Second Embodiment:

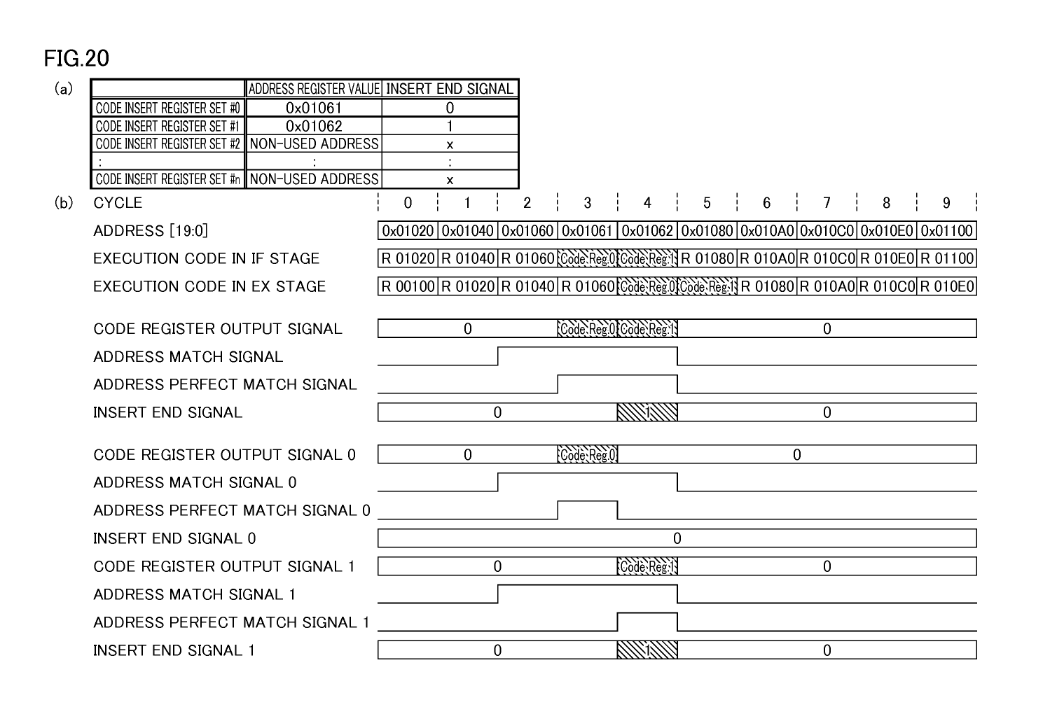

FIG. 20 (a) is a diagram showing an example of values retained in address register 31 of code insert register set 29-i (hereinafter code insert register set #i). In this example, address register 31 of code insert register set #0 retains the high-order 15 bits (6th bit to 20th bit) of “0x01061”, and address register 56 retains the low-order 5 bits (1st bit to 5th bit) of “0x01061”. Code register 32 of code insert register set #0 retains insert code “Code Reg.0”, and insert end register 59 of code insert register set #0 retains insert end “0b0”.

Address register 31 of code insert register set #1 retains the high-order 15 bits of “0x01062”, and address register 56 retains the low-order 5 bits of “0x01062”. Code register 32 of code insert register set #1 retains insert code “Code Reg.1”, and insert end register 59 of code insert register set #1 retains insert end “0b1”. An original code “R . . . ” is retained at an address “0x . . . ” in flash control code ROM 13.

FIG. 20 (b) is a timing diagram under the conditions in FIG. 20 (a).

In the 0th cycle, the 20-bit address (PC value [19:0]) which is output from program counter 51 is “0x01020”. The high-order 15 bits of address “0x01020” are different from the high-order 15 bits of address “0x01061” retained in address register 31 of code insert register set #0, and also different from the high-order 15 bits of address “0x01062” retained in address register 31 of code insert register set #1. Accordingly, the address match signal and the address perfect match signal are “L” level, the code register output signal is “0x0000”, and the insert end signal is “0b0”. From flash control code ROM 13, “R01020” which is an original code at address “0x01020” is output. Since the address perfect match signal is “L” level, code select circuit 14 outputs original code “R01020” to fetch unit 35 of instruction execution unit Execution unit 36 of instruction execution unit 15 executes original code “R01000” which is output to fetch unit 35 in the immediately preceding cycle.

In the first cycle, selector 53 of program counter 51 outputs “0x20” since the address match signal in the preceding cycle is “L” level and the insert end signal is “0b0”. Accordingly, the output address of program counter 51 is “0x01040” determined by adding “0x20”. The high-order 15 bits of address “0x01040” are different from the high-order 15 bits of address “0x01061” retained in address register 31 of code insert register set 1#0, and different from the high-order 15 bits of address “0x01062” retained in address register 31 of code insert register set #1. Accordingly, the address match signal and the address perfect match signal are “L” level, the code register output signal is “0x0000”, and the insert end signal is “0b0”. From flash control code ROM 13, original code “R01040” at address “0x01020” is output. Since the address perfect match signal is “L” level, code select circuit 14 outputs original code “R01040” to fetch unit 35 of instruction execution unit 15. Execution unit 36 of instruction execution unit 15 executes original code “R01020” which is output to fetch unit 35 in the immediately preceding cycle.

In the second cycle, selector 53 of program counter 51 outputs “0x20” since the address match signal in the preceding cycle is “L” level and the insert end signal is “0b0”. Accordingly, the output address of program counter 51 is “0x01060” determined by adding “0x20”. The high-order 15 bits of address “0x01060” match the high-order 15 bits of address “0x01061” retained in address register 31 of code insert register set #0, and match the high-order 15 bits of address “0x01062” retained in address register 31 of code insert register set #1. Accordingly, the address match signal is “H” level (since address match signal 0 and address match signal 1 are “H” level). In addition, the low-order 5 bits of address “0x01060” are different from the low-order 5 bits of address “0x01061” retained in address register 56 of code insert register set #0, and different from the low-order 5 bits of address “0x01062” retained in address register 56 of code insert register set #1. Accordingly, the address perfect match signal is still “L” level (since address perfect match signal 0 and address perfect match signal 1 are still “L” level). Since the address perfect match signal is “L” level, the code register output signal is “0x0000” and the insert end signal is “0b0”. From flash control code ROM 13, original code “R01060” at address “0x01060” is output. Since the address perfect match signal is “L” level, code select circuit 14 outputs original code “R01060” to fetch unit 35 of instruction execution unit 15. Execution unit 36 of instruction execution unit 15 executes original code “R01040” which is output to fetch unit 35 in the immediately preceding cycle.

In the third cycle, selector 24 of program counter 51 outputs “0x01” since the address match signal in the preceding cycle is “H” level and the insert end signal is “0b0”. Accordingly, the output address of program counter 51 is “0x01061” determined by adding “0x01”. The high-order 15 bits of address “0x01061” match the high-order 15 bits of address “0x01061” retained in address register 31 of code insert register set #0, and match the high-order 15 bits of address “0x01062” retained in address register 31 of code insert register set #1 Accordingly, the address match signal is “H” level (since address match signal 0 and address match signal 1 are “H” level). In addition, the low-order 5 bits of address “0x01061” match the low-order 5 bits of address “0x01061” retained in address register 56 of code insert register set #0, and therefore the address perfect match signal is “H” level (since address perfect match signal 0 is “H” level). Since address perfect match signal 0 is “H” level, code register output signal 0 is insert code “Code Reg.0” retained in code register 32 of code insert register set #0. Thus, the code register output signal is insert code “Code Reg.0”. Since address perfect match signal 0 is “H” level, insert end signal 0 is insert end “0b0” retained in insert end register 59 of code insert register set #0. Accordingly, the insert end signal is “0b0”. Since the address perfect match signal is “H” level, code select circuit 14 outputs insert code “Code Reg.0” to fetch unit 35 of instruction execution unit 15. Execution unit 36 of instruction execution unit 15 executes original code “R01060” which is output to fetch unit 35 in the immediately preceding cycle.

In the fourth cycle, selector 24 of program counter 51 outputs “0x01” since the address match signal in the preceding cycle is “H” level and the insert end signal is “0b0”. Accordingly, the output address of program counter 51 is “0x01062” determined by adding “0x01”. The high-order 15 bits of address “0x01062” match the high-order 15 bits of address “0x01061” retained in address register 31 of code insert register set #0, and match the high-order 15 bits of address “0x01062” retained in address register 31 of code insert register set #1. Accordingly, the address match signal is “H” level (since address match signal 0 and address match signal 1 are “H” level). In addition, the low-order 5 bits of address “0x1062” match the low-order 5 bits of address “0x01062” retained in address register 56 of code insert register set #1, and therefore the address perfect match signal is “H” level (since address perfect match signal 1 is “H” level). Since address perfect match signal 1 is “H” level, code register output signal 1 is insert code “Code Reg.1” retained in code register 32 of code insert register set #1. Thus, the code register output signal is insert code “Code Reg.1”. Since address perfect match signal 1 is “H” level, insert end signal 1 is insert end “0b1” retained in insert end register 59 of code insert register set #1. Accordingly, the insert end signal is “0b1”. Since the address perfect match signal is “H” level, code select circuit 14 outputs insert code “Code Reg.1” to fetch unit 35 of instruction execution unit 15. Execution unit 36 of instruction execution unit 15 executes insert code “Code Reg.0” which is output to fetch unit 35 in the immediately preceding cycle.

In the fifth cycle, selector 24 of program counter 51 outputs “0x20” since the address match signal in the preceding cycle is “H” level and the insert end signal is “0b1”. Since insert end signal is “0b1”, logic circuit 74 sets the low-order 5 bits of the output of adder 25 to “0”. Accordingly, the output address of program counter 51 is “0x01080”. The high-order 15 bits of address “0x01080” are different from the high-order 15 bits of address “0x01061” retained in address register 31 of code insert register set #0, and different from the high-order 15 bits of address “0x01062” retained in address register 31 of code insert register set #1. Accordingly, the address match signal is “L” level (since address match signal 0 and address match signal 1 are “L” level). In addition, the low-order 5 bits of address “0x01080” are different from the low-order 5 bits of address “0x01061” retained in address register 56 of code insert register set #0, and different from the low-order 5 bits of address “0x01062” retained in address register 56 of code insert register set #1. Accordingly, the address perfect match signal is “L” level (since address perfect match signal 0 and address perfect match signal 1 are “L” level). Since the address perfect match signal is “L” level, the code register output signal is “0x0000” and the insert end signal is “0b0”. From flash control code ROM 13, original code “R01080” at address “0x01080” is output. Since the address perfect match signal is “L” level, code select circuit 14 outputs original code “R01080 to fetch unit 35 of instruction execution unit 15. Execution unit 36 of instruction execution unit 15 executes insert code “Code Reg.1” which is output to fetch unit 35 in the immediately preceding cycle.

In the sixth cycle, selector 53 of program counter 51 outputs “0x20” since the address match signal in the preceding cycle is “L” level and the insert end signal is “0b0”. Accordingly, the output address of program counter 51 is “0x010A0” determined by adding “0x20”. The high-order 15 bits of address “0x010A0” are different from the high-order 15 bits of address “0x01061” retained in address register 31 of code insert register set #0, and different from the high-order 15 bits of address “0x01062” retained in address register 31 of code insert register set #1 Accordingly, the address match signal and the address perfect match signal are “L” level, the code register output signal is “0x0000”, and the insert end signal is “0b0”. From flash control code ROM 13, original code “R010A0” at address “0x010A0” is output. Since the address perfect match signal is “L” level, code select circuit 14 outputs original code “R010A0” to fetch unit 35 of instruction execution unit 15. Execution unit 36 of instruction execution unit 15 executes original code “R01080” which is output to fetch unit 35 in the immediately preceding cycle.

In the seventh and its subsequent cycles, the operation is performed similarly to that in the sixth cycle.

As seen from the foregoing, the present embodiment uses the bits of the address of the program counter except for a predetermined number of bits from the least significant bit to specify the address of an original code, and uses the predetermined number of bits from the least significant bit to control insertion of a code. Therefore, one or more codes can be inserted between two original codes and a multicycle instruction can be executed. While the first embodiment has been described in which the output of program counter 12 is 16 bits, the present embodiment supposes that the output of program counter 51 is 20 bits for allowing a plurality of instruction codes to be inserted.

### Third Embodiment

(Configuration)

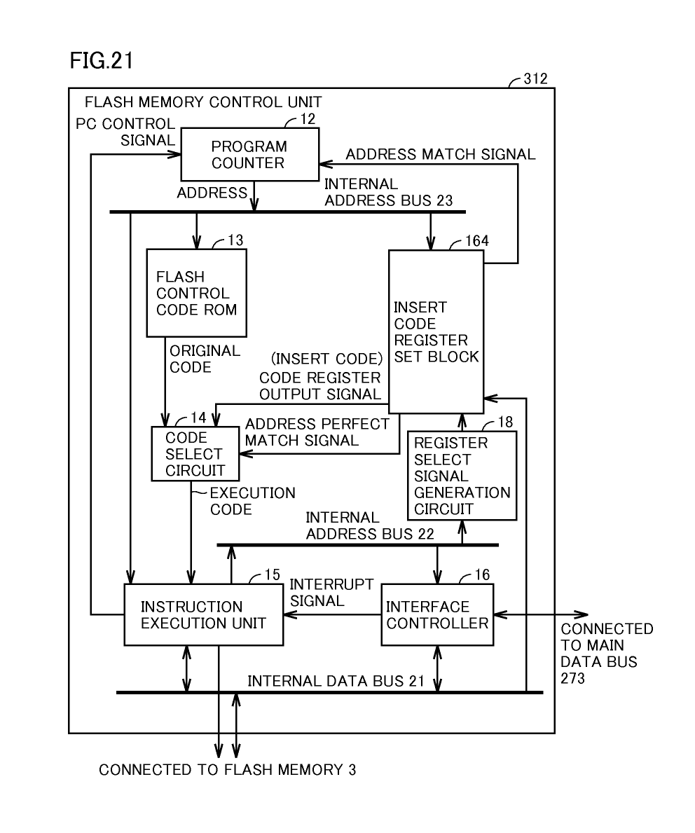

FIG. 21 is a diagram showing a configuration of a flash memory control unit 312 in a third embodiment.

Flash memory control unit 312 in FIG. 21 differs from the flash memory control unit 2 of the first embodiment in FIG. 7 in terms of insert code register set block 164.

Insert code register set block 164 outputs a first signal (namely sets the address match signal to “H” level) when the bits of the address of its retained insert code except for the least significant bit match the bits of an address given from program counter 12 except for the least significant bit. When insert code register set block 164 outputs the first signal and the least significant bit of the address of the retained insert code matches the least significant bit of the address given from program counter 12, insert code register set block 164 outputs a second signal (namely sets the address match signal to “H” level) and outputs the retained insert code.

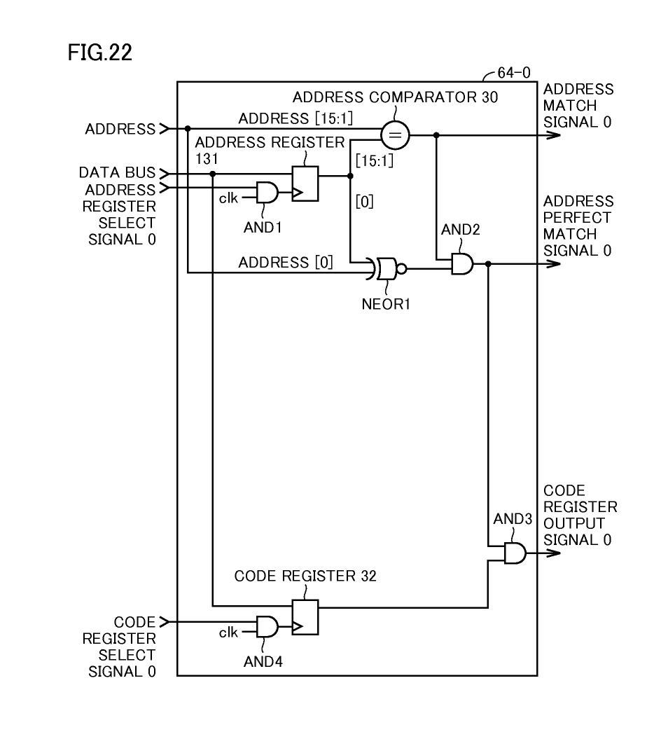

FIG. 22 is a diagram showing a configuration of code insert register set 64-0 included in insert code register set block 164. Code insert register sets 64-1 to 64-n are configured similarly to code insert register set 64-0 in FIG. 22.

Code insert register set 64-0 in FIG. 22 differs from code insert register set 29-0 of the first embodiment in FIG. 11 in that the former includes an address register 131 and a match circuit NEOR1.

Address register 131 latches and retains a 16-bit address sent through the data bus, when the output of logic circuit AND1 is “H” level.

Match circuit XNOR1 sets a match signal to “H” level, when the least significant bit (address [0]) of a 16-bit address which is output from program counter 12 matches the least significant bit of the 16-bit address retained in address register 131.

Logic circuit AND2 sets address perfect match signal 0 to “H” level, when address match signal 0 is “H” level and the match signal which is output from match circuit NROR1 is “H” level.

Example Operation of Third Embodiment:

A description will be given of an example operation in the case where an original code and an insert code before inserted are single-cycle instructions.

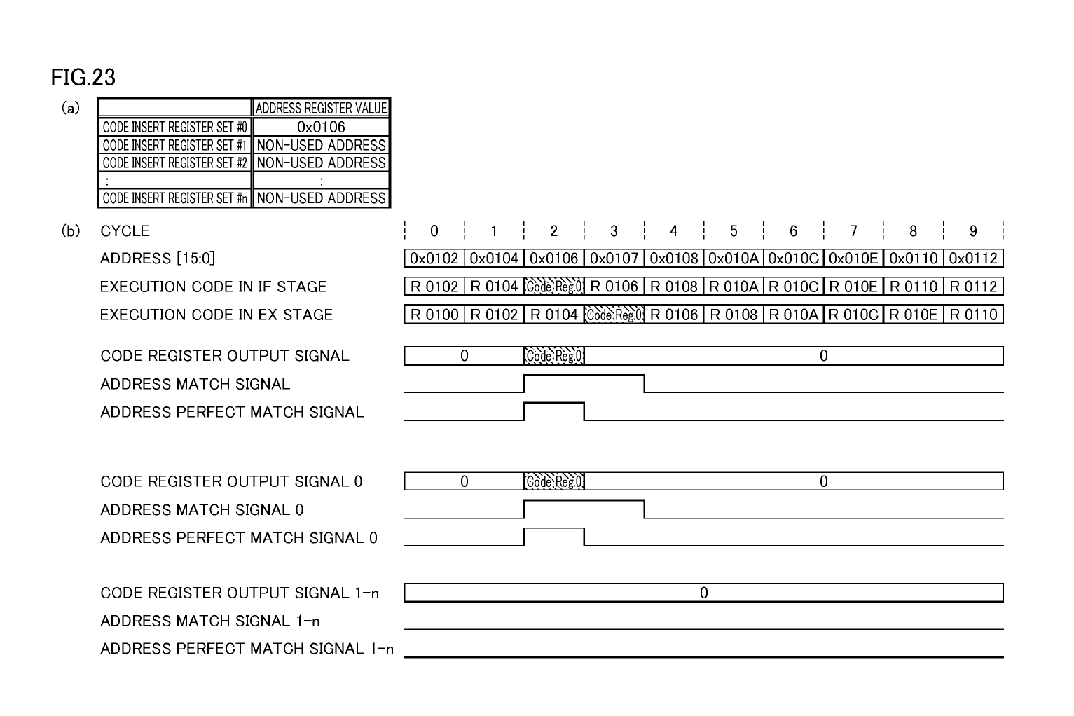

FIG. 23 (a) is a diagram showing an example of values retained in address register 31 of code insert register set 64-i (hereinafter code insert register set #i). In this example, address register 131 of code insert register set #0 retains “0x0106” of 16 bits. Code register 32 of code insert register set #0 retains insert code “Code Reg.0”. An original code “R . . . ” is retained at an address “0x . . . ” in flash control code ROM 13.

FIG. 23 (b) is a timing diagram under the conditions in FIG. 23 (a).

In the 0-th cycle, the 16-bit address (PC value [15:0]) which is output from program counter 12 is “0x0102”. The high-order 15 bits of address “0x0102” are different from the high-order 15 bits of address “0x0106” retained in address register 131. Accordingly, the address match signal and the address perfect match signal are “L” level and the code register output signal is “0x0000”. From flash control code ROM 13, “R0102” which is an original code at address “0x0102” is output. Since the address perfect match signal is “L” level, code select circuit 14 outputs original code “R0102” to fetch unit 35 of instruction execution unit 15. Execution unit 36 of instruction execution unit 15 executes original code “R0100” which is output to fetch unit 35 in the immediately preceding cycle.

In the first cycle, selector 24 of program counter 12 outputs “0x02” since the address match signal in the preceding cycle is “L” level. Accordingly, the output address of program counter 12 is “0x0104” determined by adding “0x02”. The high-order 15 bits of address “0x0104” are different from the high-order 15 bits of address “0x0106” retained in address register 131. Accordingly, the address match signal and the address perfect match signal are “L” level and the code register output signal is “0x0000”. From flash control code ROM 13, original code “R0104” at address “0x0104” is output. Since the address perfect match signal is “L” level, code select circuit 14 outputs original code “R0104” to fetch unit 35 of instruction execution unit 15. Execution unit 36 of instruction execution unit 15 executes original code “R0102” which is output to fetch unit 35 in the immediately preceding cycle.

In the second cycle, selector 24 of program counter 12 outputs “0x02” since the address match signal in the preceding cycle is “L” level. Accordingly, the output address of program counter 12 is “0x0106” determined by adding “0x02”. The high-order 15 bits of address “0x0106” match the high-order 15 bits of address “0x0106” retained in address register 131. Accordingly, the address match signal is “H” level (since address match signal 0 is “H” level). The low-order 1 bit of address “0x0106” matches the low-order 1 bit of address “0x0106” retained in address register 131, and therefore, the address perfect match signal is “H” level (since address perfect match signal 0 is “H” level). Further, the code register output signal is insert code “Code Reg.0” retained in code register 32 (since code register output signal 0 is “Code Reg.0”). Since the address perfect match signal is “H” level, code select circuit 14 outputs insert code “Code Reg.0” to fetch unit 35 of instruction execution unit 15. Execution unit 36 of instruction execution unit 15 executes original code “R0104” which is output to fetch unit 35 in the immediately preceding cycle.

In the third cycle, selector 24 of program counter 12 outputs “0x01” since the address match signal in the preceding cycle is “H” level. Accordingly, the output address of program counter 12 is “0x0107” determined by adding “0x01”. The high-order 15 bits of address “0x0107” match the high-order 15 bits of address “0x0106” retained in address register 131. Accordingly, the address match signal is “H” level (since address match signal 0 is “H” level). The low-order 1 bit of address “0x0107” is different from the low-order 1 bit of address “0x0106” retained in address register 131. Accordingly, the address perfect match signal is “L” level (since address perfect match signal 0 and the address perfect match signal are “L” level), and the code register output signal is “0x0000”. From flash control code ROM 13, original code “R0106” is output that is at address “0x0106” which is identified as identical to output address “0x0107” of program counter 12 by ignoring only the low-order 1 bit. Since the address perfect match signal is “L” level, code select circuit 14 outputs original code “R0106” to fetch unit 35 of instruction execution unit 15. Execution unit 36 of instruction execution unit 15 executes insert code “Code Reg.0” which is output to fetch unit 35 in the immediately preceding cycle.

In the fourth cycle, selector 24 of program counter 12 outputs “0x01” since the address match signal in the preceding cycle is “H” level. Accordingly, the output address of program counter 12 is “0x0108” determined by adding “0x01”. The high-order 15 bits of address “0x0108” are different from the high-order 15 bits of address “0x0106” retained in address register 131. Accordingly, the address match signal and the address perfect match signal are “L” level and the code register output signal is “0x0000”. From flash control code ROM 13, original code “R0108” at address “0x0108” is output. Since the address perfect match signal is “L” level, code select circuit 14 outputs original code “R0108” to fetch unit 35 of instruction execution unit 15. Execution unit 36 of instruction execution unit 15 executes original code “R0106” which is output to fetch unit 35 in the immediately preceding cycle.

In the fifth and its subsequent cycles, the operation is performed similarly to that in the fourth cycle.

As seen from the foregoing, the present embodiment, like the first embodiment, uses the bits of the address of the program counter except for the least significant bit to specify the address of an original code, and uses the least significant bit to control insertion of a code. Therefore, one code can be inserted between two original codes and a multicycle instruction can be executed. In accordance with the present embodiment, one of execution of an insert code after an original code (post-insertion) and execution of an insert code before an original code (pre-insertion) can be selected

### Fourth Embodiment

Configuration:

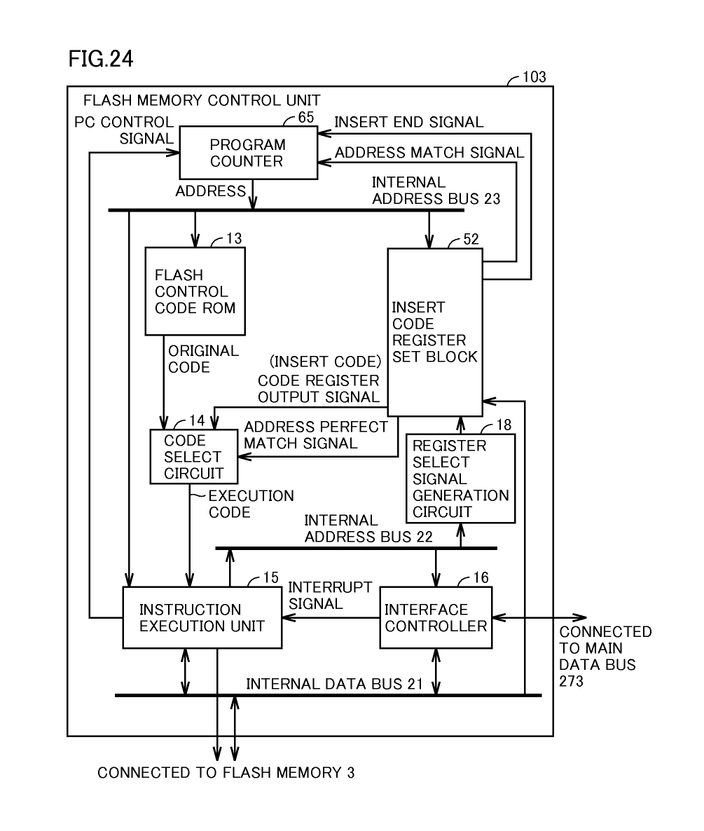

FIG. 24 is a diagram showing a configuration of a flash memory control unit 103 in a fourth embodiment.

Flash memory control unit 103 in FIG. 24 differs from flash memory control unit 102 of the second embodiment in FIG. 16 in terms of a program counter 65.

Program counter 65 sets k bits from the least significant bit to “1” when program counter 65 receives the insert end signal.

The following description will be made with k5.

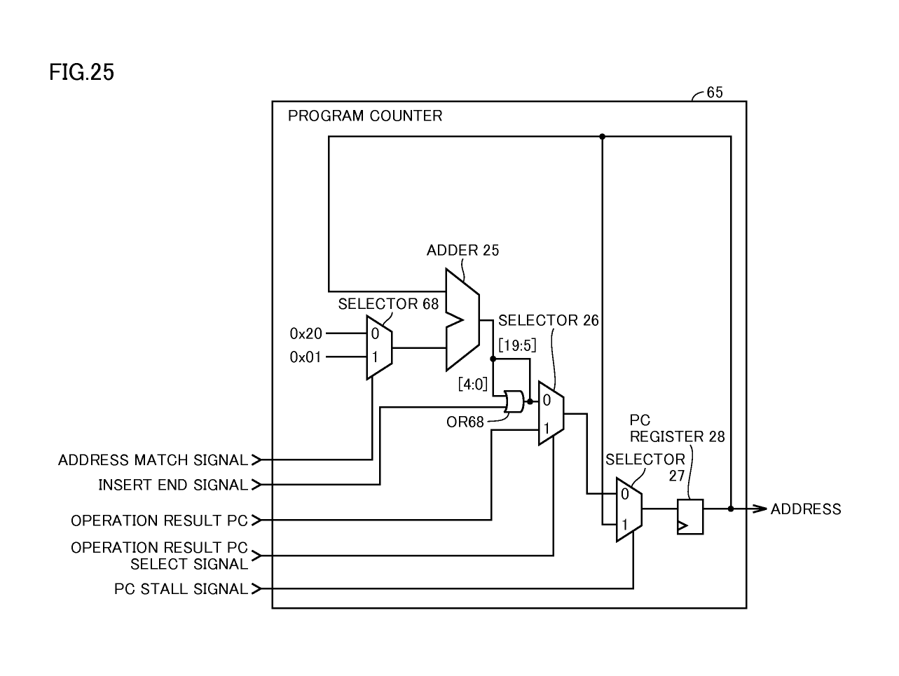

FIG. 25 is a diagram showing a configuration of program counter 65 in the fourth embodiment.

As shown in FIG. 25, program counter 65 includes a selector 68, an adder 25, a logic circuit OR68, a selector 26, a selector 27, and a PC register 28.

Selector 68 receives an address match signal from insert code register set block 52. When the address match signal is “H” level, selector 68 outputs “0x01”. When the address match signal is “L” level, selector 68 outputs “0x20”.

Adder 25 adds together a 20-bit address [19:0] which is output from PC register 28 and the value which is output from selector 68.

Logic circuit OR68 outputs the logical sum of the low-order 5 bits of the 20 bits which are output from adder 25 and the insert end signal. Namely, when the insert end signal is “L” level, logic circuit OR68 outputs the low-order 5 bits of the 20 bits which are output from adder 25. When the insert end signal is “H” level, logic circuit OR68 outputs 5-bit “0b11111”.

Selector 26 receives a signal in which the high-order 15 bits are the high-order 15 bits (6th bit to 20th bit) of the 20 bits which are output from adder 25 and the low-order 5 bits are the 5-bit signal which is output from logic circuit OR68, and also receives the operation result PC which is output from instruction execution unit 15. When the operation result PC select signal which is output from instruction execution unit 15 is “H” level, selector 26 outputs the operation result PC. When the operation result PC select signal is “L” level, selector 26 outputs the signal from adder 25 and logic circuit 58.

Selector 27 receives the output from selector 26 and an address which is output from PC register 28. When the PC stall signal which is output from instruction execution unit 15 is “H” level, selector 27 outputs the address which is output from PC register 28. When the PC stall signal is “L” level, selector 27 outputs the signal which is output from selector 26.

PC register 28 latches the output of selector 27 and outputs, to internal address bus 23, the latched output as an address of the flash control code ROM.

### 193 Example Operation of Fourth Embodiment:

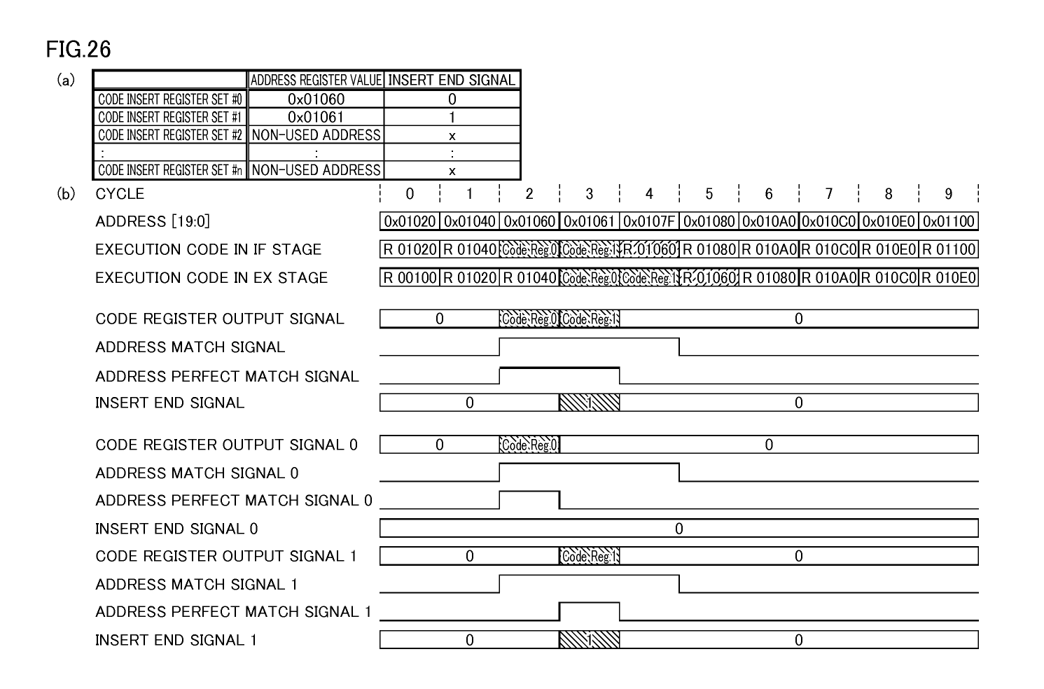

FIG. 26 (a) is a diagram showing an example of values retained in address register 31 of code insert register set 54-i (hereinafter code insert register set #i). In this example, address register 31 of code insert register set #0 retains the high-order 15 bits of “0x01060”, and address register 56 retains the low-order 5 bits of “0x01060”. Code register 32 of code insert register set #0 retains insert code “Code Reg.0”. Insert end register 59 of code insert register set #0 retains insert end “0b0”. Address register 31 of code insert register set #1 retains the high-order 15 bits of “0x01061”, and address register 56 retains the low-order 5 bits of “0x01061”. Code register 32 of code insert register set #01 retains insert code “Code Reg.1”. Insert end register 59 of code insert register set #1 retains insert end “0b1”. An original code “R . . . ” is retained at an address “0x . . . ” in flash control code ROM 13.

FIG. 26 (b) is a timing diagram under the conditions in FIG. 26 (a).

In the 0th cycle, the 20-bit address (PC value [19:0]) which is output from program counter 65 is “0x01020”. The high-order 15 bits of address “0x01020” are different from the high-order 15 bits of address “0x01060” retained in address register 31 of code insert register set #0, and different from the high-order 15 bits of address “0x01061” retained in address register 31 of code insert register set #1. Accordingly, the address match signal and the address perfect match signal are “L” level, the code register output signal is “0x0000”, and the insert end signal is “0b0”. From flash control code ROM 13, “R01020” which is an original code at address “0x01020” is output. Since the address perfect match signal is “L.” level, code select circuit 14 outputs original code “R01020” to fetch unit 35 of instruction execution unit 15. Execution unit 36 of instruction execution unit 15 executes original code “R01000” which is output to fetch unit 35 in the immediately preceding cycle.

In the first cycle, selector 68 of program counter 65 outputs “0x20” since the address match signal in the preceding cycle is “L” level. Accordingly, the output address of program counter 65 is “0x01040” determined by adding “0x20”. The high-order 15 bits of address “0x01040” are different from the high-order 15 bits of address “0x01061” retained in address register 31 of code insert register set #0, and different from the high-order 15 bits of address “0x01062” retained in address register 31 of code insert register set #1 Accordingly, the address match signal and the address perfect match signal are “L” level, the code register output signal is “0x0000”, and the insert end signal is “0b0”. From flash control code ROM 13, original code “R01040” at address “0x01040” is output. Since the address perfect match signal is “L” level, code select circuit 14 outputs original code “R01040” to fetch unit 35 of instruction execution unit 15. Execution unit 36 of instruction execution unit 15 executes original code “R01020” which is output to fetch unit 35 in the immediately preceding cycle.

In the second cycle, selector 68 of program counter 65 outputs “0x20” since the address match signal in the preceding cycle is “L” level. Accordingly, the output address of program counter 65 is “0x01060” determined by adding “0x20”. The high-order 15 bits of address “0x01060” match the high-order 15 bits of address “0x01060” retained in address register 31 of code insert register set #0, and match the high-order 15 bits of address “0x01061” retained in address register 31 of code insert register set #1. Accordingly, the address match signal is “H” level (since address match signal 0 and address match signal 1 are “H” level). In addition, the low-order 5 bits of address “0x01060” match the low-order 5 bits of address “0x01060” retained in address register 56 of code insert register set #0, and therefore the address perfect match signal is “H” level (since address perfect match signal 0 is “H” level). Since address perfect match signal 0 is “H” level, code register output signal 0 is insert code “Code Reg.0” which is retained in code register 32 of code insert register set #0. Thus, the code register output signal is insert code “Code Reg.0”. Since address perfect match signal 0 is “H” level, insert end signal 0 is insert end “0b0” retained in insert end register 59 of code insert register set #0. The insert end signal is thus “0b0”. Since the address perfect match signal is “H” level, code select circuit 14 outputs insert code “Code Reg.0” to fetch unit 35 of instruction execution unit 15. Execution unit 36 of instruction execution unit 15 executes original code “R01040” which is output to fetch unit 35 in the immediately preceding cycle.

In the third cycle, selector 68 of program counter 65 outputs “0x01” since the address match signal in the preceding cycle is “H” level. Accordingly, the output address of program counter 65 is “0x01061” determined by adding “0x01”. The high-order 15 bits (6th bit to 20th bit) of address “0x01061” match the high-order 15 bits of address “0x01060” retained in address register 31 of code insert register set #0, and match the high-order 15 bits of address “0x01061” retained in address register 31 of code insert register set #1. Accordingly, the address match signal is “H” level (since address match signal 0 and address match signal 1 are “H” level). In addition, the low-order 5 bits of address “0x01061” match the low-order 5 bits of address “0x01061” retained in address register 56 of code insert register set #1. Accordingly, the address perfect match signal is “H” level (since address perfect match signal 1 is “H” level). Since address perfect match signal 1 is “H” level, code register output signal 1 is insert code “Code Reg.1” retained in code register 32 of code insert register set #1. Thus, the code register output signal is insert code “Code Reg.1”. Since address perfect match signal 1 is “H” level, insert end signal 1 is insert end “0b1” retained in insert end register 59 of code insert register set #1. The insert end signal is thus “0b1”. Since the address perfect match signal is “H” level, code select circuit 14 outputs insert code “Code Reg.1” to fetch unit 35 of instruction execution unit 15. Execution unit 36 of instruction execution unit 15 executes insert code “Code Reg.0” which is output to fetch unit 35 in the immediately preceding cycle.

In the fourth cycle, selector 68 of program counter 65 outputs “0x01” since the address match signal in the preceding cycle is “H” level. Since the insert end signal is “0b1”, the low-order 5 bits of the 20-bit address which is output from adder 25 is set to “1” by logic circuit OR68 Accordingly, the output address of program counter 65 is “0x0107F”. The high-order 15 bits (6th bit to 20th bit) of address “0x0107F” match the high-order 15 bits of address “0x01060” retained in address register 31 of code insert register set #0, and match the high-order 15 bits of address “0x01061” retained in address register 31 of code insert register set #1. Accordingly, the address match signal is “H” level (since address match signal 0 and address match signal 1 are “H” level). In addition, the low-order 5 bits of address “0x0107F” are different from the low-order 5 bits of address “0x01060” retained in address register 56 of code insert register set #0, and different from the low-order 5 bits of address “0x01061” retained in address register 56 of code insert register set #1. Accordingly, the address perfect match signal is “L” level (since address perfect match signal 0 and the address perfect match signal are “L” level). Since the address perfect match signal is “L” level, the code register output signal is “0x0000” and the insert end signal is “0b0”. From flash control code ROM 13, original code “R01060” is output that is at address “0x01060” which is identified as identical to address “0x0107F” by ignoring its low-order 5 bits. Since the address perfect match signal is “L” level, code select circuit 14 outputs original code “R01060” to fetch unit 35 of instruction execution unit 15. Execution unit 36 of instruction execution unit 15 executes insert code “Code Reg.1” which is output to fetch unit 35 in the immediately preceding cycle.

In the fifth cycle, selector 68 of program counter 65 outputs “0x01” since the address match signal in the preceding cycle is “H” level. Since the insert end signal is “0b0”, logic circuit OR68 outputs the low-order 5 bits, as they are, of the 20-bit address which is output from adder 25. Accordingly, the output address of program counter 65 is “0x01080”. The high-order 15 bits of address “0x01080” are different from the high-order 15 bits of address “0x01060” retained in address register 31 of code insert register set #0, and different from the high-order 15 bits of address “0x01061” retained in address register 31 of code insert register set #1. Accordingly, the address match signal is “L” level (since address match signal 0 and address match signal 1 are “L” level). In addition, the low-order 5 bits of address “0x01080” are different from the low-order 5 bits of address “0x1060” retained in address register 56 of code insert register set #0, and different from the low-order 5 bits of address “0x01061” retained in address register 56 of code insert register set #1. Accordingly, the address perfect match signal is “L” level (since address perfect match signal 0 and address perfect match signal 1 are “L” level). Since the address perfect match signal is “L” level, the code register output signal is “0x0000” and the insert end signal is “0b0”. From flash control code ROM 13, original code “R01080” at address “0x01080” is output. Since the address perfect match signal is “L” level, code select circuit 14 outputs original code “R01080” to fetch unit 35 of instruction execution unit 15. Execution unit 36 of instruction execution unit 15 executes original code “R01060” which is output to fetch unit 35 in the immediately preceding cycle.

In the sixth cycle, selector 68 of program counter 65 outputs “0x20” since the address match signal in the preceding cycle is “L” level. Thus, the output address of program counter 65 is “0x010A0” determined by adding “0x20”. The high-order 15 bits of address “0x010A0” are different from the high-order 15 bits of address “0x01060” retained in address register 31 of code insert register set #0, and different from the high-order 15 bits of address “0x01061” retained in address register 31 of code insert register set #1. Accordingly, the address match signal and the address perfect match signal are “L” level, the code register output signal is “0x0000”, and the insert end signal is “0b0”. From flash control code ROM 13, original code “R010A0” at address “0x010A0” is output. Since the address perfect match signal is “L” level, code select circuit 14 outputs original code “R010A0” to fetch unit 35 of instruction execution unit 15. Execution unit 36 of instruction execution unit 15 executes original code “R01080” which is output to fetch unit 35 in the immediately preceding cycle.

In the seventh and its subsequent cycles, the operation is performed similarly to that in the sixth cycle.

As seen from the foregoing, the present embodiment, like the second embodiment, uses the bits of the address of the program counter except for a predetermined number of bits from the least significant bit to specify the address of an original code, and uses the predetermined number of bits from the least significant bit to control insertion of a code. Therefore, one or more codes can be inserted between two original codes and a multicycle instruction can be executed. In the present embodiment, in the case where the address from the program counter matches the value of the address register, execution of the insert code is done after an original code, rather than before an original code as in the second embodiment.

### Fifth Embodiment

Configuration:

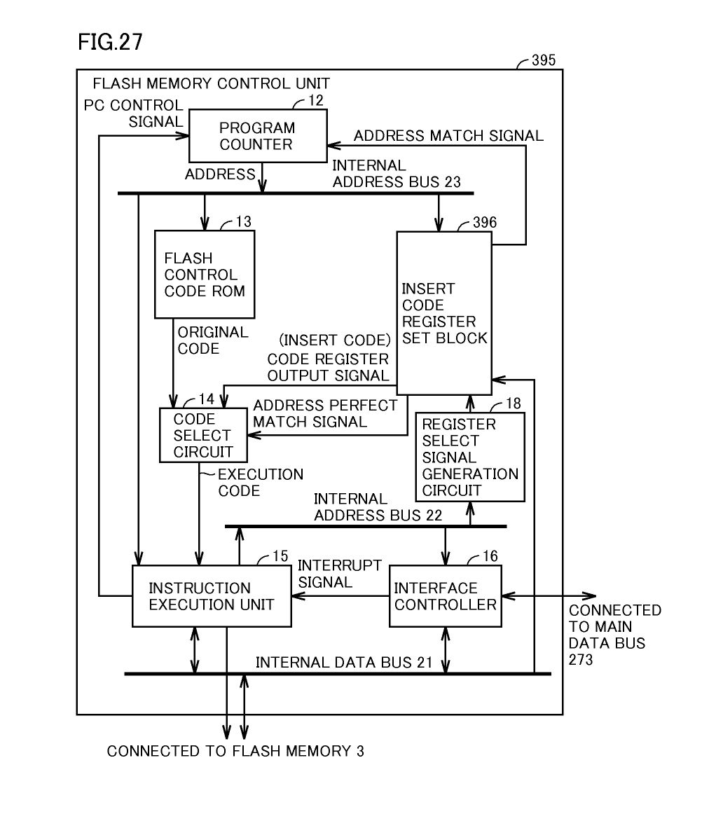

FIG. 27 is a diagram showing a configuration of a flash memory control unit 395 in a fifth embodiment.

Flash memory control unit 395 in FIG. 27 differs from flash memory control unit 2 of the first embodiment in FIG. 7 in terms of an insert code register set block 396.

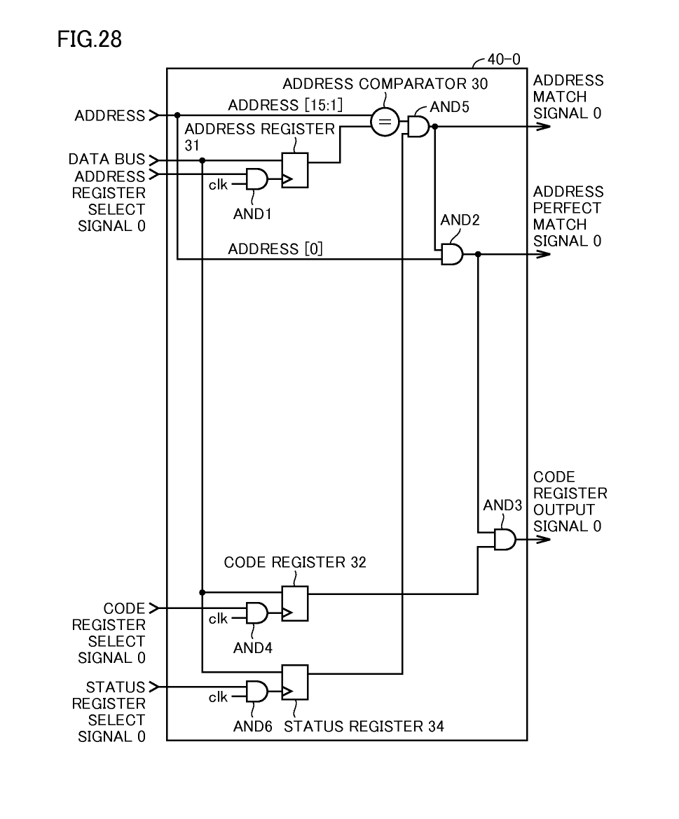

FIG. 28 is a diagram showing a configuration of code insert register set 40-0 included in insert code register set block 396. Code insert register sets 40-1 to 40-n are configured similarly to code insert register set 40-0 in FIG. 28.

Code insert register set 40-0 in FIG. 28 differs from code insert register set 29-0 of the first embodiment in FIG. 11 in terms of a logic circuit AND6, a status register 34, and a logic circuit AND5.

Logic circuit AND6 outputs an “H” level signal to a control terminal of status register 34, when both clock clk and status register select signal 0 are “H” level.

Status register 34 latches and retains a 1-bit status value sent through the data bus, when the input to the control terminal is “H” level.

Logic circuit AND5 outputs, as address match signal 0, the logical product of the output of status register 34 and the output of address comparator 30. Therefore, when the status value is set to “O0”, address match signal 0 and address perfect match signal 0 are always “L” level. Accordingly, when the status value is “0”, code select circuit 12 selects the original code which is output from flash control code ROM 13 regardless of the address of program counter 12. Thus, the capability of inserting a code described in the present embodiment is made invalid.

As seen from the foregoing, the present embodiment enables the code insert capability to be switched between a valid state and an invalid state, in accordance with the status value.

### Sixth Embodiment

Configuration:

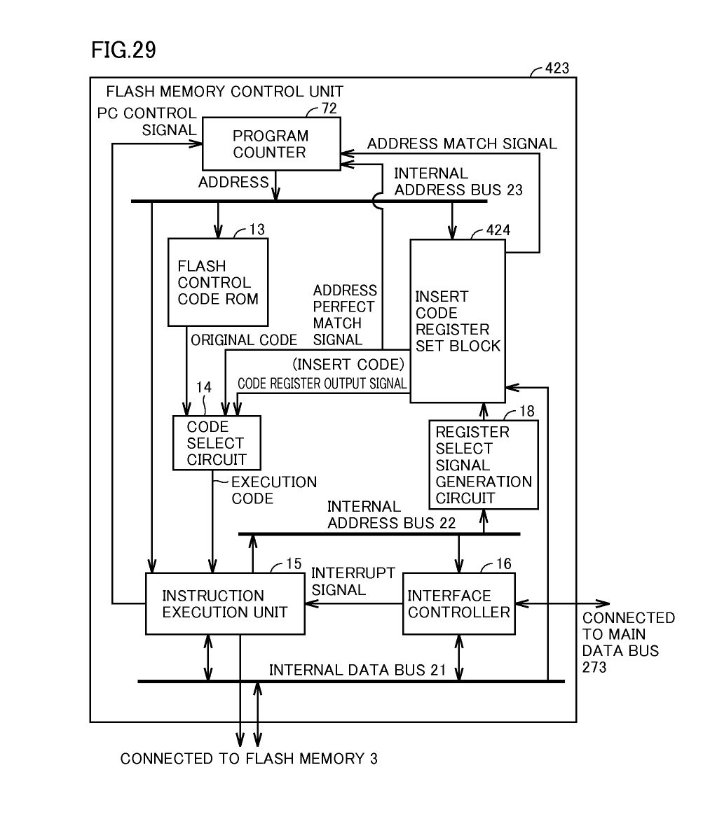

FIG. 29 is a diagram showing a configuration of a flash memory control unit 423 in a sixth embodiment.

Flash memory control unit 423 in FIG. 29 differs from flash memory control unit 102 of the first embodiment in FIG. 7 in terms of an insert code register set block 424 and a program counter 72.

Insert code register set block 424 outputs a first signal (namely sets the address match signal to “H” level), when the bits of the address of its retained insert code except for the most significant bit and the bits of the address given from program counter 72 except for the most significant bit match each other.

When insert code register set block 424 outputs the first signal and the most significant bit of the address given from program counter 72 is “1”, block 424 outputs a second signal (namely sets the address perfect match signal to “H” level) and outputs the retained insert code.

Receiving the first signal, program counter 72 adds “1” to the most significant bit and, failing to receive the first signal, program counter 72 adds “1” to the second least significant bit.

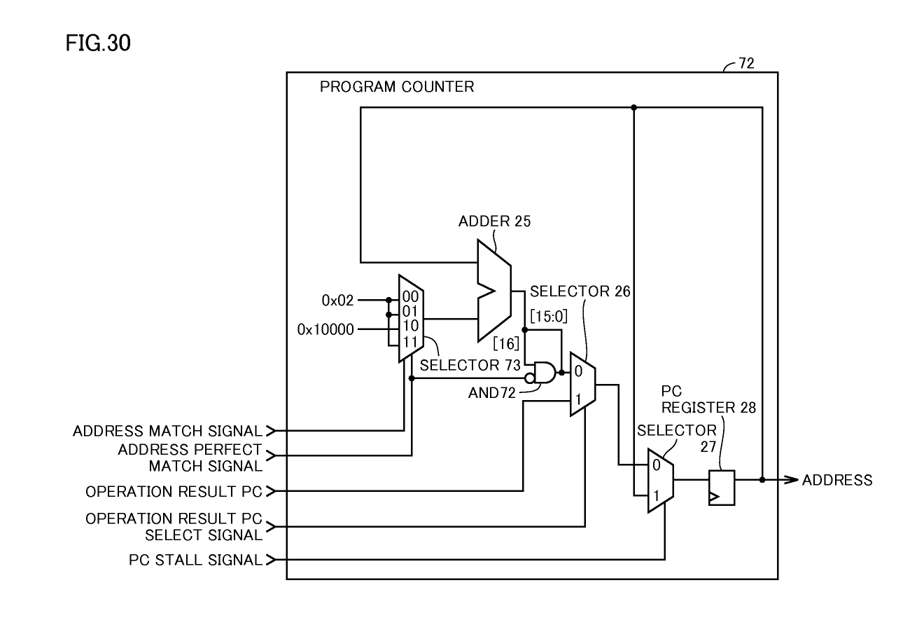

FIG. 30 is a diagram showing a configuration of program counter 72.

As shown in FIG. 30, program counter 72 includes a selector 73, an adder 25, a logic circuit AND72, a selector 26, a selector 27, and a PC register 28.

Selector 73 receives the address match signal and the address perfect match signal from insert code register set block 424. When the address match signal is “H” level and the address perfect match signal is “L” level, selector 73 outputs “0x10000”. Selector 73 outputs “0x02” when the address match signal is “L” level and the address perfect match signal is “H” level, or when the address match signal is “L” level and the address perfect match signal is “L” level, or when the address match signal is “H” level and the address perfect match signal is “H” level.

Adder 25 adds together a 17-bit address [16:0] which is output from PC register 28 and the value which is output from selector 73. In the present embodiment, one instruction code is inserted and therefore it is supposed that the output of program counter 72 is 17 bits.

Logic circuit AND72 outputs the logical product of one most significant bit of the 17 bits which are output from adder 25 and negation of the address perfect match signal Namely, when the address perfect match signal is “L” level, logic circuit AND72 outputs the one most significant bit of the 17 bits which are output from adder 25. When the address perfect match signal is “H” level, logic circuit AND72 outputs 1-bit “0b0”.

Selector 26 receives a signal in which the low-order 16 bits are the low-order 16 bits of the 17 bits which are output from adder 25 and one most significant bit is the 1-bit signal which is output from logic circuit AND72, and also receives the operation result PC which is output from instruction execution unit 15. When the operation result PC select signal which is output from instruction execution unit 15 is “H” level, selector 26 outputs the operation result PC. When the operation result PC select signal is “L” level, selector 26 outputs the signal from adder 25 and logic circuit AND72.

Selector 27 receives the output from selector 26 and an address which is output from PC register 28. When the PC stall signal which is output from instruction execution unit 15 is “H” level, selector 27 outputs the address which is output from PC register 28. When the PC stall signal is “I,” level, selector 27 outputs the signal which is output from selector 26.

PC register 28 latches the output of selector 27 and outputs, to internal address bus 23, the latched output as an address of the flash control code ROM.

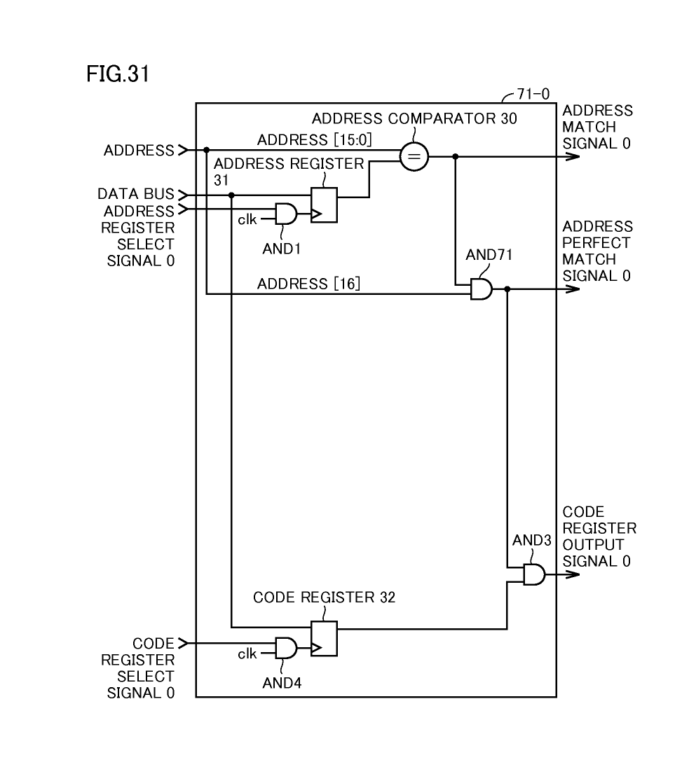

FIG. 31 is a diagram showing a configuration of a code insert register set 71-0 included in insert code register set block 424. Code insert register sets 71-1 to 71-n are configured similarly to code insert register set 71-0 in FIG. 31.

As shown in FIG. 31, code insert register set 71-0 includes a logic circuit AND1, an address register 31, an address comparator 30, a logic circuit AND4, a code register 32, and a logic circuit AND71.

Logic circuit AND1 outputs an “H” level signal to a control terminal of address register 31 when both clock clk and address register select signal 0 are “H” level.

When the input to the control terminal is “H” level, address register 31 latches and retains the 16-bit address which is sent through the data bus.

Address comparator 30 sets address match signal 0 to “H” level when the low-order 16 bits (address [15:0]) of the 17-bit address which is output from program counter 72 and the 16-bit address retained in address register 31 match each other.

Logic circuit AND71 sets address perfect match signal 0 to “H” level, when address match signal 0 is “H” level and one most significant bit (address [16]) of the 17-bit address which is output from program counter 72 is “1”.

Logic circuit AND4 outputs an “H” level signal to a control terminal of code register 32 when both clock clk and code register select signal 0 are “H” level.

Code register 32 latches and retains the 16-bit data (namely the insert code) which is sent through the data bus, when the input to the control terminal is “H” level.

Example Operation of Sixth Embodiment:

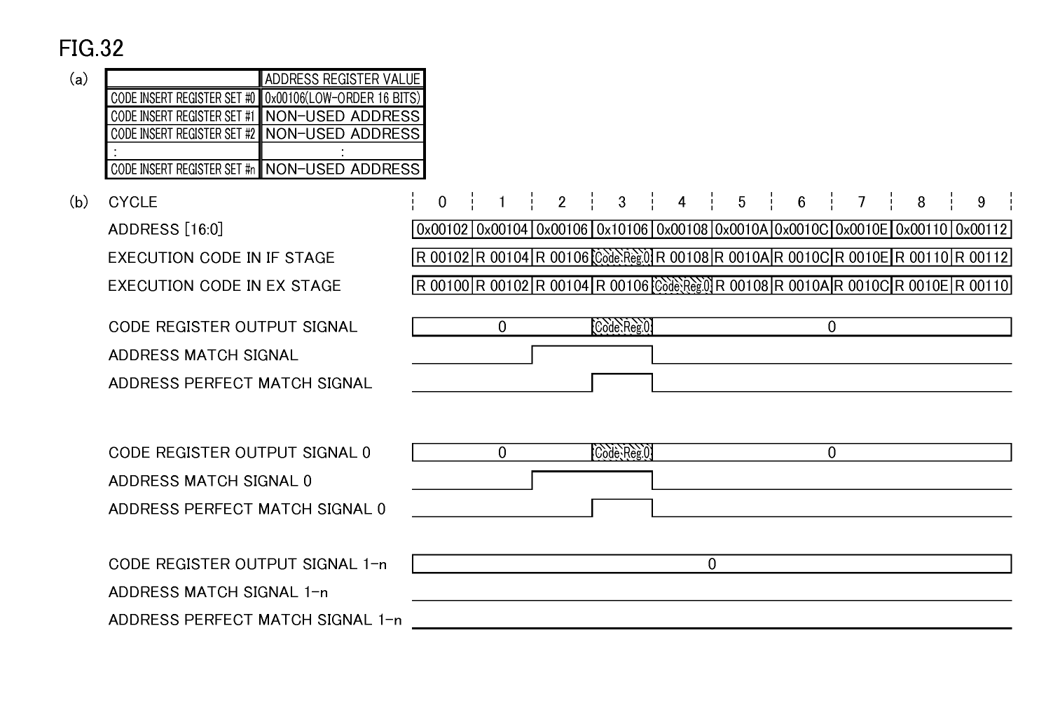

FIG. 32 (a) is a diagram showing an example of values retained in address register 31 of code insert register set 71-i (hereinafter code insert register set #i). In this example, address register 31 of code insert register set #0 retains the low-order 16 bits of “0x00106”. Code register 32 of code insert register set #0 retains insert code “Code Reg.0”. An original code “R . . . ” is retained at an address “0x . . . ” in flash control code ROM 13.

FIG. 32 (b) is a timing diagram under the conditions in FIG. 32 (a).

In the 0-th cycle, the 17-bit address (PC value [116:0]) which is output from program counter 72 is “0x00102”. The low-order 16 bits of address “0x00102” are different from the low-order 16 bits of address “0x00106” retained in address register 31 of code insert register set #0. Accordingly, the address match signal and the address perfect match signal are “L” level and the code register output signal is “0x00000”. From flash control code ROM 13, “R00102” which is an original code at address “0x00102” is output. Since the address perfect match signal is “L” level, code select circuit 14 outputs original code “R00102” to fetch unit 35 of instruction execution unit 15. Execution unit 36 of instruction execution unit IS executes original code “R000100” which is output to fetch unit 35 in the immediately preceding cycle.

In the first cycle, selector 73 of program counter 72 outputs “0x02” since the address match signal in the preceding cycle is “L” level and the address perfect match signal is “L” level. Accordingly, the output address of program counter 72 is “0x00104” determined by adding “0x02”. The low-order 16 bits of address “0x00104” are different from the low-order 16 bits of address “0x00106” retained in address register 31 of code insert register set #0. Accordingly, the address match signal and the address perfect match signal are “L” level and the code register output signal is “0x00000”. From flash control code ROM 13, original code “R00104” at address “0x00104” is output. Since the address perfect match signal is “L” level, code select circuit 14 outputs original code “R00104” to fetch unit 35 of instruction execution unit 15. Execution unit 36 of instruction execution unit 15 executes original code “R00102” which is output to fetch unit 35 in the immediately preceding cycle.

In the second cycle, selector 24 of program counter 72 outputs “0x02” since the address match signal in the preceding cycle is “L” level and the address perfect match signal is “L” level. Accordingly, the output address of program counter 72 is “0x00106” determined by adding “0x02”. The low-order 16 bits of address “0x00106” match the low-order 16 bits of address “0x00106” retained in address register 31 of code insert register set #0. Accordingly, the address match signal is “H” level (since address match signal 0 is “H” level). Meanwhile, the most significant bit of the output address of program counter 72 is “0”, and therefore, the address perfect match signal is still “L” level and the code register output signal is still “0x00000”. From flash control code ROM 13, “R00106” which is an original code at address “0x00106” is output. Since the address perfect match signal is “L” level, code select circuit 14 outputs original code “R00106” to fetch unit 35 of instruction execution unit 15. Execution unit 36 of instruction execution unit 15 executes original code “R00104” which is output to fetch unit 35 in the immediately preceding cycle.

In the third cycle, selector 73 of program counter 72 outputs “0x10000” since the address match signal in the preceding cycle is “H” level and the address perfect match signal is “L” level. Accordingly, the output address of program counter 72 is “0x10106” determined by adding “0x10000”. The low-order 16 bits of address “0x10106” match the low-order 16 bits of address “0x00106” retained in address register 31 of code insert register set #0. Accordingly, the address match signal is “H” level (since address match signal 0 is “H” level). The most significant bit of the output address of program counter 72 is “1” and therefore the address perfect match signal is “H” level (since address match signal 0 is “H” level). The code register output signal is insert code “Code Reg.0” retained in code register 32 (since code register output signal 0 is “Code Reg.0”). Since the address perfect match signal is “H” level, code select circuit 14 outputs insert code “Code Reg.0” to fetch unit 35 of instruction execution unit 15. Execution unit 36 of instruction execution unit 15 executes original code “R00106” which is output to fetch unit 35 in the immediately preceding cycle.

In the fourth cycle, selector 73 of program counter 72 outputs “0x02” since the address match signal in the preceding cycle is “H” level and the address perfect match signal is “H” level. Since the address perfect match signal is “H” level, logic circuit AND72 sets the most significant bit (17th bit) of the output from adder 25 to “O0”. Accordingly, the output address of program counter 72 is “0x00108”. The low-order 16 bits of address “0x00108” are different from the low-order 16 bits of address “0x00106” retained in address register 31. Accordingly, the address match signal and the address perfect match signal are “L” level and the code register output signal is “0x00000”. From flash control code ROM 13, original code “R00108” at address “0x00108” is output. Since the address perfect match signal is “L” level, code select circuit 14 outputs original code “R00108” to fetch unit 35 of instruction execution unit 15. Execution unit 36 of instruction execution unit 15 executes insert code “Code Reg.0” which is output to fetch unit 35 in the immediately preceding cycle.

In the fifth and its subsequent cycles, the operation is performed similarly to that in the fourth cycle.

As seen from the foregoing, the present embodiment uses the bits of the address of the program counter except for the most significant bit to specify the address of an original code, and uses the most significant bit to control insertion of a code. Therefore, one code can be inserted between two original codes and a multicycle instruction can be executed.

In the present embodiment, regarding the addresses of a plurality of original codes, the second least significant bit and more significant bits than the second least significant bit in an address are valid. The present invention, however, is not limited to this. Regarding the addresses of a plurality of original codes, the n-th least significant bit and more significant bits than the n-th least significant bit in an address may be valid, where n is a natural number of I or more. In this case, program counter 72 may add “1” to the n-th least significant bit when it fails to receive the first signal (when the address match signal is “L” level). In the present embodiment and the following embodiments, the least significant bit is not used and thus the address which is input to each program counter and each insert code register set may be [15:1]. In the following, however, this is represented as [15:0].

### Seventh Embodiment

In the present embodiment, regarding the addresses of a plurality of original codes, the m-th least significant bit and more significant bits than the m-th least significant bit in an address are valid.

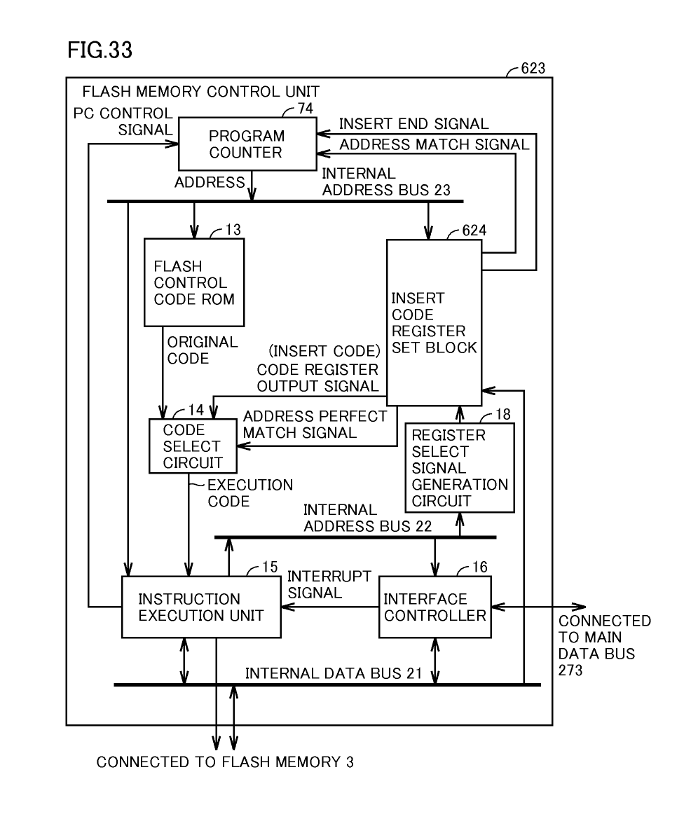

FIG. 33 is a diagram showing a configuration of a flash memory control unit 623 in a seventh embodiment.

Flash memory control unit 623 in FIG. 33 differs from flash memory control unit 102 of the second embodiment in FIG. 16 in terms of an insert code register set block 624 and a program counter 74.

Insert code register set block 624 retains up to a maximum of 2k−1 insert codes and the addresses of the insert codes. When the bits of the address of its retained insert code except for k bits from the most significant bit match the bits of an address given from program counter 74 except for k bits from the most significant bit, insert code register set block 624 outputs a first signal (namely sets the address match signal to “H” level).

When insert code register set block 624 outputs the first signal and the k bits from the most significant bit of the address of the retained insert code match the k bits from the most significant bit of the address given from program counter 74, insert code register set block 624 outputs a second signal (sets the address perfect match signal to “H” level) and outputs the retained insert code corresponding to the address given from program counter 74.

When a plurality of insert codes are to be successively inserted, insert code register set block 624 outputs the second signal at the time it outputs the last insert code, and simultaneously outputs an insert end signal indicating an end of insert.

Receiving the first signal, program counter 74 adds “1” to the k-th most significant bit and, failing to receive the first signal, program counter 74 adds “1” to the m-th least significant bit.

Receiving the insert end signal, program counter 74 adds “1” to the m-th least significant bit and sets the k bits from the most significant bit to “0” even when the program counter receives the first signal.

The following description will be made with m=2 and k=4.

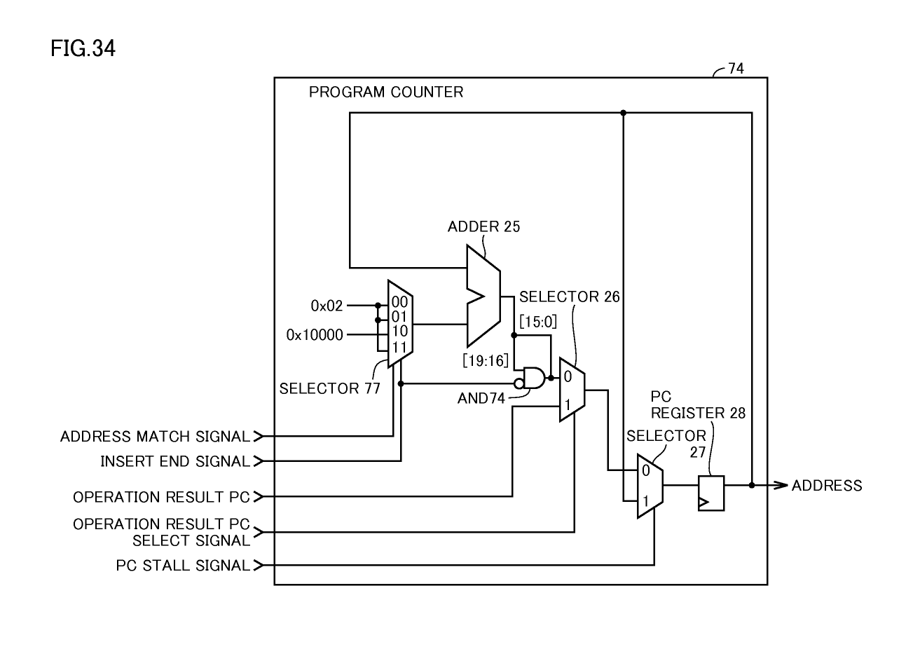

FIG. 34 is a diagram showing a configuration of program counter 74.

As shown in FIG. 34, program counter 74 includes a selector 77, an adder 25, a logic circuit AND74, a selector 26, a selector 27, and a PC register 28.

Selector 77 receives from insert code register set block 624 the address match signal and the insert end signal. Selector 77 outputs “0x10000” when the address match signal is “H” level and the insert end signal is “L” level. Selector 73 outputs “0x02” when the address match signal is “L” level and the insert end signal is “H” level, or when the address match signal is “L” level and the insert end signal is “L” level, or when the address match signal is “H” level and the insert end signal is “H” level.

Adder 25 adds together a 20-bit address which is output from PC register 28 and the value which is output from selector 73.

Logic circuit AND74 outputs the logical product of the high-order 4 bits of the 20 bits which are output from adder 25 and negation of the insert end signal Namely, when the insert end signal is “L” level, logic circuit AND74 outputs the high-order 4 bits of the 20 bits which are output from adder 25. When the insert end signal is “H” level, logic circuit AND74 outputs 4-bit “0b0000”.

Selector 26 receives a signal in which the low-order 16 bits are the low-order 16 bits of the 20 bits which are output from adder 25 and the high-order 4 bits are the 4-bit signal which is output from logic circuit AND74, and also receives the operation result PC which is output from instruction execution unit 15. When the operation result PC select signal which is output from instruction execution unit 15 is “H” level, selector 26 outputs the operation result PC. When the operation result PC select signal is “L” level, selector 26 outputs the signal from adder 25 and logic circuit AND74.

Selector 27 receives the output from selector 26 and an address which is output from PC register 28. When the PC stall signal which is output from instruction execution unit 15 is “H” level, selector 27 outputs the address which is output from PC register 28. When the PC stall signal is “L” level, selector 27 outputs the output which is given from selector 26.

PC register 28 latches the output of selector 27 and outputs, to internal address bus 23, the latched output as an address of the flash control code ROM.

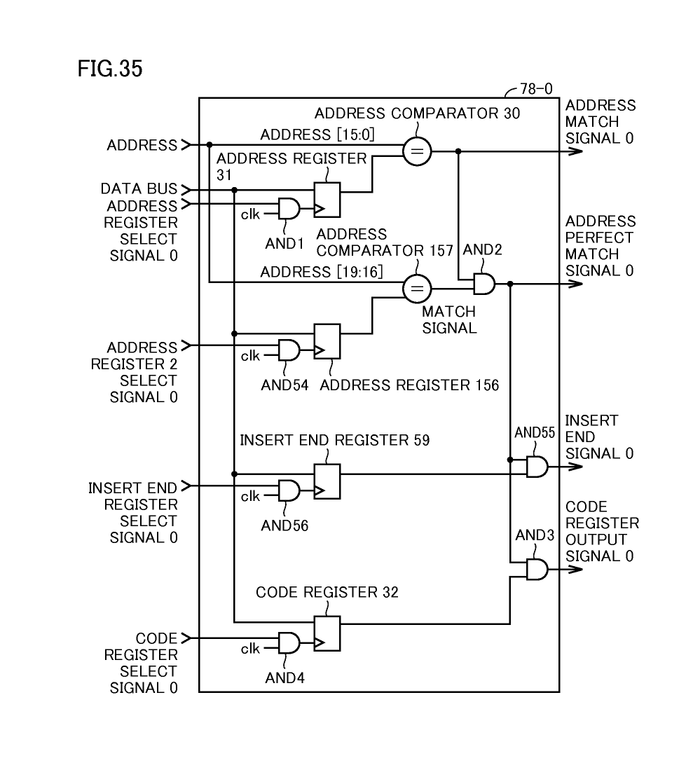

FIG. 35 is a diagram showing a configuration of code insert register set 78-0 included in insert code register set block 624. Code insert register sets 78-1 to 78-n are configured similarly to code insert register set 78-0 in FIG. 35.

As shown in FIG. 35, code insert register set 78-0 includes a logic circuit AND1, an address register 31, an address comparator 30, a logic circuit AND4, a code register 32, a logic circuit 54, an address register 156, an address comparator 157, a logic circuit 56, an insert end register 59, a logic circuit AND2, a logic circuit 55, and a logic circuit AND3.

Logic circuit AND1 outputs to a control terminal of address register 31 an “H” level signal when both clock clk and address register select signal 0 are “H” level.

When the input to the control terminal is “H” level, address register 31 latches and retains the 16-bit address which is sent through the data bus.

Address comparator 30 sets address match signal 0 to “H” level when the low-order 16 bits (address [15:0]) of the 20-bit address which is output from program counter 74 and the 16-bit address which is retained in address register 31 match each other.

Logic circuit AND54 outputs to a control terminal of code register 32 an “H” level signal when both clock clk and address register 2 select signal 0 are “H” level.

When the input to the control terminal is “H” level, address register 156 latches and retains the 4-bit address which is sent through the data bus.

Address comparator 57 outputs a match signal of “H” level when the high-order 4 bits (address [19:16]) of the 20-bit address which is output from program counter 74 match a 4-bit address retained in address register 156.

Logic circuit AND2 sets address perfect match signal 0 to “H” level when address match signal 0 is “H” level and the match signal which is output from address comparator 157 is “H” level.

Logic circuit AND56 outputs an “H” level signal to a control terminal of insert end register 59 when both clock clk and insert end register select signal 0 are “H” level.

Insert end register 59 latches and retains 1-bit data (insert end) which is sent through the data bus, when the input to the control terminal is “H” level.

Logic circuit AND55 receives address perfect match signal 0 and the output of insert end register 59. When address perfect match signal 0 is “H” level, logic circuit AND55 outputs, as insert end signal 0, the 1-bit data (insert end) retained in insert end register 59.

Logic circuit AND4 outputs an “H” level signal to a control terminal of code register 32 when both clock clk and code register select signal 0 are “H” level.

Code register 32 latches and retains, when the input to the control terminal is “H” level, the 16-bit data (namely the insert code) which is sent through the data bus.

Logic circuit AND3 receives address perfect match signal 0 and the output of code register 32. When address perfect match signal 0 is “H” level, logic circuit AND3 outputs, as code register output signal 0, the 16-bit data (namely the insert code) retained in code register 32. When address perfect match signal 0 is “L” level, logic circuit AND3 outputs, as code register output signal 0, 16-bit “0x0000”.

Example Operation of Seventh Embodiment:

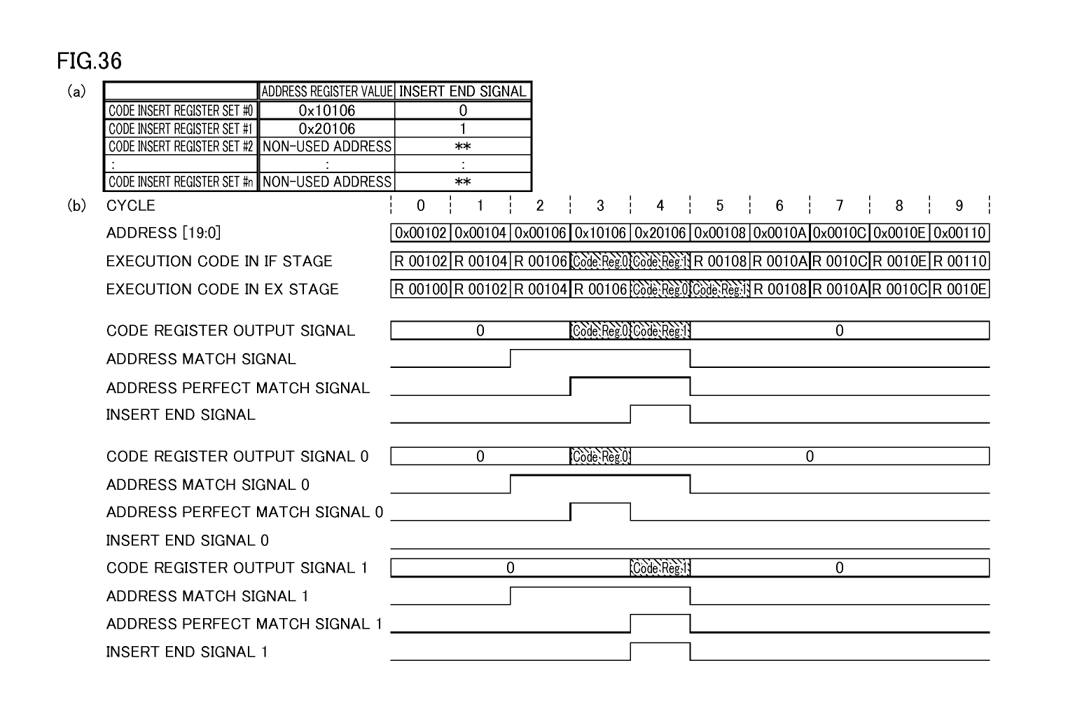

FIG. 36 (a) is a diagram showing an example of values retained in address register 31 of code insert register set 78-i (hereinafter code insert register set #i). In this example, address register 31 of code insert register set #0 retains the low-order 16 bits of “0x10106”, and address register 156 retains the high-order 4 bits of “0x10106”. Code register 32 of code insert register set #0 retains insert code “Code Reg.0”. Insert end register 59 of code insert register set #0 retains insert end “0b0”. Address register 31 of code insert register set #1 retains the low-order 16 bits of “0x20106”, and address register 156 retains the high-order 4 bits of “0x20106”. Code register 32 of code insert register set #01 retains insert code “Code Reg.1”. Insert end register 59 of code insert register set #1 retains insert end “0b1”. An original code “R . . . ” is retained at an address “0x . . . . ” in flash control code ROM 13.

FIG. 36 (b) is a timing diagram under the conditions in FIG. 36 (a).

In the 0th cycle, the 20-bit address (PC value [19:0]) which is output from program counter 74 is “0x00102”. The high-order 15 bits of address “0x00102” are different from the low-order 16 bits of address “0x10106” retained in address register 31 of code insert register set #0, and also different from the low-order 16 bits of address “0x20106” retained in address register 31 of code insert register set #1. Accordingly, the address match signal and the address perfect match signal are “L” level, the code register output signal is “0x0000”, and the insert end signal is “0b0”. From flash control code ROM 13, “R00102” which is an original code at address “0x00102” is output. Since the address perfect match signal is “L” level, code select circuit 14 outputs original code “R00102” to fetch unit 35 of instruction execution unit 15. Execution unit 36 of instruction execution unit 15 executes original code “R00100” which is output to fetch unit 35 in the immediately preceding cycle.

In the first cycle, selector 77 of program counter 74 outputs “0x02” since the address match signal in the preceding cycle is “L” level and the insert end signal is “0b0”. The output address of program counter 74 is “0x00104” determined by adding “0x02”. The low-order 16 bits of address “0x00104” are different from the low-order 16 bits of address “0x10106” retained in address register 31 of code insert register set #0, and different from the low-order 16 bits of address “0x20106” retained in address register 31 of code insert register set #1. Accordingly, the address match signal and the address perfect match signal are “L” level, the code register output signal is “0x0000”, and the insert end signal is “0b0”. From flash control code ROM 13, original code “R00104” at address “0x00104” is output. Since the address perfect match signal is “L” level, code select circuit 14 outputs original code “R00104” to fetch unit 35 of instruction execution unit 15. Execution unit 36 of instruction execution unit 15 executes original code “R00102” which is output to fetch unit 35 in the immediately preceding cycle.

In the second cycle, selector 77 of program counter 74 outputs “0x02” since the address match signal in the preceding cycle is “L” level and the insert end signal is “0b0”. Accordingly, the output address of program counter 74 is “0x00106” determined by adding “0x02”. The low-order 16 bits of address “0x00106” match the low-order 16 bits of address “0x10106” retained in address register 31 of code insert register set #0, and match the low-order 16 bits of address “0x20106” retained in address register 31 of code insert register set #1. Accordingly, the address match signal is “H” level (since address match signal 0 and address match signal 1 are “H” level). In addition, the high-order 4 bits of address “0x00106” are different from the high-order 4 bits of address “0x10106” retained in address register 156 of code insert register set #0, and different from the high-order 4 bits of address “0x20106” retained in address register 156 of code insert register set #1. Accordingly, the address perfect match signal is still “L” level (since address perfect match signal 0 and address perfect match signal 1 are still “L” level). Since the address perfect match signal is “L” level, the code register output signal is “0x0000” and the insert end signal is “0b0”. From flash control code ROM 13, original code “R00106” at address “0x00106” is output. Since the address perfect match signal is “L” level, code select circuit 14 outputs original code “R00106” to fetch unit 35 of instruction execution unit 15. Execution unit 36 of instruction execution unit 15 executes original code “R00104” which is output to fetch unit 35 in the immediately preceding cycle.

In the third cycle, selector 24 of program counter 74 outputs “0x10000” since the address match signal in the preceding cycle is “H” level and the insert end signal is “0b0”. Accordingly, the output address of program counter 74 is “0x10106” determined by adding “0x10000”. The low-order 16 bits of address “0x10106” match the low-order 16 bits of address “0x10106” retained in address register 31 of code insert register set #0, and match the low-order 16 bits of address “0x20106” retained in address register 31 of code insert register set #1. Accordingly, the address match signal is “H” level (since address match signal 0 and address match signal 1 are “H” level). In addition, the high-order 4 bits of address “0x10106” match the high-order 4 bits of address “0x10106” retained in address register 156 of code insert register set #0, and therefore the address perfect match signal is “H” level (since address perfect match signal 0 is “H” level). Since address perfect match signal 0 is “H” level, code register output signal 0 is insert code “Code Reg.0” retained in code register 32 of code insert register set #0. Thus, the code register output signal is insert code “Code Reg.0”. Since address perfect match signal 0 is “H” level, insert end signal 0 is insert end “0b0” retained in insert end register 59 of code insert register set #0. Accordingly, the insert end signal is “0b0”. Since the address perfect match signal is “H” level, code select circuit 14 outputs insert code “Code Reg.0” to fetch unit 35 of instruction execution unit 15. Execution unit 36 of instruction execution unit 15 executes original code “R00106” which is output to fetch unit 35 in the immediately preceding cycle.

In the fourth cycle, selector 77 of program counter 74 outputs “0x10000” since the address match signal in the preceding cycle is “H” level and the insert end signal is “0b0”. Accordingly, the output address of program counter 74 is “0x20106” determined by adding “0x10000”. The low-order 16 bits of address “0x20106” match the low-order 16 bits of address “0x10106” retained in address register 31 of code insert register set #0, and match the low-order 16 bits of address “0x20106” retained in address register 31 of code insert register set #1. Accordingly, the address match signal is “H” level (since address match signal 0 and address match signal 1 are “H” level). In addition, the high-order 4 bits of address “0x20106” match the high-order 4 bits of address “0x20106” retained in address register 156 of code insert register set #1, and therefore the address perfect match signal is “H” level (since address perfect match signal 1 is “H” level). Since address perfect match signal 1 is “H” level, code register output signal 1 is insert code “Code Reg.1” retained in code register 32 of code insert register set #1. Thus, the code register output signal is insert code “Code Reg.1” Since address perfect match signal 1 is “H” level, insert end signal 1 is insert end “0b1” retained in insert end register 59 of code insert register set #1. Accordingly, the insert end signal is “0b1”. Since the address perfect match signal is “H” level, code select circuit 14 outputs insert code “Code Reg.1” to fetch unit 35 of instruction execution unit 15. Execution unit 36 of instruction execution unit 15 executes insert code “Code Reg.0” which is output to fetch unit 35 in the immediately preceding cycle.

In the fifth cycle, selector 24 of program counter 74 outputs “0x02” since the address match signal in the preceding cycle is “H” level and the insert end signal is “0b1”. Since insert end signal is “0b1”, logic circuit AND74 sets the high-order 4 bits (17th bit to 20th bit) of the output of adder 25 to “0”. Accordingly, the output address of program counter 74 is “0x00108”. The low-order 16 bits of address “0x00108” are different from the low-order 16 bits of address “0x10106” retained in address register 31 of code insert register set #0, and different from the low-order 16 bits of address “0x20106” retained in address register 31 of code insert register set #1. Accordingly, the address match signal is “L” level (since address match signal 0 and address match signal 1 are “L” level). In addition, the high-order 4 bits of address “0x00108” are different from the high-order 4 bits of address “0x10106” retained in address register 156 of code insert register set #0, and different from the high-order 4 bits of address “0x20106” retained in address register 156 of code insert register set #1. Accordingly, the address perfect match signal is “L” level (since address perfect match signal 0 and address perfect match signal 1 are “L” level). Since the address perfect match signal is “L” level, the code register output signal is “0x0000” and the insert end signal is “0b”. From flash control code ROM 13, original code “R00108” at address “0x00108” is output. Since the address perfect match signal is “L” level, code select circuit 14 outputs original code “R00108” to fetch unit 35 of instruction execution unit 15. Execution unit 36 of instruction execution unit 15 executes insert code “Code Reg.1” which is output to fetch unit 35 in the immediately preceding cycle. In the sixth cycle, selector 77 of program counter 74 outputs “0x02” since the address match signal in the preceding cycle is “L” level and the insert end signal is “0b0”. Accordingly, the output address of program counter 74 is “0x0010A” determined by adding “0x02”. The low-order 16 bits of address “0x0010A” are different from the low-order 16 bits of address “0x10106” retained in address register 31 of code insert register set #0, and different from the low-order 16 bits of address “0x20106” retained in address register 31 of code insert register set #1. Accordingly, the m address match signal and the address perfect match signal are “L” level, the code register output signal is “0x0000”, and the insert end signal is “0b0”. From flash control code ROM 13, original code “R0010A” at address “0x0010A” is output. Since the address perfect match signal is “L” level, code select circuit 14 outputs original code “R0010A” to fetch unit 35 of instruction execution unit 15. Execution unit 36 of instruction execution unit 15 executes original code “R00108” which is output to fetch unit 35 in the immediately preceding cycle.

In the seventh and its subsequent cycles, the operation is performed similarly to that in the sixth cycle.

As seen from the foregoing, the present embodiment uses the bits of the address of the program counter except for a predetermined number of bits from the most significant bit to specify the address of an original code, and uses the predetermined number of bits from the most significant bit to control insertion of a code. Therefore, one or more codes can be inserted between two original codes and a multicycle instruction can be executed.

### Eighth Embodiment

In the present embodiment, regarding the addresses of a plurality of original codes, the second least significant bit and more significant bits than the second least significant bit except for the most significant bit in an address are valid.

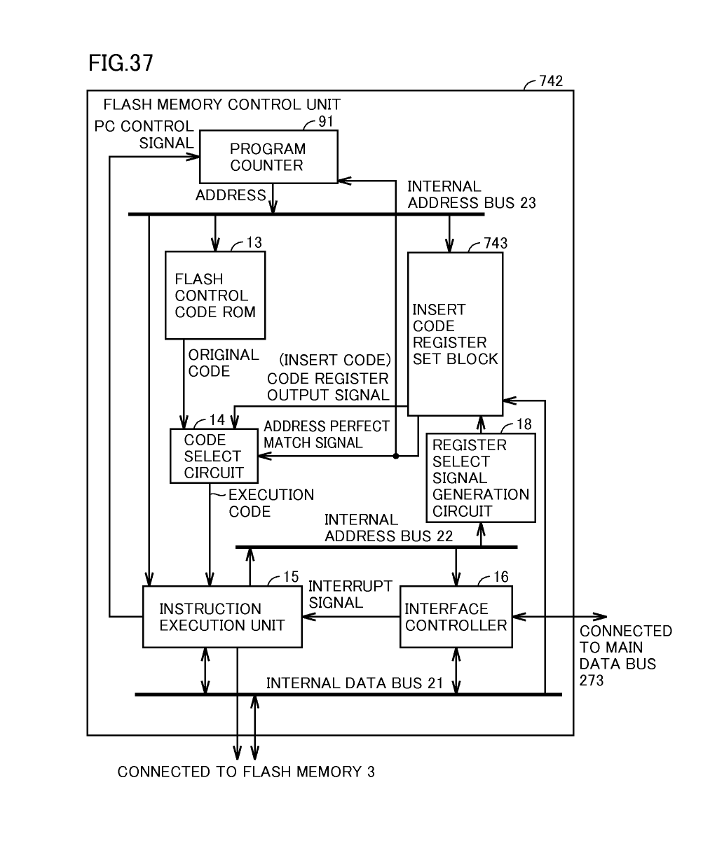

FIG. 37 is a diagram showing a configuration of a flash memory control unit 742 in an eighth embodiment.

Flash memory control unit 742 in FIG. 37 differs from flash memory control unit 2 of the first embodiment in FIG. 7 in terms of an insert code register set block 743 and a program counter 91.

When the bits of the address of an insert code retained in insert code register set block 743 except for the most significant bit and the bits of an address given from program counter 91 except for the most significant bit match each other and the most significant bit of the address given from program counter 91 is “1”, insert code register set block 743 outputs a first signal (sets the address perfect match signal to “H” level) and outputs the retained insert code.

Receiving the first signal, program counter 91 adds “1” to the most significant bit and, failing to receive the first signal, program counter 91 adds “1” to the second least significant bit and sets the most significant bit to “0”.

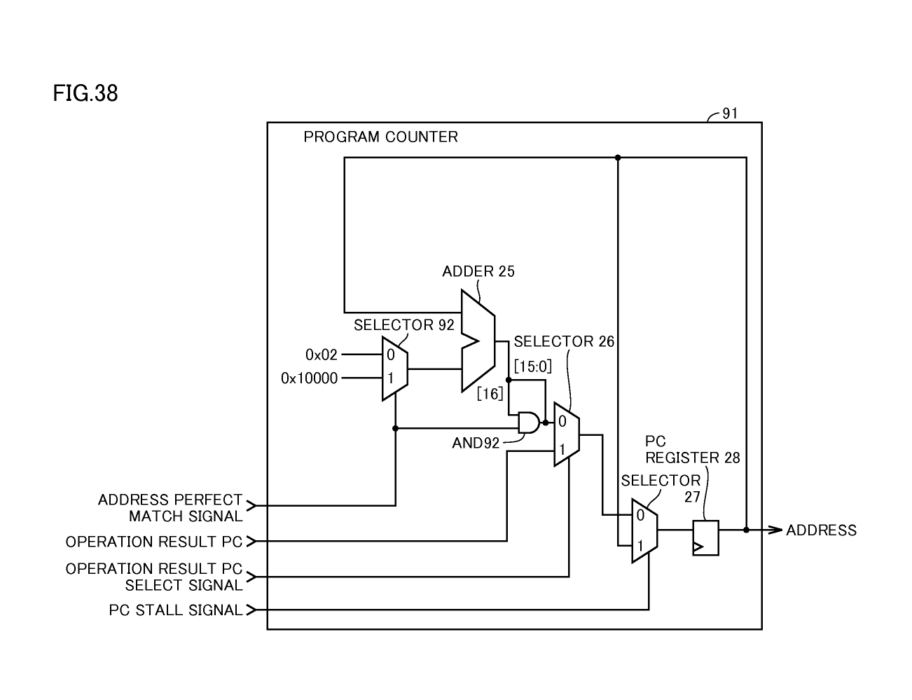

FIG. 38 is a diagram showing a configuration of program counter 91.

Program counter 91 in FIG. 38 differs from program counter 72 of the sixth embodiment in FIG. 30 in terms of a selector 92 and a logic circuit AND92.

Selector 92 receives the address perfect match signal from insert code register set block 743. Selector 92 outputs “0x10000” when the address perfect match signal is “H” level. Selector 92 outputs “0x02” when the address perfect match signal is “L” level.

Logic circuit AND92 outputs the logical product of the most significant bit of the 17 bits which are output from adder 25 and the address perfect match signal. Namely, when the address perfect match signal is “H” level, logic circuit AND92 outputs the most significant bit of the 17 bits which are output from adder 25. When the address perfect match signal is “L” level, logic circuit AND92 outputs 1-bit “0b0”.

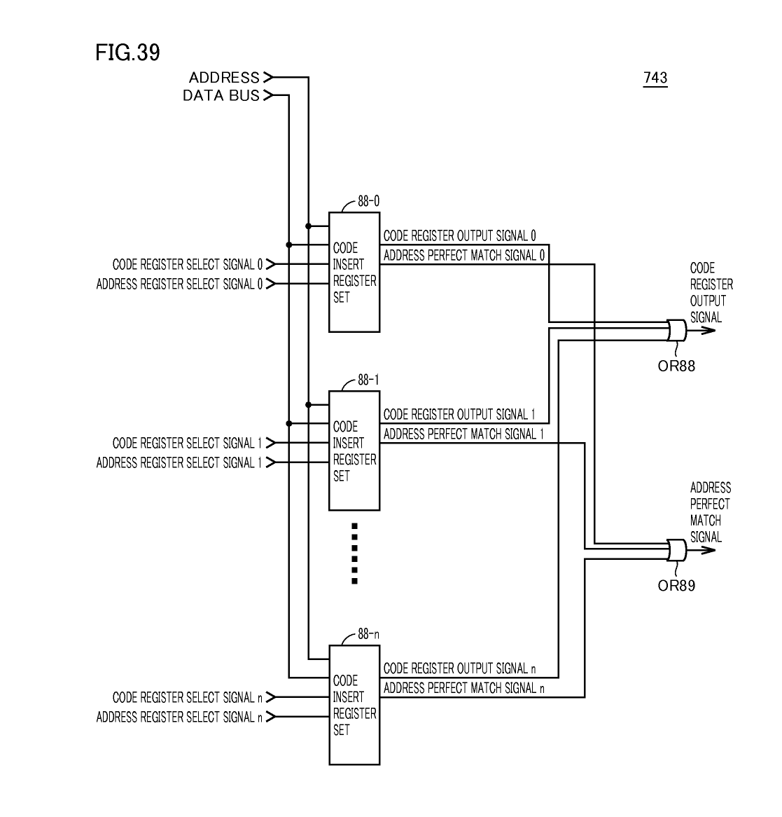

FIG. 39 is a diagram showing a configuration of insert code register set block 743.

As shown in FIG. 39, insert code register set block 743 includes a code insert register set 88-i (i=0 to n) retaining a code to be inserted and the address where the code is to be inserted, as well as logic circuits OR88, OR89.

Code insert register set 88-i receives an address which is output from program counter 91 and data which is transmitted through the data bus, further receives from code select circuit 14 code register select signal i and address register select signal i, and outputs address perfect match signal i and code register output signal i.

Logic circuit OR88 outputs a code register output signal, namely the logical sum of (n+1) code register output signals 0 to n. Namely, when at least one of (n+1) code register output signals 0 to n has an “H” level bit (namely when the insert code is output), the code register output signal is the insert code. Namely, when all bits of (n+1) code register output signals 0 to n are “L” level (namely when the insert code is not output), all bits of the code register output signal are “L”.

Logic circuit OR89 outputs an address perfect match signal, namely the logical sum of (n+1) address perfect match signals 0 to n. Namely, when at least one of (n+1) address perfect match signals 0 to n is “H” level, the address perfect match signal is “H” level.

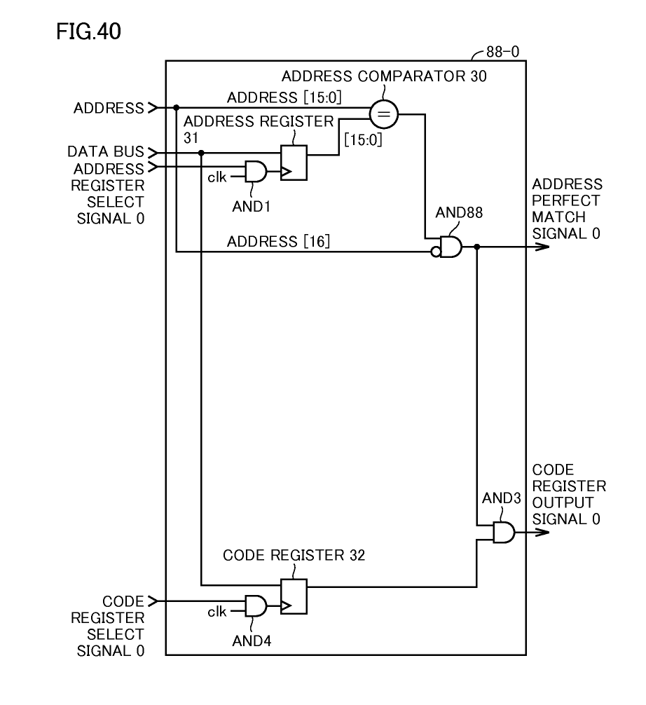

FIG. 40 is a diagram showing a configuration of code insert register set 88-0 included in insert code register set block 743. Code insert register sets 88-1 to 88-n are configured similarly to code insert register set 88-0 in FIG. 35.

Code insert register set 88-0 in FIG. 40 differs from code insert register set 71-0 of the sixth embodiment in FIG. 31 in that the address match signal is not output from address comparator 30 to the external circuitry and in terms of a logic circuit AND88.

Logic circuit AND88 sets address perfect match signal 0 to “H” level when the signal which is output from address comparator 30 is “H” level and the most significant bit (address [16]) of the 17-bit address which is output from program counter 91 is “O”.

Example Operation of Eighth Embodiment:

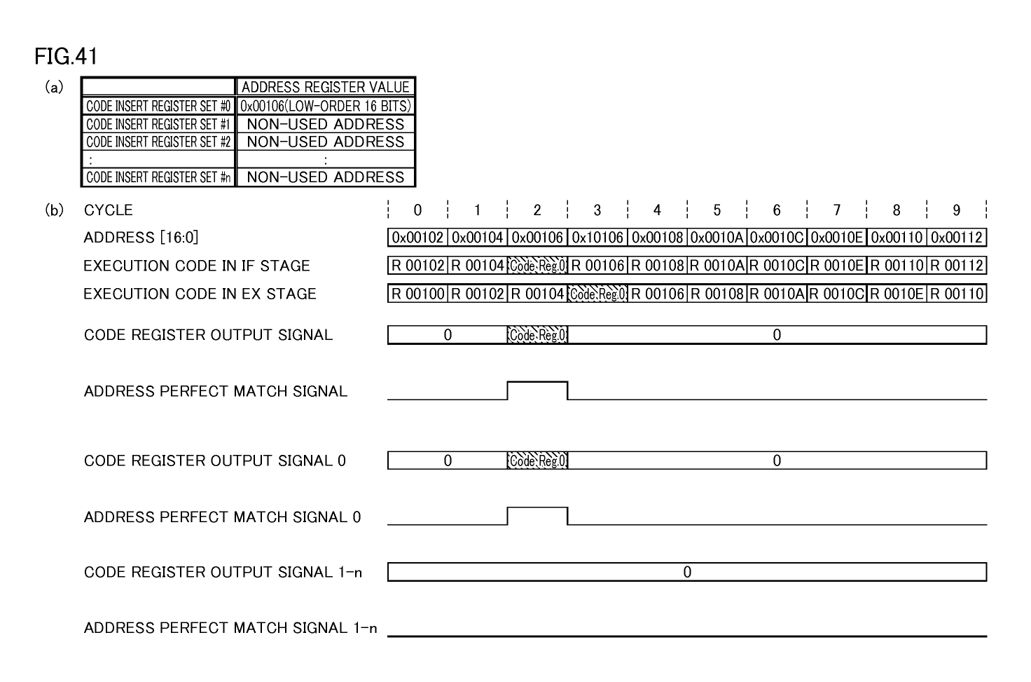

FIG. 41 (a) is a diagram showing an example of values retained in address register 31 of code insert register set 88-i (hereinafter code insert register set #i). In this example, address register 31 of code insert register set #0 retains the low-order 16 bits of “0x00106”. Code register 32 of code insert register set #0 retains insert code “Code Reg.0”. An original code “R . . . ” is retained at an address “0x . . . ” in flash control code ROM 13.

FIG. 41 (b) is a timing diagram under the conditions in FIG. 41 (a).

In the 0th cycle, the 17-bit address (PC value [16:0]) which is output from program counter 91 is “0x00102”. The low-order 16 bits of address “0x00102” are different from the low-order 16 bits of address “0x00106” retained in address register 31 of code insert register set #0. Accordingly, the address perfect match signal is “L” level and the code register output signal is “0x00000”. From flash control code ROM 13. “R00102” which is an original code at address “0x00102” is output. Since the address perfect match signal is “L” level, code select circuit 14 outputs original code “R00102” to fetch unit 35 of instruction execution unit 15. Execution unit 36 of instruction execution unit 15 executes original code “R00100” which is output to fetch unit 35 in the immediately preceding cycle.

In the first cycle, selector 92 of program counter 91 outputs “0x02” since the address perfect match signal in the preceding cycle is “L” level. Accordingly, the output address of program counter 91 is “0x00104” determined by adding “0x02”. The low-order 16 bits of address “0x00104” are different from the low-order 16 bits of address “0x00106” retained in address register 31 of code insert register set #0. Accordingly, the address perfect match signal is “L” level, and the code register output signal is “0x00000”. From flash control code ROM 13, original code “R00104” at address “0x00104” is output. Since the address perfect match signal is “L” level, code select circuit 14 outputs original code “R00104” to fetch unit 35 of instruction execution unit 15. Execution unit 36 of instruction execution unit 15 executes original code “R00102” which is output to fetch unit 35 in the immediately preceding cycle.

In the second cycle, selector 92 of program counter 91 outputs “0x02” since the address perfect match signal in the preceding cycle is “L” level. Thus, the output address of program counter 91 is “0x00106” determined by adding “0x02”. The low-order 16 bits of address “0x00106” match the low-order 16 bits of address “0x0106” retained in address register 31 of code insert register set #0. The most significant bit (17th bit: address [16]) of address “0x00106” is “0”. Accordingly, the address perfect match signal is “H” level (since address perfect match signal 0 is “H” level). Further, the code register output signal is insert code “Code Reg.0” retained in code register 32 (since code register output signal 0 is “Code Reg.0”. Code select circuit 14 outputs insert code “Code Reg.0” to fetch unit 35 of instruction execution unit 15, since the address perfect match signal is “H” level. Execution unit 36 of instruction execution unit 15 executes original code “R00106” which is output to fetch unit 35 in the immediately preceding cycle.

In the third cycle, since the address perfect match signal in the preceding cycle is “H” level, selector 92 of program counter 91 outputs “0x10000”. Thus, the output address of program counter 91 is “0x10106” determined by adding “0x10000”. While the low-order 16 bits of address “0x10106” match the low-order 16 bits of address “0x00106” retained in address register 31 of code insert register set #0, the most significant bit (17-th bit: address [16]) of address “0x10106” is “1”. Accordingly, the address perfect match signal is “L” level (since address perfect match signal 0 is “L” level). Further, the code register output signal is “0x00000”. Flash control code ROM 13 outputs original code “R00106” at address “0x00106” corresponding output address “0x10106” of program counter 91 in which the most significant bit (17th bit) is set to “0”. Code select circuit 14 outputs original code “R00106” to fetch unit 35 of instruction execution unit 15, since the address perfect match signal is “L” level Execution unit 36 of instruction execution unit 15 executes insert code “Code Reg.0” which is output to fetch unit 35 in the immediately preceding cycle.

In the fourth cycle, selector 92 of program counter 91 outputs “0x00002” since the address perfect match signal in the preceding cycle is “L” level. Further, since the address perfect match signal is “L” level, the most significant bit (17th bit) of the output address of adder 25 is “0”. Accordingly, the output address of program counter 91 is “0x00108”. The low-order 16 bits of address “0x00108” are different from the low-order 16 bits of address “0x00106” retained in address register 31 of code insert register set #0. Accordingly, the address perfect match signal is “L” level and the code register output signal is “0x00000”. Flash control code ROM 13 outputs original code “R00108” at address “0x00108”. Code select circuit 14 outputs original code “R00108” to fetch unit 35 of instruction execution unit 15, since the address perfect match signal is “L” level. Execution unit 36 of instruction execution unit 15 executes original code “R00106” which is output to fetch unit 35 in the immediately preceding cycle.

In the fifth and its subsequent cycles, the operation is performed similarly to that in the fourth cycle.

As seen from the foregoing, the present embodiment, like the sixth embodiment, uses the bits of the address of the program counter except for the most significant bit to specify the address of an original code, and uses the most significant bit to control insertion of a code. Therefore, one or more codes can be inserted between two original codes and a multicycle instruction can be executed. Further, in the present embodiment, when the address from the program counter matches the value of the address register, execution of the insert code is done before the original code, in contrast to the sixth embodiment in which execution of the insert code is done after the original code.

In the present embodiment, regarding the addresses of a plurality of original codes, the second least significant bit and more significant bits than the second least significant bit except for the most significant bit in an address are valid. The present invention, however, is not limited to this. Regarding the addresses of a plurality of original codes, the n-th least significant bit and more significant bits than the n-th least significant bit except for the most significant bit in an address may be valid, where n is a natural number of 1 or more. In this case, program counter 91 may add “1” to the n-th least significant bit and set the most significant bit to “0” when it fails to receive the first signal (when the address perfect match signal is “L” level).

### Ninth Embodiment

In the present embodiment, regarding the addresses of a plurality of original codes, the m-th least significant bit and more significant bits than the m-th least significant bit in an address are valid.

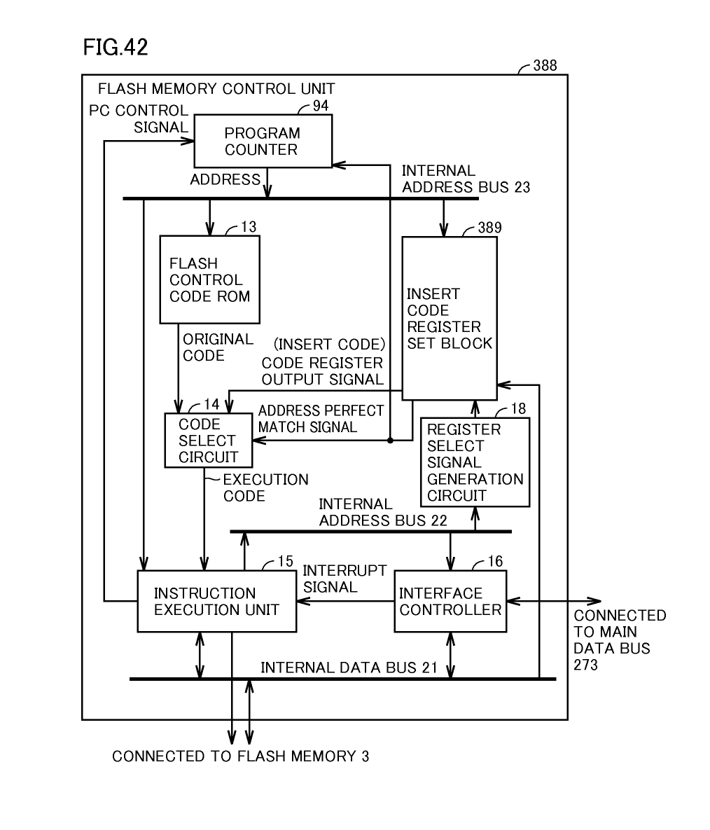

FIG. 42 is a diagram showing a configuration of a flash memory control unit 388 in a ninth embodiment.

Flash memory control unit 388 in FIG. 42 differs from flash memory control unit 102 of the second embodiment in FIG. 16 in terms of an insert code register set block 389 and a program counter 94.

Insert code register set block 389 retains up to a maximum of 2k−1 insert codes and the addresses of the insert codes. When the bits of the address of a retained insert code except for k bits from the most significant bit match the bits of an address given from program counter 94 except for k bits from the most significant bit and the k bits from the most significant bit of the address of the retained insert code match the k bits from the most significant bit of the address given from program counter 94, insert code register set block 389 outputs a first signal (sets the address perfect match signal to “H” level) and outputs its retained insert code corresponding to the address given from program counter 94.

Receiving the first signal, program counter 94 adds “1” to the k-th most significant bit. Failing to receive the first signal, program counter 94 adds “1” to the m-th least significant bit and sets the k bits from the most significant bit to “0”.

The following description will be made with m=2 and k=4.

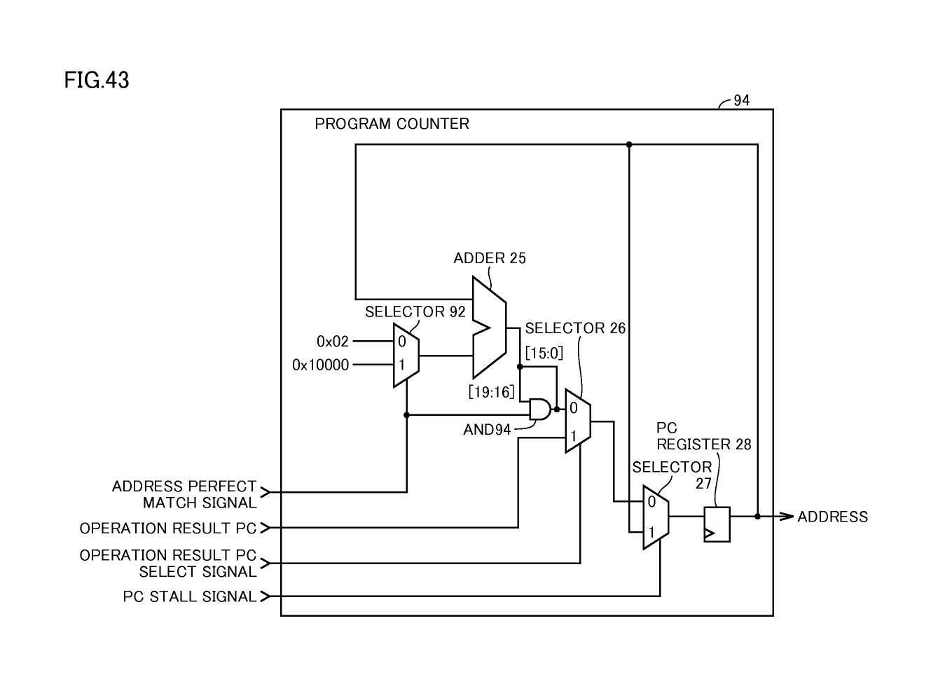

FIG. 43 is a diagram showing a configuration of program counter 94.

Program counter 94 in FIG. 43 differs from program counter 74 of the seventh embodiment in FIG. 34 in terms of a selector 92 and a logic circuit AND94.

Selector 92 receives the address perfect match signal from insert code register set block 389. Selector 92 outputs “0x10000” when the address perfect match signal is “H” level. Selector 92 outputs “0x02” when the address perfect match signal is “L” level.

Logic circuit AND94 outputs the logical product of the high-order 4 bits (17th bit to 19th bit) of the 20 bits which are output from adder 25 and the address perfect match signal. Namely, when the address perfect match signal is “H” level, logic circuit AND94 outputs the high-order 4 bits of the 20 bits which are output from adder 25. When the address perfect match signal is “L” level, logic circuit AND94 outputs 4-bit “0b0”.

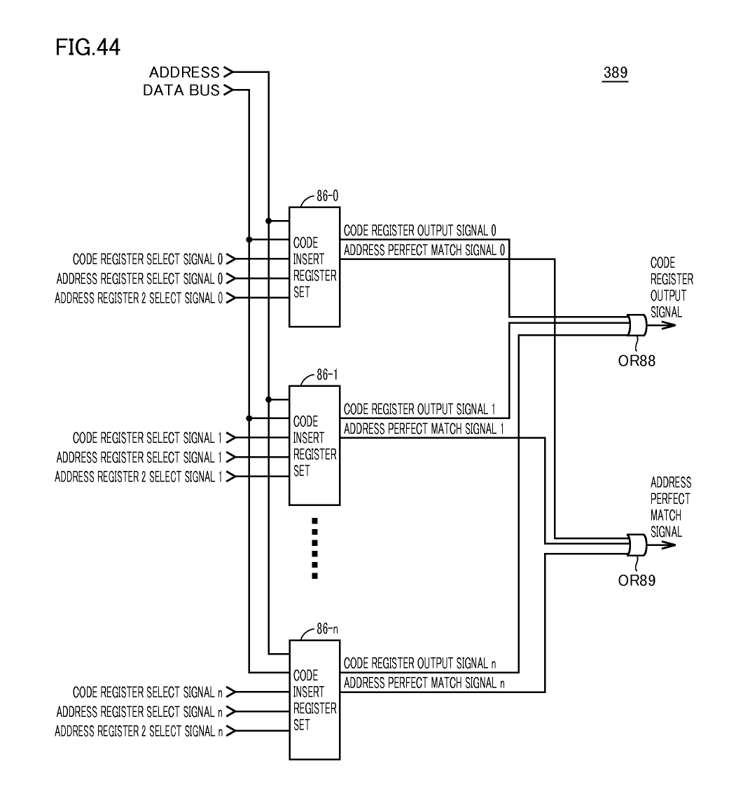

FIG. 44 is a diagram showing a configuration of insert code register set block 389.

As shown in FIG. 44, insert code register set block 389 includes a code insert register set 86-i (i=0 to n) retaining a code to be inserted and the address where the code is to be inserted, and logic circuits OR88, OR89.

Code insert register set 86-i receives an address which is output from program counter 94 and data which is transmitted through the data bus, further receives from code select circuit 14 code register select signal i, address register select signal i, and address register 2 select signal i, and outputs address perfect match signal i and code register output signal i.

Logic circuit OR88 outputs a code register output signal which is the logical sum of (n+1) code register output signals 0 to n. Namely, when at least one of (n+1) code register output signals 0 to n has an “H” level bit (namely when an insert code is output), the code register output signal is the insert code. Namely, when all bits of (n+1) code register output signals 0 to n are “L” level (namely when the insert code is not output), all bits of the code register output signal are “L”.

Logic circuit OR89 outputs the address perfect match signal which is the logical sum of (n+1) address perfect match signals 0 to n. Namely, when at least one of (n+1) address perfect match signals 0 to n is “H” level, the address perfect match signal is “H” level.

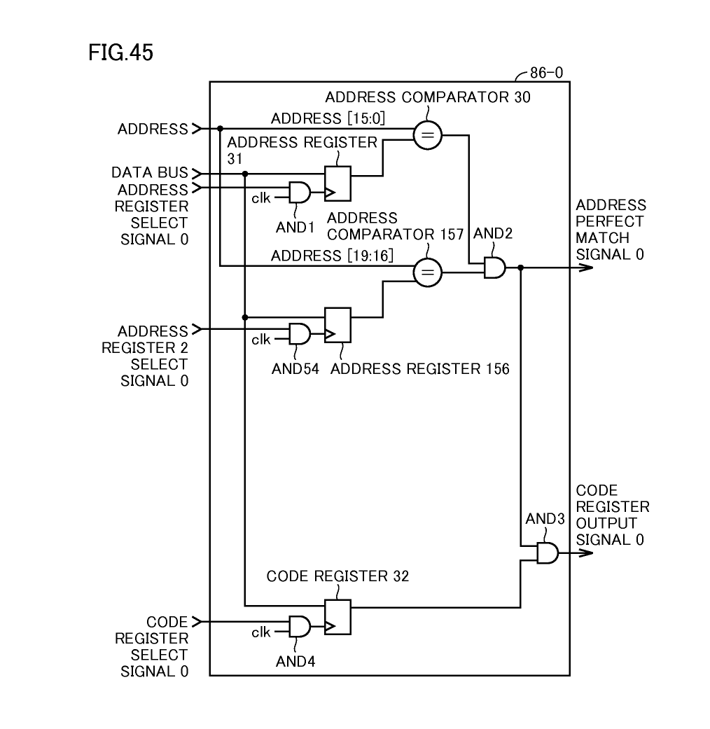

FIG. 45 is a diagram showing a configuration of code insert register set 86-0 included in insert code register set block 389. Code insert register sets 86-1 to 86-n are configured similarly to code insert register set 86-0 in FIG. 45.

Code insert register set 64-0 in FIG. 45 differs from code insert register set 78-0 of the seventh embodiment in FIG. 35 in that the address match signal which is output from address comparator 30 is not output to the external circuitry and in that logic circuit AND56 and insert end register 59 are not included.

Example Operation of Ninth Embodiment:

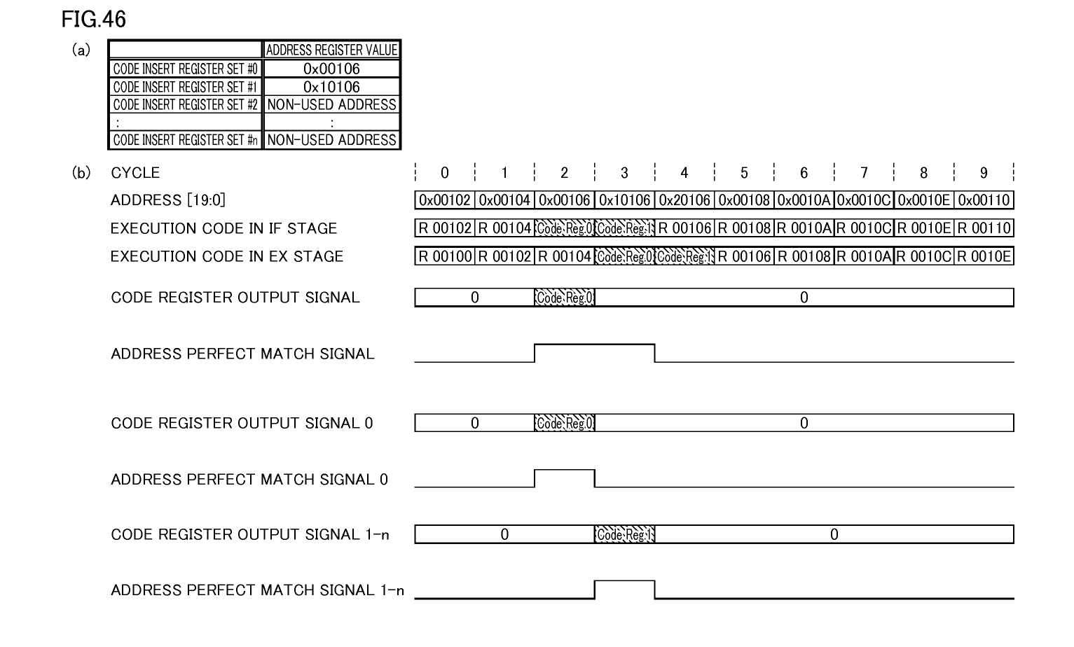

FIG. 46 (a) is a diagram showing an example of values retained in address register 31 of code insert register set 86-i (hereinafter code insert register set #i). In this example, address register 31 of code insert register set #0 retains the low-order 16 bits of “0x00106”, and address register 156 retains the high-order 4 bits (17th bit to 20th bit) of “0x00106”. Code register 32 of code insert register set #0 retains insert code “Code Reg.0”. Address register 31 of code insert register set #1 retains the low-order 16 bits of “0x10106”, and address register 156 retains the high-order 4 bits (17th bit to 20th bit) of “0x10106”. Code register 32 of code insert register set #1 retains insert code “Code Reg.1”. An original code “R . . . ” is retained at an address “0x . . . . ” in flash control code ROM 13.

FIG. 46 (b) is a timing diagram under the conditions in FIG. 46 (a).

In the 0th cycle, the 20-bit address (PC value [19:0]) which is output from program counter 94 is “0x00102”. The low-order 16 bits of address “0x00102” are different from the low-order 16 bits of address “0x00106” retained in address register 31 of code insert register set #0. Accordingly, the address perfect match signal is “L” level and the code register output signal is “0x00000”. From flash control code ROM 13, “R00102” which is an original code at address “0x000102” is output. Since the address perfect match signal is “L” level, code select circuit 14 outputs original code “R00102” to fetch unit 35 of instruction execution unit 15. Execution unit 36 of instruction execution unit 15 executes original code “R00100” which is output to fetch unit 35 in the immediately preceding cycle.

In the first cycle, selector 92 of program counter 94 outputs “0x02” since the address perfect match signal in the preceding cycle is “L” level Thus, the output address of program counter 94 is “0x00104” determined by adding “0x02”. The low-order 16 bits of address “0x00104” are different from the low-order 16 bits of address “0x00106” retained in address register 31 of code insert register set #0. Accordingly, the address perfect match signal is “L” level and the code register output signal is “0x00000”. From flash control code ROM 13, original code “R00104” at address “0x00104” is output. Since the address perfect match signal is “L” level, code select circuit 14 outputs original code “R00104” to fetch unit 35 of instruction execution unit 15. Execution unit 36 of instruction execution unit 15 executes original code “R00102” which is output to fetch unit 35 in the immediately preceding cycle.

In the second cycle, selector 92 of program counter 94 outputs “0x02” since the address perfect match signal in the preceding cycle is “L” level. Thus, the output address of program counter 94 is “0x00106” determined by adding “0x02”. The low-order 16 bits of address “0x00106” match the low-order 16 bits of address “0x00106” retained in address register 31 of code insert register set #0. In addition, the high-order 4 bits (17th bit to 20th bit) of address “x00106” match the high-order 4 bits of address “0x0106” retained in address register 156 of code insert register set #0. Accordingly, the address perfect match signal is “H” level (since address perfect match signal 0 is “H” level). Further, the code register output signal is “Code Reg.0” retained in code register 32 (since code register output signal 0 is “Code Reg.0”). Since the address perfect match signal is “H” level, code select circuit 14 outputs insert code “Code Reg.0” to fetch unit 35 of instruction execution unit 15. Execution unit 36 of instruction execution unit 15 executes original code “R00104” which is output to fetch unit 35 in the immediately preceding cycle.

In the third cycle, selector 92 of program counter 94 outputs “0x10000” since the address perfect match signal in the preceding cycle is “H” level. Thus, the output address of program counter 94 is “0x10106” determined by adding “0x10000”. The low-order 16 bits of address “0x10106” match the low-order 16 bits of address “0x10106” retained in address register 31 of code insert register set #1. In addition, the high-order 4 bits (17th bit to 20th bit, address [16] to [19]) of address “0x10106” match the high-order 4 bits of address “0x10106” retained in address register 156 of code insert register set #1. Accordingly, the address perfect match signal is “H” level (since address perfect match signal 1 is “H” level). Further, the code register output signal is insert code “Code Reg.1” retained in code register 32 (since code register output signal 0 is “Code Reg.1”). Since the address perfect match signal is “H” level, code select circuit 14 outputs insert code “Code Reg.1” to fetch unit 35 of instruction execution unit 15. Execution unit 36 of instruction execution unit 15 executes insert code “Code Reg.0” which is output to fetch unit 35 in the immediately preceding cycle.

In the fourth cycle, selector 92 of program counter 94 outputs “0x10000” since the address perfect match signal in the preceding cycle is “H” level. Thus, the output address of program counter 94 is “0x20106” determined by adding “0x10000”. The low-order 16 bits of address “0x20106” match the low-order 16 bits of addresses “0x00106” and “0x10106” retained in address registers 31 of code insert register sets #0 and #1. The high-order 4 bits (17th bit to 20th bit, address [16] to [19]) of address “0x20106”, however, are different from the high-order 4 bits of addresses “0x00106” and “0x10106” retained in address registers 156 of code insert register sets #0 and #1. Accordingly, the address perfect match signal is “L” level (since address perfect match signal 0 and the address perfect match signal are “L” level). Further, the code register output signal is “0x00000”. Flash control code ROM 13 outputs original code “R00106” at address “0x00106” corresponding to output address “0x20106” of program counter 94 in which the high-order 4 bits (17th bit to 20th bit) are set to “0”. Since the address perfect match signal is “L” level, code select circuit 14 outputs original code “R00106” to fetch unit 35 of instruction execution unit 15. Execution unit 36 of instruction execution unit 15 executes insert code “Code Reg.1” which is output to fetch unit 35 in the immediately preceding cycle.

In the fifth cycle, selector 92 of program counter 94 outputs “0x02” since the address perfect match signal in the preceding cycle is “L” level. Since the address perfect match signal is “L” level, the high-order 4 bits (17th bit to 20th bit) of the output address of adder 25 are “0”. Accordingly, the output address of program counter 94 is “0x00108”. In addition, since the low-order 16 bits of address “0x00108” are different from the low-order 16 bits of address “0x00106” retained in address register 31, the address perfect match signal is “L” level, and the code register output signal is “0x00000”. Flash control code ROM 13 outputs original code “R00108” at address “0x00108”. Since the address perfect match signal is “L” level, code select circuit 14 outputs original code “R00108” to fetch unit 35 of instruction execution unit 15. Execution unit 36 of instruction execution unit 15 executes original code “R00106” which is output to fetch unit 35 in the immediately preceding cycle. In the sixth and its subsequent cycles, the operation is performed similarly to that in the fifth cycle.

As seen from the foregoing, the present embodiment, like the seventh embodiment, uses the bits of the address of the program counter except for a predetermined number of bits from the most significant bit to specify the address of an original code, and uses the predetermined number of bits from the most significant bit to control insertion of a code. Therefore, one or more codes can be inserted between two original codes and a multicycle instruction can be executed. Further, in the present embodiment, when the address from the program counter matches the value of the address register, execution of an insert code is done before the original code, in contrast to the seventh embodiment in which execution of the insert code is done after the original code.

(Modifications)

The present invention is not limited to the above-described embodiments. For example, the code register value may be fixed at a specific value. While the type of insertable codes is accordingly restricted, the register size can be reduced instead.

Further, the code register value may be stored in a ROM or stored in a circuit made up of a combination of logic circuits. Only a specific command (command for error monitor for example) may be allowed to be inserted.

In the present embodiments, the flash memory control unit may be equipped with functions similar to those of the general-purpose processor. A nonvolatile semiconductor device may be configured to include flash memory 3 and flash memory control unit 2 shown in FIG. 6 that are formed on one semiconductor substrate (chip).

It should be construed that the embodiments disclosed herein are given by way of illustration in all respects, not by way of limitation. It is intended that the scope of the present invention is defined bay claims, not by the description above, and encompasses all modifications and variations equivalent in meaning and scope to the claims.

### REFERENCE SIGNS LIST

1 microcomputer; 2, 102, 103, 312, 395, 423, 623, 742 flash memory control unit; 3 flash memory; 4 CPU; 5 RAM; 6 peripheral device; 7 A/D converter; 8 D/A converter, 9 analogue input terminal; 10 analogue output terminal; 11 I/O port; 12, 51, 65, 72, 74, 91, 94 program counter; 13 flash control code ROM; 14 code select circuit; 15 instruction execution unit; 16 interface controller, 17, 52, 164, 396, 399, 424, 624, 743 insert code register set block; 18 register select signal generation circuit; 21 internal data bus; 22, 23 internal address bus; 24, 26, 27, 33, 53, 68, 73, 77, 92 selector; 25 adder, 28 PC register; 29-0 to 29-n, 40-0, 54-0 to 54-n, 64-0, 71-0, 78-0, 86-0 to 86-n, 88-0 to 88-n code insert register set; 30, 157 address comparator; 31, 56, 156 address register; 32 code register, 34 status register; 35 fetch unit; 36 execution unit; 59 insert end register; 273 main data bus; OR1, OR2, OR3, OR54, OR68, OR88, OR89, AND1, AND2, AND3, AND4, AND5, AND6, AND54, AND55, AND56, AND71, AND72, AND74, AND88, AND92 logic circuit; NEOR1 match circuit

1. A microcomputer comprising:
a ROM storing a plurality of original codes;
a program counter updating an address by adding a first value or a second value;
a register retaining at least one insert code and an address of said insert code;
a select circuit selecting, in accordance with the address of said program counter, one of
the insert code retained in said register and corresponding to the address specified by said program counter, and
an original code stored in said ROM and having the address specified by said program counter; and
an instruction execution unit executing the code selected by said select circuit,
at least one of said plurality of original codes and said insert code being a multicycle instruction,
said program counter stopping update of the address when the multicycle instruction is executed.

2. The microcomputer according to claim 1, wherein
said plurality of original codes in said ROM each have an address in which a second least significant bit and more significant bits than the second least significant bit are valid,
said register
outputs a first signal when bits except for a least significant bit in the address of said retained insert code match bits except for a least significant bit in the address of said program counter, and
outputs a second signal and outputs said retained insert code when said register outputs said first signal and the least significant bit in the address of said program counter is “1”,
said program counter adds “1” to the least significant bit when said program counter receives said first signal, and said program counter adds “1” to the second least significant bit when said program counter fails to receive said first signal, and
said select circuit selects said insert code when said select circuit receives said second signal, and said select circuit selects said original code when said select circuit fails to receive said second signal.

3. The microcomputer according to claim 1, wherein
said plurality of original codes in said ROM each have an address in which a second least significant bit and more significant bits than the second least significant bit are valid,
said register
outputs a first signal when bits except for a least significant bit in the address of said retained insert code match bits except for a least significant bit in the address of said program counter, and
outputs a second signal and outputs said retained insert code when said register outputs said first signal and the least significant bit in the address of said retained insert code matches the least significant bit in the address of said program counter,
said program counter adds “1” to the least significant bit when said program counter receives said first signal, and said program counter adds “1” to the second least significant bit when said program counter fails to receive said first signal, and
said select circuit selects said insert code when said select circuit receives said second signal, and said select circuit selects said original code when said select circuit fails to receive said second signal.

4. The microcomputer according to claim 1, wherein
said plurality of original codes in said ROM each have an address in which an n-th least significant bit and more significant bits than the n-th least significant bit are valid,
said register
outputs a first signal when bits except for a most significant bit in the address of said retained insert code match bits except for a most significant bit in the address of said program counter, and
outputs a second signal and outputs said retained insert code when said register outputs said first signal and the most significant bit in the address of said program counter is “1”,
said program counter adds “1” to the most significant bit when said program counter receives said first signal, and said program counter adds “1” to the n-th least significant bit when said program counter fails to receive said first signal, and
said select circuit selects said insert code when said select circuit receives said second signal, and said select circuit selects said original code when said select circuit fails to receive said second signal.

5. The microcomputer according to claim 1, wherein
said plurality of original codes in said ROM each have an address in which an n-th least significant bit and more significant bits than the n-th least significant bit except for a most significant bit are valid,
said register outputs a first signal and outputs said retained insert code when bits except for the most significant bit in the address of said retained insert code match bits except for the most significant bit in the address of said program counter and the most significant bit in the address of said program counter is “1”,
said program counter adds “1” to the most significant bit when said program counter receives said first signal, and said program counter adds “1” to the n-th least significant bit and sets the most significant bit to “0” when said program counter fails to receive said first signal, and
said select circuit selects said insert code when said select circuit receives said first signal, and said select circuit selects said original code when said select circuit fails to receive said first signal.

6. The microcomputer according to claim 1, wherein
said plurality of original codes in said ROM each have an address in which an (n+1)-th least significant bit and more significant bits than the (n+1)-th least significant bit are valid,
said register retains up to a maximum of 2n−1 insert codes and addresses of said insert codes,
said register
outputs a first signal when bits except for n bits from a least significant bit in the address of said retained insert code match bits except for n bits from a least significant bit in the address of said program counter, and
outputs a second signal and outputs said retained insert code corresponding to the address of said program counter, when said register outputs said first signal and the n bits from the least significant bit in the address of said retained insert code match the n bits from the least significant bit in the address of said program counter,
said program counter adds “1” to the least significant bit when said program counter receives said first signal, and said program counter adds “1” to the (n+1)-th least significant bit when said program counter fails to receive said first signal, and
said select circuit selects said insert code when said select circuit receives said second signal, and said select circuit selects said original code when said select circuit fails to receive said second signal.

7. The microcomputer according to claim 6, wherein in a case where a plurality of insert codes are successively inserted, said register outputs said second signal and simultaneously outputs an insert end signal indicating an end of insert, when said register outputs a last insert code.

8. The microcomputer according to claim 7, wherein when said program counter receives said insert end signal, said program counter adds “1” to the (n+1)-th least significant bit and sets the n bits from the least significant bit to “0”, even when said program counter receives said first signal.

9. The microcomputer according to claim 7, wherein when said program counter receives said insert end signal, said program counter sets the n bits from the least significant bit to “1”.

10. The microcomputer according to claim 1, wherein
said plurality of original codes in said ROM each have an address in which an m-th least significant bit and more significant bits than the m-th least significant bit are valid,
said register retains up to a maximum of 2n−1 insert codes and addresses of said insert codes,
said register
outputs a first signal when bits except for n bits from a most significant bit in the address of said retained insert code match bits except for n bits from a most significant bit in the address of said program counter, and
outputs a second signal and outputs said retained insert code corresponding to the address of said program counter, when said register outputs said first signal and the n bits from the most significant bit in the address of said retained insert code match the n bits from the most significant bit in the address of said program counter,
said program counter adds “1” to an n-th most significant bit when said program counter receives said first signal, and said program counter adds “1” to the m-th least significant bit when said program counter fails to receive said first signal, and
said select circuit selects said insert code when said select circuit receives said second signal, and said select circuit selects said original code when said select circuit fails to receive said second signal.

11. The microcomputer according to claim 10, wherein in a case where a plurality of insert codes are successively inserted, said register outputs said second signal and simultaneously outputs an insert end signal indicating an end of insert, when said register outputs a last insert code.

12. The microcomputer according to claim 1, wherein when said program counter receives said insert end signal, said program counter adds “1” to the m-th least significant bit and sets the n bits from the most significant bit to “0”, even when said program counter receives said first signal.

13. The microcomputer according to claim 1, wherein
said plurality of original codes in said ROM each have an address in which an m-th least significant bit and more significant bits than the m-th least significant bit are valid,
said register retains up to a maximum of 2n−1 insert codes and addresses of said insert codes,
said register outputs a first signal and outputs said retained insert code corresponding to the address of said program counter, when bits except for n bits from a most significant bit in the address of said retained insert code match bits except for n bits from a most significant bit in the address of said program counter and the n bits from the most significant bit in the address of said retained insert code match the n bits from the most significant bit in the address of said program counter,
said program counter adds “1” to the n-th most significant bit when said program counter receives said first signal, and said program counter adds “1” to the m-th least significant bit and sets the n bits from the most significant bit to “0” when said program counter fails to receive said first signal, and
said select circuit selects said insert code when said select circuit receives said first signal, and said select circuit selects said original code when said select circuit fails to receive said first signal.

14. The microcomputer according to claim 1, wherein
said register retains a status bit, and
when said status bit has the first value, said select circuit selects said original code regardless of the address of said program counter.

15. A microcomputer comprising:
a nonvolatile memory capable of electrical erasure and writing from and into a semiconductor substrate;
a central processing unit capable of accessing said nonvolatile memory; and
a nonvolatile memory control circuit controlling said nonvolatile memory in a predetermined sequence in response to access from said central processing unit,
said nonvolatile memory control circuit comprising:
a ROM in which a plurality of instruction codes executed in a predetermined sequence are each stored at an address specified by M valid bits;
a program counter providing an output of K (>M) bits and updating an address for selecting an instruction code stored in said ROM;
a register circuit retaining an insert code to be inserted in the plurality of instruction codes executed in said predetermined sequence and retaining an address indicating an insert destination where said insert code is to be inserted;
a code select circuit selecting, in accordance with a result of detection of whether the address from said program counter matches the address indicating the insert destination of the insert code retained in said register circuit, one of an instruction code stored in said ROM and the insert code retained in said register circuit; and
an instruction execution unit executing the code selected by said select circuit,
said program counter including an addition value select circuit changing addition of one bit to a least significant bit among said M valid bits to addition of one bit to an output bit other than said M valid bits, when a code is inserted,
said instruction execution unit being capable of executing at least one multicycle instruction, and instructing said program counter to stop update when said multicycle instruction is executed.

16. The microcomputer according to claim 15, wherein the register retaining the address indicating the insert destination of said insert code retains bit data of the same number of bits (K bits) as the output of said program counter.

17. A nonvolatile semiconductor device comprising:
a nonvolatile memory capable of electrical erasure and writing from and into a semiconductor substrate, and
a nonvolatile memory control circuit controlling said nonvolatile memory in a predetermined sequence,
said nonvolatile memory control circuit comprising:
a ROM in which a plurality of instruction codes executed in a predetermined sequence are each stored at an address specified by M valid bits;
a program counter providing an output of K (>M) bits and updating an address for selecting an instruction code stored in said ROM;
a register circuit retaining an insert code to be inserted in the plurality of instruction codes executed in said predetermined sequence and retaining an address indicating an insert destination where said insert code is to be inserted;
a code select circuit selecting, in accordance with a result of detection of whether the address from said program counter matches the address indicating the insert destination of the insert code retained in said register circuit, one of an instruction code stored in said ROM and the insert code retained in said register circuit; and
an instruction execution unit executing the code selected by said select circuit,
said program counter including an addition value select circuit changing addition of one bit to a least significant bit among said M valid bits to addition of one bit to an output bit different from said M valid bits, when a code is inserted,
said instruction execution unit being capable of executing at least one multicycle instruction, and instructing said program counter to stop update when said multicycle instruction is executed.
